(19) United States
(12) Patent Application Publication
(10) Pub. No.: US 2005/0090396 A1
(43) Pub. Date: Apr. 28, 2005

(54) Herbicides based on substituted carboxylic acid anilides

(76) Inventors: Dieter Feucht, Kelkheim (DE); Peter Dahmen, Neuss (DE); Mark Wilhelm Drewes, Langenfeld (DE); Rolf Pontzen, Leichlingen (DE); Roland Andree, Langenfeld (DE); Karl-Heinz Linker, Leverkusen (DE)

Correspondence Address: BAYER CROPSCIENCE LP;Patent Department, 100 BAYER ROAD, PITTSBURGH, PA, 15205-9741, US

(21) Appl. No.: 10/497,381

(22) PCT Filed: Dec. 2, 2002
(86) PCT No.: PCT/EP02/13599

(30) Foreign Application Priority Data
Dec. 5, 2001 (DE) 10159659.6

(51) Int. Cl. A01N 63/00; A01N 43/00

(52) U.S. Cl. 504/129; 504/118

(57) ABSTRACT

The invention relates to novel herbicidal active compound combinations comprising known substituted carboxanilides of the formula (I) 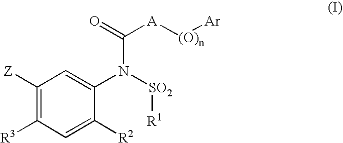
in which n, A, Ar, R¹, R², R³ and Z are as defined in the description on the disclosure, and one or more known herbicidally active compounds and/or, if appropriate, a compound that improves compatibility with crop plants. The invention further relates to the use of such compound combinations for controlling weeds in various crops of useful plants and for controlling monocotyledonous and dicotyledonous weeds in the semi- and nonselective field.

The invention relates to novel herbicidal active compound combinations comprising known substituted carboxanilides on the one hand, and one or more known herbicidally active compounds on the other and/or, if appropriate, a compound which improves compatibility with crop plants, and to their use for controlling weeds in various crops of useful plants and for controlling monocotyledonous and dicotyledonous weeds in the semi- and nonselective field.

Substituted carboxanilides are known to be effective herbicides (WO-A-98/32746, WO-A-00/02867, WO-A-00/75119). However, the activity of these compounds, when used alone, is not under all conditions entirely satisfactory. Thus, when used against certain weeds, there may be weaknesses in the activity, and because of this, it is desirable to close such activity gaps by using one or more suitable active compounds together with the compounds mentioned. It may also be possible to improve the herbicidal action considerably, as a result of a synergism, by choosing a suitable mixing partner.

Surprisingly, it has now been found that certain active compounds from the group of the substituted carboxanilides, when used together with certain herbicidally active compounds, show synergistic effects with respect to the activity against weeds and can be used particularly advantageously as broadly active compound preparations for the selective control of monocotyledonous and dicotyledonous weeds in crops of useful plants, such as, for example, in cotton, barley, potatoes, maize, oilseed rape, rice, rye, soya beans, sunflowers, wheat, sugar cane and sugar beet, but also for controlling monocotyledonous and dicotyledonous weeds in the semi- and nonselective field.

Accordingly, the invention provides herbicidal compositions, characterized in that they comprise an effective amount of an active compound combination comprising
(a) at least one substituted carboxanilide of the general formula (I) 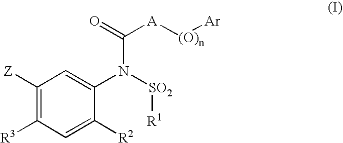
   in which
n represents the number 0 or 1,
A represents alkanediyl (alkylene) or alkenediyl having in each case up to 6 carbon atoms,
Ar represents optionally substituted aryl having 6 or 10 carbon atoms or represents optionally substituted heterocyclyl having up to 9 carbon atoms and 1 to 4 nitrogen atoms and/or optionally 1 or 2 oxygen or sulphur atoms,
   where the substituents possible in each case are selected from the following list:
   nitro, cyano, carboxyl, carbamoyl, thiocarbamoyl, halogen, C₁-C₄-alkyl, C₁-C₄-haloalkyl, C₁-C₄-alkoxy, C₁-C₄-haloalkoxy, C₁-C₄-alkylthio, C₁-C₄-halo-alkylthio, C₁-C₄-alkylsulphinyl, C₁-C₄-haloalkylsulphinyl, C₁-C₄-alkyl-sulphonyl, C₁-C₄-haloalkylsulphonyl, C₁-C₄-alkylamino, di-(C₁-C₄-alkyl)amino, C₁-C₄-alkylcarbonyl, C₁-C₄-alkoxycarbonyl, C₁-C₄-alkyl-aminocarbonyl, di-(C₁-C₄-alkyl)-aminocarbonyl, di-(C₁-C₄-alkyl)aminosulphonyl,
R¹ represents optionally halogen-substituted alkyl having 1 to 6 carbon atoms,
   represents optionally halogen-substituted alkenyl having 2 to 6 carbon atoms,
   represents optionally halogen- or C₁-C₄-alkyl-substituted cycloalkyl having 3 to 6 carbon atoms,
   represents in each case optionally nitro-, cyano-, halogen-, C₁-C₄-alkyl- or C₁-C₄-alkoxy-substituted aryl or arylalkyl having in each case 6 or 10 carbon atoms in the aryl group and, if appropriate, 1 to 4 carbon atoms in the alkyl moiety, or
   represents optionally nitro-, cyano-, halogen-, C₁-C₄-alkyl- or C₁-C₄-alkoxy-substituted heterocyclyl having 5 carbon atoms and 1 to 4 nitrogen atoms and/or 1 or 2 oxygen or sulphur atoms,
R² represents cyano, carbamoyl, thiocarbamoyl, halogen, or represents in each case optionally halogen-substituted alkyl or alkoxy having in each case 1 to 4 carbon atoms,
R³ represents hydrogen, cyano, carbamoyl, thiocarbamoyl or halogen, and
Z represents one of the groupings illustrated below, 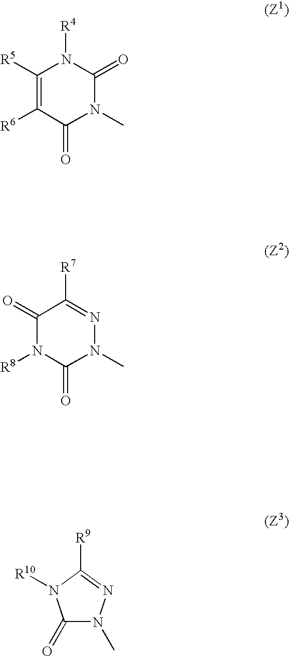
   in which
   R⁴ represents hydrogen, amino or optionally halogen-substituted alkyl having 1 to 4 carbon atoms,
   R⁵ represents carboxyl, cyano, carbamoyl, thiocarbamoyl or in each case optionally halogen-substituted alkyl or alkoxycarbonyl having in each case 1 to 4 carbon atoms in the alkyl groups,
   R⁶ represents hydrogen, halogen or optionally halogen-substituted alkyl having 1 to 4 carbon atoms,
   R⁷ represents hydrogen, cyano, halogen, or represents in each case optionally cyano-, halogen- or C₁-C₄-alkoxy-substituted alkyl, alkoxy, alkylthio, alkylamino or dialkylamino having in each case 1 to 4 carbon atoms in the alkyl groups, and
   R⁸ represents hydrogen or represents in each case optionally cyano-, halogen- or C₁-C₄-alkoxy-substituted alkyl, alkoxy, alkylamino, alkyl-carbonyl or alkoxycarbonyl having in each case 1 to 4 carbon atoms in the alkyl groups,
   R⁹ represents hydrogen, cyano, halogen or one of the groupings —R¹¹, —O—R¹¹, S—R¹, SO—R¹¹ or SO₂—R¹¹,
   R¹⁰ represents hydrogen, hydroxyl, amino or one of the groupings —R¹¹ or —O—R¹¹, and
   R¹¹ represents optionally cyano-, halogen- or C₁-C₄-alkoxy-substituted alkyl having 1 to 6 carbon atoms,
      represents in each case optionally halogen-substituted alkenyl or alkynyl having in each case 2 to 6 carbon atoms,
      represents optionally cyano-, halogen- or C₁-C₄-alkyl-substituted cycloalkyl having 3 to 6 carbon atoms, or
      represents in each case optionally nitro-, cyano-, halogen-, C₁-C₄-alkyl-, C₁-C₄-haloalkyl-, C₁-C₄-alkoxy- or C₁-C₄-haloalkoxy-substituted phenyl or benzyl,
(“active compounds of group (1)”) and
(b) one or more compounds of a second group of herbicides consisting of the active compounds below:
4,5-dihydro-3-methoxy-4-methyl-5-oxo-N-[(2-trifluoromethoxyphenyl)-sulphonyl]-1-H-1,2,4-triazole-1-carboxamide sodium salt (flucarbazone-sodium), 2-chloro-N-(ethoxymethyl)-N-(2-ethyl-6-methylphenyl)acetamide(acetochlor), 5-(2-chloro-4-tri-fluoromethylphenoxy)-2-nitrobenzoic acid (sodium salt) (acifluorfen (-sodium)), 2-chloro-6-nitro-3-phenoxybenzeneamine(aclonifen), 2-chloro-N-(methoxymethyl)-N-(2,6-diethylphenyl)acetamide(alachlor), methyl 4-hydroxy-6,6-dimethyl-2-oxo-3-[1-[(2-propenyloxy)imino]butyl]-3-cyclohexene-1-carboxylate (sodium salt) (alloxydim (-sodium)), N-ethyl-N′-isopropyl-6-methylthio-1,3,5-triazine-2,4-diamine(ametryn), 4-amino-N-(1,1-dimethylethyl)-4,5-dihydro-3-(1-methylethyl)-5-oxo-1H-1,2,4-tri-azole-1-carboxamide(amicarbazone), N-(4,6-dimethoxypyrimidin-2-yl)-N′-(N-methyl-N-methylsulphonylsulphamoyl)urea (amidosulfuron), 1H-1,2,4-tniazole-3-amine(amitrole), S-[2-[(4-chlorophenyl)-(1-isopropyl)amino]-2-oxoethyl]O,O-di-methyl phosphorodithioate (anilofos), O-methyl N-(4-aminophenylsulphonyl)carbamate (asulam), 6-chloro-4-ethylamino-2-isopropyl-amino-1,3,5-triazine (atrazine), 2-[2,4-dichloro-5-(2-propynyloxy)phenyl]-5,6,7,8-tetrahydro-1,2,4-triazolo-[4,3-a]-pyridin-3(2H)-one (azafenidin), N-(4,6-di-methoxypyrimidin-2-yl)-N′-[1-methyl-4-(2-methyl-2H-tetrazol-5-yl)-1H-pyrazol-5-ylsulphonyl]urea (azimsulfuron), N-benzyl-2-(4-fluoro-3-trifluoro-methylphenoxy)butanamide (beflubutamid), 4-chloro-2-oxo-3(2H)-benzothi-azoleacetic acid (ethyl ester) (benazolin, (-ethyl)), N-butyl-N-ethyl-2,6-dinitro-4-tri-fluoromethylbenzeneamine (benfluralin), 2,3-dihydro-3,3-dimethyl-5-benzo-furanylethanesulphonate (benfuresate), N-(4,6-dimethoxypyrimidin-2-yl)-N′-(2-methoxycarbonylphenylmethylsulphonyl)urea (bensulfuron-methyl), 3-isopropyl-1H-2,1,3-benzothiadiazin-4(3H)-one 2,2-dioxide (bentazone), S-[(4-chlorophenyl)methyl]diethylthiocarbamate (benthiocarb, thiobencarb), methyl 2-[2-[4-(3,6-dihydro-3-methyl-2,6-dioxo-4-trifluoromethyl-1 (2H)-pyrimidinylphenoxy-methyl]-5-ethylphenoxypropanoate (benzfendizone), 3-(2-chloro-4-methyl-sulphonylbenzoyl)-4-phenylthiobicyclo-[3.2.1]-oct-3-en-2-one (benzobicyclon), 2-[[4-(2,4-dichloro-3-methylbenzoyl)-1,3-dimethyl-1H-pyrazol-5-yl]oxy]-1-(4-methylphenyl)ethanone (benzofenap), methyl 5-(2,4-dichlorophenoxy)-2-nitrobenzo-ate (bifenox), 2,6-bis-(4,6-dimethoxypyrimidin-2-yloxy)benzoic acid sodium salt (bispyribac-sodium), 5-bromo-6-methyl-3-(1-methylpropyl)-2,4(1H,3H)-pyrimidine-dione (bromacil), 2-bromo-3,3-dimethyl-N-(1-methyl-1-phenylethyl)butanamide (bromobutide), 3,5-dibromo-4-hydroxybenzaldehyde O-(2,4-dinitrophenyl)oxime (bromofenoxim), 3,5-dibromo-4-hydroxybenzonitrile (bromoxynil), N-butoxymethyl-2-chloro-N-(2,6-diethylphenyl)acetamide(butachlor), 1,1-dimethyl-2-oxo-2-(2-propenyloxy)]ethyl 2-chloro-5-(3,6-dihydro-3-methyl-2,6-dioxo-4-trifluoromethyl-1(2H)-pyrimidinyl)benzoate (butafenacil), 4-(1-t-butyl)-N-(s-butyl)-2,6-di-nitroaniline (butralin), 2-(1-ethoximinopropyl)-3-hydroxy-5-[2,4,6-trimethyl-3-(1-oxobutyl)phenyl]-2-cyclohexen-1-one (butroxydim), S-ethyl bis-(2-methylpropyl)thiocarbamate (butylate), N,N-diethyl-3-(2,4,6-trimethylphenylsulph-onyl)-1H-1,2,4-triazole-1-carboxamide(cafenstrole), (R)-N-ethyl-2-[(phenylamino-carbonyl)oxy]propanamide(carbetamide), 2-(4-chloro-2-fluoro-5-(2-chloro-2-eth-oxycarbonylethyl)phenyl)-4-difluoromethyl-5-methyl-2,4-dihydro-3H-1,2,4-triazol-3-one (carfentrazone-ethyl), 2,4-dichloro-1-(3-methoxy-4-nitrophenoxy)benzene (chlormethoxyfen), 5-amino-4-chloro-2-phenyl-3(2H)-pyridazinone (chloridazon), N-(4-chloro-6-methoxypyrimidin-2-yl)-N′-(2-ethoxycarbonylphenylsulphonyl)urea (chlorimuron-ethyl), 1,3,5-trichloro-2-(4-nitrophenoxy)benzene (chlornitrofen), N′-(3-chloro-4-methylphenyl)-N,N-dimethylurea (chlorotoluron), N-(4-methoxy-6-methyl-1,3,5-triazin-2-yl)-N′-(2-chlorophenylsulphonyl)urea (chlorsulfuron), ethyl 2-chloro-3-[2-chloro-5-(1,3,4,5,6,7-hexahydro-1,3-dioxo-2H-isoindol-2-yl)phenyl]-2-propanoate (cinidon-ethyl), exo-1-methyl-4-isopropyl-2-(2-methylphenylmethoxy)-7-oxabicyclo-[2.2.1]-heptane (cinmethylin), N-(4,6-dimethoxy-1,3,5-triazin-2-yl)-N′-(2-(2-methoxyethoxy)phenylsulphonyl)urea (cinosulfuron), 2-[1-[2-(4-chlorophen-oxy)propoxyaminobutyl]-5-(tetrahydro-2H-thiopyran-3-yl)-1,3-cyclohexanedione (clefoxydim), (E,E)-(+)-2-[1-[[(3-chloro-2-propenyl)oxy]imino]propyl]-3-hydroxy-2-cyclohexen-1-one (clethodim), (R)-(2-propynyl) 2-[4-(5-chloro-3-fluoropyridin-2-yl-oxy)phenoxypropanoate (clodinafop-propargyl), 2-[(2-chlorophenyl)methyl]-4,4-di-methyl-3-isoxazolidinone (clomazone), 2-(2,4-dichloro-3-methylphenoxy)-N-phenylpropanamide (clomeprop), 3,6-dichloropyridin-2-carboxylic acid (clopyralid), methyl 3-chloro-2-[(5-ethoxy-7-fluoro[1,2,4]triazolo[1,5-c]pyrimidin-2-ylsulph-onyl)amino]benzoate (cloransulam-methyl), N-[(2-chlorophenyl)methyl]-N′-(1-methyl-1-phenylethyl)urea (cumyluron), 2-chloro-4-ethylamino-6-(1-cyano-1-methylethylamino)-1,3,5-triazine (cyanazine), N-(4,6-dimethoxypyrimidin-2-yl)-N′-(2-cyclopropylcarbonylphenylsulphonyl)urea (cyclosulfamuron), 2-(1-ethoximino-butyl)-3-hydroxy-5-(tetrahydro-2H-thiopyran-3-yl)-2-cyclohexen-1-one (cycloxy-dim), (R)-butyl 2-[4-(4-cyano-2-fluorophenoxy)phenoxy]propanoate (cyhalofop-butyl), 2,4-dichlorophenoxyacetic acid (2,4-D), O-ethyl N-[3-(phenylaminocarbonyl-oxy)phenyl]carbamate (desmedipham), 3,6-dichloro-2-methoxybenzoic acid (di-camba), 2,6-dichlorobenzonitrile (dichlobenil), (R)-2-(2,4-dichlorophen-oxy)propanoic acid (dichlorprop-P), methyl 2-[4-(2,4-dichlorophenoxy)phen-oxy]propanoate (diclofop-methyl), N-(2,6-dichlorophenyl)-5-ethoxy-7-fluoro-[1,2,4]-triazolo-[1,5-c]-pyrimidine-2-sulphonamide(diclosulam), 1,2-dimethyl-3,5-diphenyl-1H-pyrazolium methylsulphate (difenzoquat), N-(2,4-difluorophenyl)-2-(3-tri-fluoromethylphenoxy)pyridine-3-carboxamide(diflufenican), 2-[1-[(3,5-difluorophenyl)aminocarbonylhydrazono]ethyl]pyridine-3-carboxylic acid (diflufen-zopyr), N′-[3-chloro-4-(5-t-butyl-oxo-1,3,4-oxadiazol-3(2H)-yl)phenyl]-N,N-di-methylurea (dimefuron), S-(1-methyl-1-phenylethyl) 1-piperidinecarbothioate (dime-piperate), 2-chloro-N-(2,6-dimethylphenyl)-N-(2-methoxyethyl)acetamide(dimetha-chlor), N-(1,2-dimethylpropyl)-N′-ethyl-6-methylthio-1,3,5-triazine-2,4-diamine(di-methametryn), (S—) 2-chloro-N-(2,4-dimethyl-3-thienyl)-N-(2-methoxy-1-methylethyl)acetamide((S—) (dimethenamid)), 2-amino-4-(1-fluoro-1-methylethyl)-6-(1-methyl-2-(3,5-dimethylphenoxy)ethylamino)-1,3,5-triazine (dimexyflam), 6,7-dihydrodipyrido[1,2-a:2′,1′-c]pyrazinediium dibromide (diquat-dibromide), S,S-dimethyl 2-difluoromethyl-4-isobutyl-6-trifluoromethylpyridine-3,5-dicarbothioate (dithiopyr), N′-(3,4-dichlorophenyl)-N,N-dimethylurea (diuron), N-(4-methylphenyl)-N′-(1-methyl-1-phenylethyl)urea (dymron, daimuron), S-ethyl dipropylthiocarbamate (EPTC), S-(phenylmethyl) N-ethyl-N-(1,2-dimethylpropyl)thiocarbamate (Espro-carb), N-ethyl-N-(2-methyl-2-propenyl)-2,6-dinitro-4-trifluoromethylbenzeneamine (ethalfluralin), methyl 2-[[[[(4-ethoxy-6-methylamino-1,3,5-triazin-2-yl)amino]carbonyl]amino]sulphonyl]benzoate (ethametsulfuron-methyl), 2-ethoxy-2,3-dihydro-3,3-dimethyl-5-benzofuranylmethanesulphonate (ethofumesate), (S)-(2-ethoxy-1-methyl-2-oxoethyl) 2-chloro-5-(2-chloro-4-trifluoromethylphenoxy)benzoate (ethoxyfen), N-(4,6-dimethoxypyrimidin-2-yl)-N′-(2-ethoxyphenoxysulphonyl)urea (ethoxysulfuron), N-(2,3-dichlorophenyl)-4-ethoxymethoxybenzamide(etobenzamide), (R)-ethyl 2-[4-(6-chlorobenzoxazol-2-yloxy)phenoxy]propanoate (Fenoxaprop-(P)-ethyl), 4-(2-chlorophenyl)-N-cyclohexyl-N-ethyl-4,5-dihydro-5-oxo-1H-tetrazole-1-carboxamide (fentrazamide), isopropyl N-benzoyl-N-(3-chloro-4-fluorophenyl)-D-alaninate (flamprop-M-isopropyl), methyl N-benzoyl-N-(3-chloro-4-fluorophenyl)-D-alaninate (flamprop-M-methyl), N-[[(4,6-dimethoxy-2-pyrimidinyl)amino]carbonyl]-3-trifluoromethyl-2-pyridinesulphonamide(flazasulfuron), N-(2,6-difluorophenyl)-8-fluoro-5-methoxy-[1,2,4]-triazolo-[1,5-c]-pyrimidine-2-sulphonamide(florasulam), (R)-butyl 2-[4-(5-trifluoromethylpyridin-2-yloxy)phenoxy]propanoate (fluazifop-P-butyl), isopropyl 5-(4-bromo-1-methyl-5-trifluoromethyl-1H-pyrazol-3-yl)-2-chloro-4-fluorobenzoate (fluazolate), N-(4-fluorophenyl)-N-isopropyl-2-(5-trifluoromethyl-1,3,4-thiadiazol-2-yloxy)acetamide(flufenacet), ethyl [2-chloro-4-fluoro-5-(5-methyl-6-oxo-4-trifluoromethyl-1 (6H)-pyridazinyl)phenoxy]acetate(flufenpyr), N-(2,6-difluorophenyl)-5-methyl-1,2,4-triazolo[1,5-a]-pyrimidine-2-sulphonamide(flumetsulam), pentyl [2-chloro-4-fluoro-5-(1,3,4,5,6,7-hexahydro-1,3-dioxo-2H-isoindol-2-yl)phenoxy]acetate(flumiclorac-pentyl), 2-[7-fluoro-3,4-dihydro-3-oxo-4-(2-propynyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propynyl)oxy]phenyl]-4,5,6,7-tetrahydro-1H-isoindole-1,3(2H)-dione (flumipropyn), N,N-dimethyl-N′-(3-trifluoromethylphenyl)urea (fluometuron), 3-chloro-4-chloromethyl-1-(3-trifluoromethylphenyl)-2-pyrrolidinone (fluorochloridone), ethoxycarbonylmethyl 5-(2-chloro-4-trifluoromethylphenoxy)-2-nitrobenzoate (fluoroglycofen-ethyl), 1-(4-chloro-3-(2,2,3,3,3-pentafluoropropoxymethyl)phenyl)-5-phenyl-1H-1,2,4-triazol-3-carboxamide(flupoxam), 1-isopropyl-2-chloro-5-(3,6-dihydro-3-methyl-2,6-dioxo-4-trifluoromethyl-1(2H)-pyrimidyl)benzoate (flupropacil), N-(4,6-dimethoxypyrimidin-2-yl)-N′-(3-methoxycarbonyl-6-trifluoromethylpyridin-2-ylsulphonyl)urea sodium salt (flupyrsulfuron-methyl-sodium), 9-hydroxy-9H-fluorene-9-carboxylic acid (flurenol), (4-amino-3,5-dichloro-6-fluoropyridin-2-yloxy)acetic acid (2-butoxy-1-methylethyl ester, 1-methylheptyl ester) (fluroxypyr, -butoxypropyl, -meptyl), 5-methylamino-2-phenyl-4-(3-trifluoromethylphenyl)-3(2H)-furanone (flurtamone), methyl [(2-chloro-4-fluoro-5-(tetrahydro-3-oxo-1H,3H-[1,3,4]-thiadiazolo-[3,4-a]-pyridazin-1-ylidene)aminophenyl]thioacetate(fluthiacet-methyl), 5-(2-chloro-4-trifluoromethylphenoxy)-N-methylsulphonyl-2-nitrobenzamide(fomesafen), 2-[[[[(4,6-dimethoxy-2-pyrimidinyl)amino]carbonyl]amino]sulphonyl]-4-formylamino-N,N-dimethylbenzamide (foramsulfuron), 2-amino-4-(hydroxymethylphosphinyl)butanoic acid (ammonium salt) (glufosinate (ammonium)), N-phosphonomethylglycine (isopropylammonium salt) (glyphosate, isopropylammonium), methyl 3-chloro-5-[[[[(4,6-dimethoxy-2-pyrimidinyl)amino]carbonyl]amino]sulphonyl]-1-methyl-1H-pyrazole-4-carboxylate (halosulfuron-methyl), (R)-2-[4-(3-chloro-5-trifluoromethylpyridin-2-yloxy)phenoxy]propanoic acid (methyl ester, 2-ethoxyethyl ester, butyl ester) (haloxyfop, -methyl, —P-methyl, -ethoxyethyl, -butyl), 3-cyclohexyl-6-dimethylamino-1-methyl-1,3,5-triazine-2,4(1H,3H)-dione (hexazinone), methyl 2-(4,5-dihydro-4-methyl-4-isopropyl-5-oxo-1H-imidazol-2-yl)-4-methylbenzoate (imazamethabenz-methyl), 2-(4,5-dihydro-4-methyl-4-isopropyl-5-oxo-1H-imidazol-2-yl)-5-methoxymethylpyridine-3-carboxylic acid (imazamox), 2-(4,5-dihydro-4-methyl-4-isopropyl-5-oxo-1H-imidazol-2-yl)-5-methylpyridine-3-carboxylic acid (imazapic), 2-(4,5-dihydro-4-methyl-4-(isopropyl)-5-oxo-1H-imidazol-2-yl)-3-pyridinecarboxylic acid (imazapyr), 2-(4,5-dihydro-4-methyl-4-isopropyl-5-oxo-1H-imidazol-2-yl)quinoline-3-carboxylic acid (imazaquin), 2-(4,5-dihydro-4-methyl-4-isopropyl-5-oxo-1H-imidazol-2-yl)-5-ethylpyridine-3-carboxylic acid (imazethapyr), N-(4,6-dimethoxypyrimidin-2-yl)-N′-(2-chloroimidazo[1,2-a]-pyridin-3-ylsulphonyl)urea (imazosulfuron), 2-[2-(3-chlorophenyl)oxiranylmethyl]-2-ethyl-1H-indene-1,3(2H)-dione (indanofan), N-(4-methoxy-6-methyl-1,3,5-triazin-2-yl)-N′-(5-iodo-2-methoxycarbonylphenylsulphonyl)urea sodium salt (iodosulfuron-methyl-sodium), 4-hydroxy-3,5-diiodobenzonitrile (ioxynil), N,N-dimethyl-N′-(4-isopropylphenyl)urea (isoproturon), N-(5-t-butyl-3-isoxazolyl)-N′,N′-dimethylurea (isouron), N-(3-(1-ethyl-1-methylpropyl)isoxazol-5-yl)-2,6-dimethoxybenzamide(isoxaben), (4-chloro-2-methylsulphonylphenyl)-(5-cyclopropylisoxazol-4-yl)methanone (isoxachlortole), (5-cyclopropylisoxazol-4-yl)-(2-methylsulphonyl-4-trifluoromethylphenyl)-methanone (isoxaflutole), 2-[(2,3-dihydro-5,8-dimethyl-1,1-dioxidospiro-[4H-1-benzothiopyran-4,2′-[1,3]-dioxolan-6-yl)carbonyl]-1,3-cyclohexanedione (ketospiradox), (2-ethoxy-1-methyl-2-oxoethyl) 5-(2-chloro-4-trifluoromethylphenoxy)-2-nitrobenzoate (lactofen), 3-cyclohexyl-6,7-dihydro-1H-cyclopentapyrimidine-2,4-(3H,5H)-dione (lenacil), N′-(3,4-dichlorophenyl)-N-methoxy-N-methylurea (linuron), (4-chloro-2-methylphenoxy)acetic acid (MCPA), (R)-2-(4-chloro-2-methylphenoxy)propionic acid (mecoprop-P), 2-(2-benzothiazolyloxy)-N-methyl-N-phenylacetamide (mefenacet), methyl 2-[[[[(4,6-dimethoxy-2-pyrimidin-yl)amino]carbonyl]amino]sulphonyl]4-[[(methylsulphonyl)amino]methyl]benzoate (mesosulfuron), 2-(4-methylsulphonyl-2-nitrobenzoyl)-1,3-cyclohexanedione (mesotrione), 4-amino-3-methyl-6-phenyl-1,2,4-triazin-5(4H)-one (metamitron), 2-chloro-N-(2,6-dimethylphenyl)-N-(1H-pyrazol-1-ylmethyl)acetamide(metazachlor), N-(2-benzothiazolyl)-N,N′-dimethylurea (methabenzthiazuron), N′-(4-bromophenyl)-N-methoxy-N-methylurea (metobromuron), (S)-2-chloro-N-(2-ethyl-6-methylphenyl)-N-(2-methoxy-1-methylethyl)acetamide(metolachlor, S-metolachlor), N-(2,6-dichloro-3-methylphenyl)-5,7-dimethoxy-1,2,4-triazolo [1,5-a]-pyrimidine-2-sulphonamide (metosulam), N′-(3-chloro-4-methoxyphenyl)-N,N-dimethylurea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonylphenylsulphonyl)urea (metsulfuron-methyl), S-ethyl hexahydro-1H-azepine-1-carbothioate (molinate), 2-(2-naphthyloxy)-N-phenylpropananilide (naproanilide), N,N-diethyl-2-(1-naphthalenyloxy)propanamide (napropamide), N-butyl-N′-(3,4-dichlorophenyl)-N-methylurea (neburon), N-(4,6-dimethoxypyrimidin-2-yl)-N′-(3-dimethylcarbamoylpyridin-2-ylsulphonyl)urea (nicosulfuron), 4-chloro-5-methylamino-2-(3-trifluoromethylphenyl)-3(2H)pyridazinone (norflurazon), S-(2-chlorobenzyl) N,N-diethylthiocarbamate (orbencarb), 4-dipropylamino-3,5-dinitrobenzenesulphonamide(oryzalin), 3-[2,4-dichloro-5-(2-propynyloxy)phenyl]-5-(t-butyl)-1,3,4-oxadiazol-2(3H)-one (oxadiargyl), 3-[2,4-dichloro-5-(1-methylethoxy)phenyl]-5-(t-butyl)-1,3,4-oxadiazol-2(3H)-one (oxadiazon), N-(4,6-dimethylpyrimidin-2-yl)-N′-(2-oxetan-3-yloxycarbonylphenylsulphonyl)urea (oxasulfuron), 3-[1-(3,5-dichlorophenyl)-1-isopropyl]-2,3-dihydro-6-methyl-5-phenyl-4H-1,3-oxazin-4-one (oxaziclomefone), 2-chloro-1-(3-ethoxy-4-nitrophenoxy)-4-trifluoromethylbenzene (oxyfluorfen), 1,1′-dimethyl-4,4′-bipyridinium (paraquat), 1-amino-N-(1-ethylpropyl)-3,4-dimethyl-2,6-dinitrobenzene (pendimethalin), 4-(t-butyl)-N-(1-ethylpropyl)-2,6-dinitrobenzeneamine(pendralin), 2-(2,2-difluoroethoxy)-N-(5,8-dimethoxy[1,2,4]triazolo[1,5-c]pyrimidin-2-yl)-6-trifluoromethylbenzenesulphonamide (penoxsulam), 3-(4-chloro-5-cyclopentyloxy-2-fluorophenyl)-5-(1-methylethylidene)-2,4-oxazolidinedione (pentoxazone), 2-chloro-N-(2-ethoxyethyl)-N-(2-methyl-1-phenyl-1-propenyl)acetamide(pethoxamid), O-methyl N-[3-(3-methylphenylaminocarbonyloxy)phenyl]carbamate (phenmedipham), 4-amino-3,5,6-trichloropyridine-2-carboxylic acid (picloram), N-(4-fluorophenyl)-6-(3-trifluoromethylphenoxy)pyridine-2-carboxamide(picolinafen), S-[2-(2-methyl-1-piperidinyl)-2-oxoethyl]O,O-dipropyl phosphorodithioate (piperophos), 2-chloro-N-(2,6-diethylphenyl)-N-(2-propoxyethyl)acetamide(pretilachlor), N-(4,6-bis-difluoromethoxypyrimidin-2-yl)-N′-(2-methoxycarbonylphenylsulphonyl)urea (primisulfuron-methyl), 1-chloro-N-[2-chloro-4-fluoro-5-[(6S,7aR)-6-fluorotetrahydro-1,3-dioxo-1H-pyrrolo[1,2-c]imidazol-2(3H)yl]phenyl]methanesulphonamide(profluazol), 2-[1-[[2-(4-chlorophenoxy)propoxy]imino]butyl]-3-hydroxy-5-(tetrahydro-2H-thiopyranyl)-2-cyclohexen-1-one (profoxydim), N,N′-bis-isopropyl-6-methylthio-1,3,5-triazine-2,4-diamine(prometryn), 2-chloro-N-isopropyl-N-phenylacetamide(propachlor), N-(3,4-dichlorophenyl)propanamide(propanil), (R)-[2-[[(1-methylethylidene)amino]oxy]ethyl]2-[4-(6-chloro-2-quinoxalinyloxy)phenoxy]propanoate (propaquizafop), 2-chloro-N-(2-ethyl-6-methylphenyl)-N-[(1-methylethoxy)methyl]acetamide(propisochlor), methyl 2-[[[(4,5-dihydro-4-methyl-5-oxo-3-propoxy-1H-1,2,4-triazol-1-yl)carbonyl]amino]sulphonyl]benzoate sodium salt (propoxycarbazone-sodium), 3,5-dichloro-N-(1,1-dimethyl-2-propynyl)benzamide (propyzamide), S-phenylmethyl N,N-dipropylthiocarbamate (prosulfocarb), N-(4-methoxy-6-methyl-1,3,5-triazin-2-yl)-N′-(2-(3,3,3-trifluoropropyl)phenylsulphonyl) urea (prosulfuron), 1-(3-chloro-4,5,6,7-tetrahydropyrazolo[1,5-a]pyridin-2-yl)-5-(methyl-2-propynylamino)-1H-pyrazole-4-carbonitrile (pyraclonil), ethyl [2-chloro-5-(4-chloro-5-difluoromethoxy-1-methyl-1H-pyrazol-3-yl)-4-fluorophenoxy]acetate (pyraflufen-ethyl), 4-(2,4-dichlorobenzoyl)-1,3-dimethyl-5-(4-methylphenylsulphonyloxy)pyrazole (pyrazolate), N-(4,6-dimethoxypyrimidin-2-yl)-N′-(4-ethoxycarbonyl-1-methylpyrazol-5-ylsulphonyl)urea (pyrazosulfuron-ethyl), 4-(2,4-dichlorobenzoyl)-1,3-dimethyl-5-(phenylcarbonylmethoxy)pyrazole (pyrazoxyfen), diphenylmethanone 0-[2,6-bis-(4,6-dimethoxypyrimidin-2-yloxy)benzoyl]oxime (pyribenzoxim), 0-[3-(1,1-dimethylethyl)phenyl](6-methoxy-2-pyridinyl)methylthiocarbamate (pyributicarb), 6-chloro-3-phenyl-4-pyridazinol (pyridafol), 0-(6-chloro-3-phenylpyridazin-4-yl)S-octyl thiocarbonate (pyridate), 6-chloro-3-phenylpyridazin-4-ol (pyridatol), 7-[(4,6-dimethoxy-2-pyrimidinyl)thio]-3-methyl-1-(3H)-isobenzofuranone (pyriftalid), methyl 2-(4,6-dimethoxypyrimidin-2-yloxy)benzoate (pyriminobac-methyl), 2-chloro-6-(4,6-dimethoxypyrimidin-2-yl-thio)benzoic acid sodium salt (pyrithiobac-sodium), 3,7-dichloroquinoline-8-carboxylic acid (quinchlorac), 7-chloro-3-methylquinoline-8-carboxylic acid (quinmerac), 2-amino-3-chloro-1,4-naphthalenedione (quinoclamine), (R)-2-[4-(6-chloro-2-quinoxalinyloxy)phenoxy]propanoic acid (ethyl ester, tetrahydro-2-furanylmethyl ester) (quizalofop, -ethyl, —P-ethyl, —P-tefuryl), N-(4,6-dimethoxypyrimidin-2-yl)-N′-(3-ethylsulphonylpyridin-2-ylsulphonyl)urea (rimsulfuron), 2-(1-ethoximinobutyl)-5-(2-ethylthiopropyl)-3-hydroxy-2-cyclohexen-1-one (sethoxydim), 6-chloro-2,4-bisethylamino-1,3,5-triazine (simazine), 2-(2-chloro-4-methylsulphonylbenzoyl)cyclohexane-1,3-dione (sulcotrione), 2-(2,4-dichloro-5-methylsulphonylaminophenyl)-4-difluoromethyl-5-methyl-2,4-dihydro-3H-1,2,4-triazol-3-one (sulfentrazone), methyl 2-[[[[(4,6-dimethyl-2-pyrimidinyl)amino]carbonyl]amino]sulphonyl]benzoate (sulfo-meturon-methyl), N-phosphonomethylglycine trimethylsulphonium (sulfosate), N-(4,6-dimethoxypyrimidin-2-yl)-N′-(2-ethylsulphonyl)imidazo[1,2-a]pyridine-3-sulphonamide(sulfosulfuron), N-(5-t-butyl-1,3,4-thiadiazol-2-yl)-N,N′-dimethylurea (tebuthiuron), 2-[1-[(3-chloro-2-propenyl)oxyimino]propyl]-3-hydroxy-5-(tetrahydro-2H-pyran-4-yl)-2-cyclohexen-1-one (tepraloxydim), 6-chloro-4-ethylamino-2-t-butylamino-1,3,5-triazine (terbuthylazine), 2-t-butylamino-4-ethylamino-6-methylthio-1,3,5-triazine (terbutryn), 2-chloro-N-(2,6-dimethylphenyl)-N-(3-methoxy-2-thienylmethyl)acetamide (thenylchlor), 2-difluoromethyl-5-(4,5-dihydrothiazol-2-yl)-4-(2-methylpropyl)-6-trifluoromethylpyridine-3-carboxylate (thiazopyr), N-(4-methoxy-6-methyl-1,3,5-triazin-2-yl)-N′-(2-methoxycarbonylthien-3-ylsulphonyl)urea (thifensulfuron-methyl), S-phenylmethyl bis-s-butylcarbamothioate (tiocarbazil), 2-(ethoximinopropyl)-3-hydroxy-5-(2,4,6-trimethylphenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloroethoxy)phenylsulphonyl]urea (triasulfuron), N-methyl-N-(4-methoxy-6-methyl-1,3,5-triazin-2-yl)-N′-(2-methoxycarbonylphenylsulphonyl)urea (tribenuron-methyl), (3,5,6-trichloro)pyridin-2-yloxyacetic acid (triclopyr), 2-(3,5-dichlorophenyl)-2-(2,2,2-trichloroethyl)oxirane (tridiphane), N-[[(4,6-dimethoxy-2-pyrimidinyl)amino]carbonyl]-3-(2,2,2-trifluoroethoxy)-2-pyridinesulphonamide sodium salt (trifloxysulfuron), 1-amino-2,6-dinitro-N,N-dipropyl-4-trifluoromethylbenzene (trifluralin), N-[4-dimethylamino-6-(2,2,2-trifluoroethoxy)-1,3,5-triazin-2-yl]-N′-(2-methoxycarbonylphenylsulphonyl)-urea (triflusulfuron-methyl), N-(4-methoxy-6-trifluoromethoxy-1,3,5-triazin-2-yl)-N′-(2-trifluoromethylphenylsulphonyl)urea (tritosulfuron), N-[[(4,6-dimethoxy-2-pyrimidinyl)amino]carbonyl]-3-(N-methyl-N-methylsulphonylamino)-2-pyridinesulphonamide (cf. WO-A-92/10660), N-[[(4,6-dimethoxy-2-pyrimidinyl)amino]carbonyl]-3-(N-methyl-N-methylsulphonylamino)-2-pyridinesulphonamide(cf. WO-A-92/10660), 4-(4,5-dihydro-4-methyl-5-oxo-3-trifluoromethyl-1H-1,2,4-triazol-1-yl)-2-(ethylsulphonylamino)-5-fluorobenzenecarbothioamide (HWH4991, cf. WO-A-95/30661), 2-chloro-N-[1-(2,6-dichloro-4-difluoromethylphenyl)₄-nitro-1H-pyrazol-5-yl]propanecarboxamide (SLA5599, cf. EP-A-303153), [2-chloro-3-(4,5-dihydro-3-isoxazolyl)-4-methylsulphonylphenyl]-(5-hydroxy-1-methyl-1H-pyrazol-4-yl)methanone (cf. WO-A-96/26206, WO-A-98/31681), [3-(4,5-dihydro-3-isoxazolyl)-2-methyl-4-methylsulphonylphenyl]-(5-hydroxy-1-methyl-1H-pyrazol-4-yl)methanone (cf. WO-A-96/26206, WO-A-98/31681), [3-[2-chloro-3-[(2,6-dioxocyclohexyl)carbonyl]-6-ethylsulphonylphenyl]-5-isoxazolyl]acetonitrile (cf. WO-A-01/28341), 2-[2-chloro-4-methylsulphonyl-3-[(2,2,2-trifluoroethoxy)methyl]benzoyl]-1,3-cyclohexanedione (cf. WO-A-01/28341), 2-[[5,8-dimethyl-1,1-dioxido-4-(2-pyrimidinyloxy)-3,4-dihydro-2H-thiochromen-6-yl]carbonyl]-1,3-cyclohexanedione (cf. WO-A-01/28341)
(“active compounds of group (2)”), and/or
(c) if appropriate a compound that improves compatibility with crop plants, from the following group of compounds:
4-dichloroacetyl-1-oxa-4-azaspiro[4.5]decane (AD-67), 1-dichloroacetylhexahydro-3,3,8a-trimethylpyrrolo[1,2-a]pyrimidin-6(2H)-one (BAS-145138), 4-dichloroacetyl-3,4-dihydro-3-methyl-2H-1,4-benzoxazine (benoxacor), 4-carboxy-3,4-dihydro-2H-1-benzopyran-4-acetic acid (CL-304415), 1-methylhexyl 5-chloroquinolin-8-oxyacetate(cloquintocet-mexyl), α-(cyanomethoximino)phenylacetonitrile (cyometrinil), 2,4-dichlorophenoxy acetic acid (2,4-D), 2,2-dichloro-N-(2-oxo-2-(2-propenylamino)ethyl)-N-(2-propenyl)acetamide (DKA-24), 2,2-dichloro-N,N-di-2-propenylacetamide(dichlormid), N-(4-methylphenyl)-N′-(1-methyl-1-phenylethyl)urea (daimuron, dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazol-ethyl), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifenethyl), (4-chloro-2-methylphenoxy)acetic acid (MCPA), (+−)-2-(4-chloro-2-methylphenoxy)propanoic acid (mecoprop), diethyl 1-(2,4-dichlorophenyl)-4,5-dihydro-5-methyl-1H-pyrazol-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2,5-trimethyloxazolidine (R-29148), N-cyclopropyl-4-[[(2-methoxy-5-methylbenzoyl)amino]sulphonyl]benzamide, N-[[(4-methoxyacetylamino)phenyl]sulphonyl]-2-methoxybenzamide and N-[[(4-methylaminocarbonylamino)phenyl]sulphonyl]-2-methoxybenzamide (the latter are in each case known from WO-A-99/66795), methyl(3-oxo-isochroman-4-ylidenemethoxy)acetate and methyl(3-oxo-1H-2-benzothiopyran-4-(3H)-ylidenemethoxy)acetate (the latter are in each case known from WO-A-98/13361), 1-ethyl-4-hydroxy-3(1H-tetrazolyl-5-ylcarbonyl)-2(1H) quinoline (known from WO-A-99/00020)
(“active compounds of group (3)”).

The invention also relates to herbicidal active compound combinations which are composed
either of active compounds of groups (1) and (2),
or of active compounds of groups (1) and (3),
or of active compounds of groups (1) and (2) and (3).

Preferred meanings of the groups mentioned above in connection with the formula (I) are defined below.
n preferably represents the number 0.
A preferably represents alkanediyl (alkylene) having 1 to 5 carbon atoms or alkenediyl having 2 to 5 carbon atoms.
Ar preferably represents in each case optionally substituted phenyl or naphthyl, or represents in each case optionally substituted heterocyclyl from the group consisting of furyl, tetrahydrofuryl, thienyl, tetrahydrothienyl, benzofuryl, di-hydrobenzofuryl, benzothienyl, pyrrolyl, pyrazolyl, pyranyl, benzopyranyl, dihydrobenzopyranyl, tetrahydrobenzopyranyl, pyridinyl, quinolinyl or pyrimidinyl,
   where the substituents possible in each case are preferably selected from the following list:
   nitro, cyano, carboxyl, carbamoyl, thiocarbamoyl, fluorine, chlorine, bromine, methyl, ethyl, n- or isopropyl, n-, iso-, s- or t-butyl, trifluoromethyl, methoxy, ethoxy, n- or isopropoxy, n-, iso-, s- or t-butoxy, difluoromethoxy, trifluoro-methoxy, methylthio, ethylthio, n- or isopropylthio, n-, iso-, s- or t-butylthio, difluoromethylthio, trifluoromethylthio, methylsulphinyl, ethylsulphinyl, n- or isopropylsulphinyl, trifluoromethylsulphinyl, methylsulphonyl, ethyl-sulphonyl, n- or isopropylsulphonyl, trifluoromethylsulphonyl, methylamino, ethylamino, n- or isopropylamino, n-, iso-, s- or t-butylamino, dimethylamino, diethylamino, acetyl, propionyl, n- or isobutyroyl, methoxycarbonyl, ethoxy-carbonyl, n- or isopropoxycarbonyl, methylaminocarbonyl, ethylaminocarbonyl, n- or isopropylaminocarbonyl, dimethylaminocarbonyl, diethylaminocarbonyl, dimethylaminosulphonyl, diethylaminosulphonyl.
R¹ preferably represents optionally fluorine-, chlorine- and/or bromine-substituted alkyl having 1 to 5 carbon atoms,
   represents optionally fluorine-, chlorine- and/or bromine-substituted alkenyl having 2 to 5 carbon atoms,
   represents optionally fluorine-, chlorine- and/or bromine- or C₁-C₄-alkyl-substituted cycloalkyl having 3 to 6 carbon atoms,
   represents in each case optionally nitro-, cyano-, fluorine-, chlorine- and/or bromine-, methyl-, ethyl-, n- or isopropyl-, n-, iso-, s- or t-butyl-, methoxy-, ethoxy-, n- or isopropoxy-, n-, iso-, s- or t-butoxy-substituted aryl or arylalkyl having in each case 6 or 10 carbon atoms in the aryl group and, if appropriate, 1 to 3 carbon atoms in the alkyl moiety, or
   represents optionally nitro-, cyano-, fluorine-, chlorine- and/or bromine-, methyl-, ethyl-, n- or isopropyl-, n-, iso-, s- or t-butyl-, methoxy-, ethoxy-, n- or isopropoxy-, n-, iso, s- or t-butoxy-substituted heterocyclyl having 5 carbon atoms and 1 to 3 nitrogen atoms and/or 1 or 2 oxygen or sulphur atoms.
R² preferably represents cyano, carbamoyl, thiocarbamoyl, fluorine, chlorine, bromine, or represents in each case optionally fluorine-, chlorine- and/or bromine-substituted methyl, ethyl, n- or isopropyl, methoxy, ethoxy, or n- or isopropoxy.
R³ preferably represents hydrogen, cyano, carbamoyl, thiocarbamoyl, fluorine, chlorine or bromine.
R⁴ preferably represents hydrogen, amino or optionally fluorine-, chlorine-and/or bromine-substituted methyl, ethyl or n- or isopropyl.
R⁵ preferably represents carboxyl, cyano, carbamoyl, thiocarbamoyl or in each case optionally fluorine-, chlorine and/or bromine-substituted methyl, ethyl, n- or isopropyl, methoxycarbonyl, ethoxycarbonyl or n- or isopropoxy-carbonyl.
R⁶ preferably represents hydrogen, fluorine, chlorine, bromine or in each case optionally fluorine-, chlorine- and/or bromine-substituted methyl, ethyl or n- or isopropyl.
R⁷ preferably represents hydrogen, cyano, fluorine, chlorine, bromine or in each case optionally cyano-, fluorine-, chlorine-, bromine-, methoxy-, ethoxy-, n- or isopropoxy-, n-, iso-, s- or t-butoxy-substituted alkyl, alkoxy, alkylthio, alkylamino or dialkylamino having in each case 1 to 3 carbon atoms in the alkyl groups.
R⁸ preferably represents hydrogen or in each case optionally cyano-, fluorine-, chlorine-, bromine- or methoxy-, ethoxy-, n- or isopropoxy-, n-, iso-, s- or t-butoxy-substituted alkyl, alkoxy, alkylamino, alkylcarbonyl or alkoxycarbonyl having in each case 1 to 3 carbon atoms in the alkyl groups.
R⁹ preferably represents hydrogen, cyano, fluorine, chlorine, bromine or one of the groupings —R¹¹, —O—R¹¹, S—R¹ or SO₂—R¹¹.
R¹⁰ preferably represents hydrogen, hydroxyl, amino or the grouping —R¹¹.
R¹¹ preferably represents optionally cyano-, fluorine-, chlorine-, bromine-, methoxy-, ethoxy-, n- or isopropoxy-, n-, iso-, s- or t-butoxy-substituted alkyl having 1 to 4 carbon atoms,
   represents in each case optionally halogen-substituted alkenyl or alkynyl having in each case 2 to 4 carbon atoms,
   represents optionally cyano-, fluorine-, chlorine-, bromine-, ethyl-, methyl-, n- or isopropyl- or n-, iso-, s- or t-butyl-substituted cycloalkyl having 3 to 6 carbon atoms, or
   represents in each case optionally nitro-, cyano-, fluorine-, chlorine-, bromine-, C₁-C₄-alkyl-, C₁-C₄-haloalkyl, C₁-C₄-alkoxy or C₁-C₄-haloalkoxy-substituted phenyl or benzyl.
A particularly preferably represents methylene, ethane-1,1-diyl(ethylidene), ethane-1,2-diyl(dimethylene), propane-1,1-diyl(propylidene), propane-1,2-diyl, propane-1,3-diyl(trimethylene), ethene-1,2-diyl, propene-1,2-diyl or propene-2,3-diyl.
Ar particularly preferably represents optionally substituted phenyl, or represents optionally substituted heterocyclyl from the group consisting of furyl, tetrahydrofuryl, thienyl, benzofuryl, dihydrobenzofuryl, benzothienyl, pyrrolyl, pyrazolyl, benzopyranyl, dihydrobenzopyranyl, tetrahydrobenzopyranyl, pyridinyl and pyrimidinyl.
   where the substituents possible in each case are preferably selected from the following list:
   nitro, cyano, carboxyl, carbamoyl, thiocarbamoyl, fluorine, chlorine, bromine, methyl, ethyl, n- or isopropyl, n-, iso-, s- or t-butyl, trifluoromethyl, methoxy, ethoxy, n- or isopropoxy, difluoromethoxy, trifluoromethoxy, methylthio, ethylthio, n- or isopropylthio, difluoromethylthio, trifluoromethylthio, methylsulphinyl, ethylsulphinyl, trifluoromethylsulphinyl, methylsulphonyl, ethylsulphonyl, trifluoromethylsulphonyl, methylamino, ethylamino, n- or isopropylamino, dimethylamino, diethylamino, acetyl, propionyl, n- or isobutyroyl, methoxycarbonyl, ethoxycarbonyl, n- or isopropoxycarbonyl, methylaminocarbonyl, ethylaminocarbonyl, n- or isopropylaminocarbonyl, dimethylaminocarbonyl, diethylaminocarbonyl, dimethylaminosulphonyl, diethylaminosulphonyl.
R¹ particularly preferably represents in each case optionally fluorine-, chlorine- and/or bromine-substituted methyl, ethyl, n- or isopropyl, n-, iso-, s- or t-butyl,
   represents in each case optionally fluorine-, chlorine- and/or bromine-substituted ethenyl, propenyl or butenyl,
   represents in each case optionally fluorine-, chlorine-, bromine-, methyl-, ethyl-, n- or isopropyl-substituted cyclopropyl, cyclobutyl, cyclopentyl or cyclohexyl,
   represents in each case optionally nitro-, cyano-, fluorine-, chlorine-, brominemethyl-, ethyl-, n- or isopropyl-, n-, iso-, s- or t-butyl-, methoxy-, ethoxy-, n- or isopropoxy-substituted phenyl, naphthyl, benzyl or phenylethyl, or
   represents in each case optionally fluorine-, chlorine-, bromine-, methyl-, ethyl-, n- or isopropyl-, n-, iso-, s- or t-butyl-, methoxy-, ethoxy-, n- or isopropoxy-substituted heterocyclyl from the group consisting of furyl, thienyl, pyrazolyl and pyridinyl.
R² particularly preferably represents cyano, carbamoyl, thiocarbamoyl, fluorine, chlorine, bromine, or represents in each case optionally fluorine- and/or chlorine-substituted methyl, ethyl, methoxy or ethoxy.
R³ particularly preferably represents hydrogen, cyano, fluorine or chlorine.
R⁴ particularly preferably represents hydrogen, amino or in each case optionally fluorine-substituted methyl or ethyl.
R⁵ particularly preferably represents carboxyl, cyano, carbamoyl, thiocarbamoyl or in each case optionally fluorine- and/or chlorine-substituted methyl, ethyl, methoxycarbonyl or ethoxycarbonyl.
R⁶ particularly preferably represents hydrogen, fluorine, chlorine, bromine or in each case optionally fluorine- and/or chlorine-substituted methyl or ethyl.
R⁷ particularly preferably represents hydrogen, cyano, fluorine, chlorine, bromine or in each case optionally cyano-, fluorine-, chlorine-, methoxy-, ethoxy-, n- or isopropoxy-substituted methyl, ethyl, n- or isopropyl, methoxy, ethoxy, n- or isopropoxy, methylthio, ethylthio, n- or isopropylthio, methylamino, ethylamino, n- or isopropylamino, dimethylamino or diethylamino.
R⁸ particularly preferably represents hydrogen or in each case optionally cyano-, fluorine-, chlorine-, methoxy-, ethoxy-, n- or isopropoxy-substituted methyl, ethyl, n- or isopropyl, methoxy, ethoxy, n- or isopropoxy, methylamino, ethylamino, n- or isopropylamino, acetyl, propionyl, n- or isobutyroyl, methoxycarbonyl, ethoxycarbonyl, n- or isopropoxycarbonyl.
R⁹ particularly preferably represents hydrogen, cyano, fluorine, chlorine, bromine or the grouping —O—R¹¹ or SO₂—R¹¹.
R¹⁰ particularly preferably represents hydrogen or the grouping —R¹¹.
R¹¹ particularly preferably represents in each case optionally cyano-, fluorine-, chlorine-, bromine-, methoxy-, ethoxy-, n- or isopropoxy-substituted methyl, ethyl, n- or isopropyl, n-, iso-, s- or t-butyl,
   represents in each case optionally fluorine-, chlorine- and/or bromine-substituted ethenyl, propenyl, butenyl, ethynyl, propynyl or butynyl,
   represents in each case optionally cyano-, fluorine-, chlorine-, bromine-, methyl, ethyl-, n- or isopropyl-substituted cyclopropyl, cyclobutyl, cyclopentyl or cyclohexyl, or
   represents in each case optionally nitro-, cyano-, fluorine-, chlorine-, bromine-methyl-, ethyl-, n- or isopropyl-, n-, iso-, s- or t-butyl-, trifluoromethyl-, methoxy-, ethoxy-, n- or isopropoxy-, difluoromethoxy- or trifluoromethoxy-substituted phenyl or benzyl.
A very particularly preferably represents methylene, ethane-1,1-diyl (ethylidene), ethane-1,2-diyl(dimethylene), propane-1,1-diyl(propylidene), ethene-1,2-diyl, propene-1,2-diyl or propene-2,3-diyl.
Ar very particularly preferably represents optionally substituted phenyl, pyridinyl or pyrimidinyl,
   where the substituents possible in each case are preferably selected from the following list:
   cyano, carbamoyl, thiocarbamoyl, fluorine, chlorine, bromine, methyl, ethyl, trifluoromethyl, methoxy, ethoxy and trifluoromethoxy.
R¹ very particularly preferably represents in each case optionally fluorine- and/or chlorine-substituted methyl, ethyl, n- or isopropyl, n-, iso or s-butyl, represents optionally fluorine-, chlorine- or methyl-substituted cyclopropyl, represents in each case optionally fluorine-, chlorine-, bromine-, methyl-, ethyl-, methoxy- or ethoxy-substituted phenyl or benzyl, or represents in each case optionally fluorine-, chlorine-, bromine-, methyl-, ethyl-, methoxy- or ethoxy-substituted heterocyclyl from the group consisting of furyl, thienyl, pyrazolyl and pyridinyl.
R² very particularly preferably represents cyano, chlorine, bromine or trifluoromethyl.
R³ very particularly preferably represents hydrogen, fluorine or chlorine.
R⁴ very particularly preferably represents hydrogen, amino or methyl.
R⁵ very particularly preferably represents cyano or trifluoromethyl.
R⁶ very particularly preferably represents hydrogen, chlorine, bromine or methyl.
R⁷ very particularly preferably represents hydrogen, cyano, fluorine, chlorine, bromine or in each case optionally fluorine- and/or chlorine-substituted methyl or ethyl.
R⁸ very particularly preferably represents hydrogen or in each case optionally fluorine-substituted methyl or ethyl.
R⁹ very particularly preferably represents hydrogen, chlorine, bromine or the grouping —R¹¹.
R¹¹ very particularly preferably represents in each case optionally fluorine-, chlorine-, methoxy- or ethoxy-substituted methyl, ethyl, n- or isopropyl, or represents optionally fluorine-, chlorine- or methyl-substituted cyclopropyl.

A very particularly preferred group of the active compound components of the formula (I) according to the invention are those compounds in which Z represents the grouping designated Z¹ and n, A, Ar, R¹, R² and R³ have one of the meanings mentioned above.

A further very particularly preferred group of the active compound components of the formula (I) according to the invention are those compounds in which Z represents the grouping designated Z² and n, A, Ar, R¹, R² and R³ have one of the meanings mentioned above.

A further very particularly preferred group of the active compound components of the formula (1) according to the invention are those compounds in which Z represents the grouping designated Z³ and n, A, Ar, R¹, R² and R³ have one of the meanings mentioned above.

Examples of compounds of the formula (I) which are very particularly preferred as active compound components according to the invention are listed in Table 1 below.

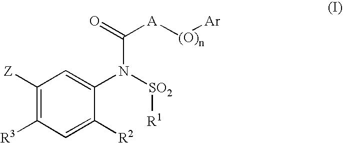

TABLE 1
Examples of the compounds of the formula (I)

| Ex. No. | n | A | Ar | R¹ | R² | R³ | Z |
|---|---|---|---|---|---|---|---|
| I-1 | 1 | CH₂ | 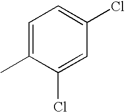 | C₂H₅ | CN | F | 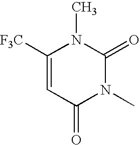 |
| I-2 | 0 | CH₂CH₂ | 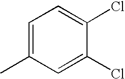 | C₂H₅ | CN | F | 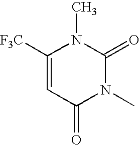 |
| I-3 | 0 | CH₂ | 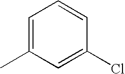 | C₂H₅ | CN | F | 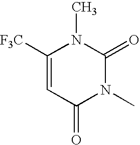 |
| I-4 | 1 | CH₂ | 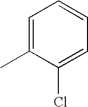 | C₂H₅ | CN | F | 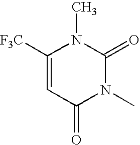 |
| I-5 | 0 | CH(CH₃) | 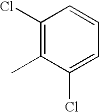 | C₂H₅ | CN | F | 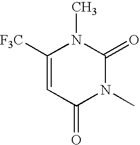 |
| I-6 | 1 | CH₂ | 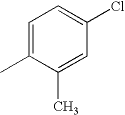 | C₂H₅ | CN | F | 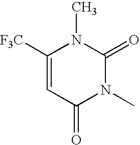 |
| I-7 | 0 | CH₂ | 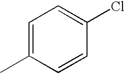 | C₂H₅ | CN | F | 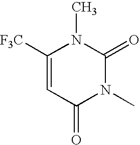 |
| I-8 | 1 | CH₂ | 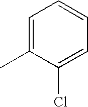 | CH₃ | CN | F | 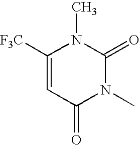 |
| I-9 | 1 | CH₂ | 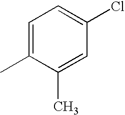 | CH₃ | CN | F | 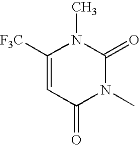 |
| I-10 | 0 | CH₂ | 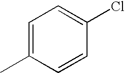 | CH₃ | CN | F | 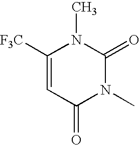 |
| I-11 | 1 | CH₂ | 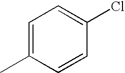 | CH₃ | CN | F | 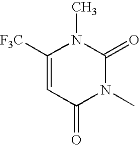 |
| I-12 | 0 | CH₂CH₂ | 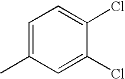 | CH₃ | CN | F | 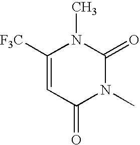 |
| I-13 | 0 | CH₂ | 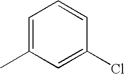 | CH₃ | CN | F | 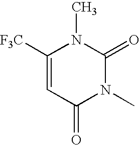 |
| I-14 | 0 | CH₂CH₂ | 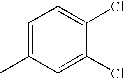 | C₂H₅ | CN | F | 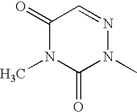 |
| I-15 | 1 | CH₂ | 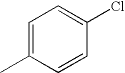 | C₂H₅ | CN | F | 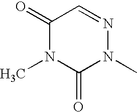 |
| I-16 | 1 | CH₂ | 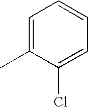 | C₂H₅ | CN | F | 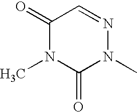 |
| I-17 | 0 | CH₂ | 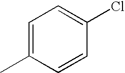 | C₂H₅ | CN | F | 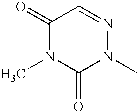 |
| I-18 | 1 | CH₂ | 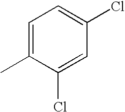 | C₂H₅ | CN | F | 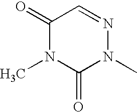 |
| I-19 | 1 | CH₂ | 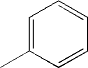 | C₂H₅ | CN | F | 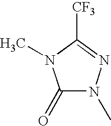 |
| I-20 | 0 | CH₂CH₂ | 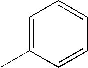 | C₂H₅ | CN | F | 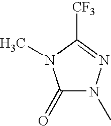 |
| I-21 | 1 | CH(CH₃) | 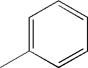 | C₂H₅ | CN | F | 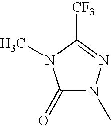 |
| I-22 | 0 | CH═CH | 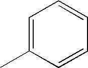 | C₂H₅ | CN | F | 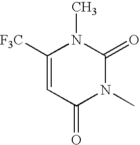 |
| I-23 | 0 | CH═CH | 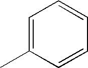 | CH₃ | CN | F | 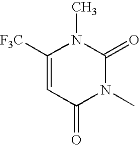 |
| I-24 | 0 | CH₂CH₂ | 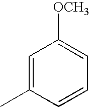 | C₂H₅ | CN | F | 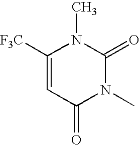 |
| I-25 | 0 | CH₂CH₂ | 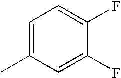 | C₂H₅ | CN | F | 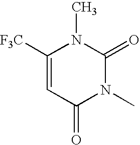 |
| I-26 | 0 | CH₂CH₂ | 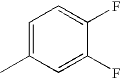 | CH₃ | CN | F | 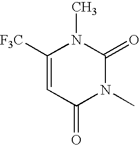 |
| I-27 | 0 | CH═CH | 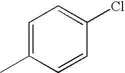 | C₂H₅ | CN | F | 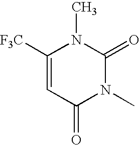 |
| I-28 | 0 | CH═CH | 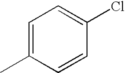 | CH₃ | CN | F | 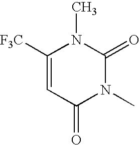 |
| I-29 | 0 | C(CH₃)═CH | 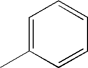 | C₂H₅ | CN | F | 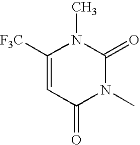 |
| I-30 | 0 | CH═C(CH₃) | 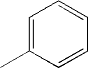 | CH₃ | CN | F | 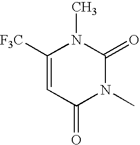 |
| I-31 | 0 | CH═CH | 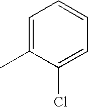 | C₂H₅ | CN | F | 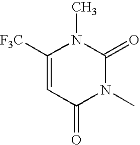 |
| I-32 | 0 | CH═CH | 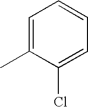 | CH₃ | CN | F | 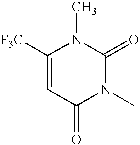 |
| I-33 | 0 | CH₂CH₂ | 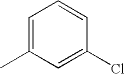 | C₂H₅ | CN | F | 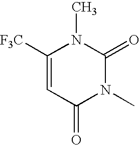 |
| I-34 | 0 | CH═CH | 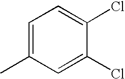 | C₂H₅ | CN | F | 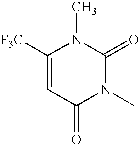 |
| I-35 | 0 | CH═CH | 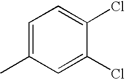 | CH₃ | CN | F | 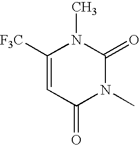 |
| I-36 | 0 | CH═CH | 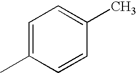 | C₂H₅ | CN | F | 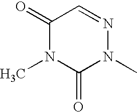 |
| I-37 | 0 | CH═CH | 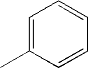 | C₂H₅ | CN | F | 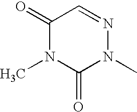 |
| I-38 | 0 | CH═CH | 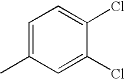 | C₂H₅ | CN | F | 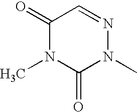 |
| I-39 | 0 | C(CH₃)═CH | 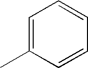 | C₂H₅ | CN | F | 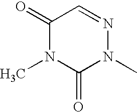 |
| I-40 | 0 | CH₂CH(CH₃) | 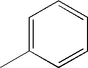 | C₂H₅ | CN | F | 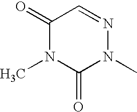 |
| I-41 | 0 | CH₂CH₂ | 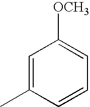 | C₂H₅ | CN | F | 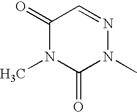 |
| I-42 | 0 | CH₂CH₂ | 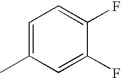 | C₂H₅ | CN | F | 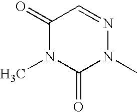 |
| I-43 | 0 | CH₂CH₂ | 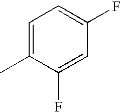 | C₂H₅ | CN | F | 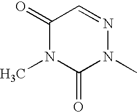 |
| I-44 | 0 | CH₂CH₂ | 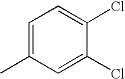 | C₂H₅ | CN | F | 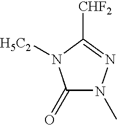 |
| I-45 | 0 | CH₂CH₂ | 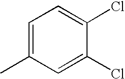 | C₂H₅ | CN | F | 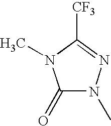 |
| I-46 | 0 | CH₂CH₂ | 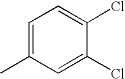 | C₂H₅ | CN | F | 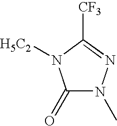 |

According to their chemical structure, the active compounds of Group (2) can be assigned to the following classes of active compounds:

Amides (for example isoxaben, picolinafen, propanil), arylheterocycles (for example azafenidin, benzfendizone, butafenacil-allyl, carfentrazone-ethyl, cinidon-ethyl, fluazolate, flumiclorac-pentyl, flumioxazin, flupropacil, fluthiacet-methyl, oxadiazon, oxadiargyl, profluazol, pyraflufen-ethyl, pyridate, pyridafol, sulfentrazone, 4-[4,5-dihydro-4-methyl-5-oxo-(3-trifluoromethyl)-1H-1,2,4-triazol-1-yl]-2-[(ethylsulphonyl)amino]-5-fluorobenzenecarbothioamide), aryloxyphenoxypropionates (for example clodinafop-propargyl, cyhalofop-butyl, diclofop-methyl, fenoxaprop-P-ethyl, fluazifop-P-butyl, haloxyfop-P-methyl, quizalofop-P-ethyl), carboxylic acid derivatives (for example clopyralid, dicamba, fluroxypyr, picloram, triclopyr), benzothiadiazoles (for example bentazone), chloroacetamides (for example acetochlor, alachlor, butachlor, (S—)dimethenamid, metazachlor, metolachlor, pretilachlor, propachlor, propisochlor), cyclohexanediones (for example butroxydim, clefoxydim, cycloxydim, sethoxydim, tralkoxydim), dinitroanilines (for example benfluralin, ethalfluralin, oryzalin, pendimethalin, trifluralin), diphenyl ethers (for example acifluorfen-sodium, aclonifen, bifenox, fluoroglycofen-ethyl, fomesafen, lactofen, oxyfluorfen), ureas (for example chlorotoluron, diuron, isoproturon, linuron, metobromuron, metoxuron), imidazolinones (for example imazamethabenz-methyl, imazamox, imazaquin, imazethapyr), isoxazoles (for example isoxaflutole), nicotinanilides (for example diflufenican), nitriles (for example bromoxynil, ioxynil), organophosphorus compounds (for example anilofos, glufosinate-ammonium, glyphosate-isopropylammonium, sulfosate), oxyacetamides (for example flufenacet, mefenacet), phenoxycarboxylic acid derivatives (for example 2,4-D, dichloroprop-P, MCPA, MCPB, mecoprop), pyrazoles (for example pyrazolate, pyrazoxyfen), pyridazinones (for example norflurazon), pyridines (for example dithiopyr, thiazopyr), pyrimidinyl-(thio)benzoates (for example bispyribac, pyribenzoxim, pyrithiobac, pyriminobac), sulphonylureas (for example amidosulfuron, azimsulfuron, bensulfuron-methyl, chloroimuron-ethyl, chlorosulfuron, cinosulfuron, cyclosulfamuron, ethoxysulfuron, flupyrsulfuron-methyl-sodium, foramsulfuron, iodosulfuron-methyl-sodium, imazo-sulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron, triflusulfuronmethyl, tritosulfuron), tetrazolinones (for example fentrazamide), thiocarbamates (for example butylate, dimepiperate, EPTC, esprocarb, molinate, orbencarb, prosulfocarb, triallate), triazines (for example ametryn, atrazine, cyanazine, dimexyflam, simazine, terbuthylazine, terbutryn), triazinones (for example hexazinone, metamitron, metribuzin), triazoles (for example amitrole), triazolinones (for example amicarbazone, flucarbazone-sodium, propoxycarbazone-sodium), triazolopyrimidines (for example cloransulam-methyl, diclosulam, florasulam, flumetsulam, metosulam), triketones (for example mesotrione, sulcotrione), uracils (for example bromacil).

A particularly preferred group of compounds of Group (2) are the triazolinones, sulphonylureas (in particular iodosulfuron-methyl sodium), aryloxyphenoxypropionates (in particular fenoxaprop-P-ethyl) and isoxazoles.

Mixing components from the active compounds of the Group (2) which are furthermore particularly emphasized are:
flucarbazone-sodium, acetochlor, aclonifen, alachlor, amicarbazone, amidosulfuron, amitrole, anilofos, asulam, atrazine, beflubutamid, benazolin (-ethyl), benfuresate, bentazone, bifenox, bispyribac-sodium, bromoxynil, butylate, carfentrazone-ethyl, chlorotoluron, chlorosulfuron, cinidon-ethyl, clodinafop-propargyl, clopyralid, cyanazine, 2,4-D, desmedipham, dicamba, dichlorprop-P, diclofop-methyl, difenzoquat, diflufenican, diflufenzopyr, dimethenamid, S-dimethenamid, EPTC, ethofumesate, ethoxysulfuron, fenoxaprop-ethyl, fenoxaprop-P-ethyl, fentrazamide, flamprop-M-isopropyl, flarnprop-M-methyl, florasulam, fluazifop-P-butyl, fluazolate, flufenacet, flumetsulam, fluoroglycofen-ethyl, flupyrsulfuron-methyl-sodium, fluroxypyr, -butoxypropyl, -meptyl, flurtamone, fluthiacet-methyl, foramsulfuron, glufosinate, glufosinate-ammonium, halosulfuron-methyl, haloxyfop-P-methyl, imazamethabenzmethyl, imazamox, imazapic, imazapyr, imazaquin, imazethapyr, iodosulfuron-methyl-sodium, ioxynil, isoproturon, isoxaben, isoxachlortole, isoxaflutole, lactofen, linuron, MCPA, mecoprop-P, mefenacet, mesosulfuron, mesotrione, metamitron, metazachlor, methabenzthiazuron, metolachlor, S-metolachlor, metosulam, metribuzin, metsulfuron-methyl, naproanilide, neburon, nicosulfuron, oxadiargyl, oxadiazon, oxaziclomefone, oxyfluorfen, pendimethalin, penoxsulam, phenmedipham, picolinafen, primisulfuron-methyl, profluazol, propanil, propoxycarbazone-sodium, prosulfocarb, prosulfuron, pyraclonil, pyraflufen-ethyl, pyribenzoxim, pyridafol, pyridate, qinclorac, quinmerac, rimsulfuron, sulcotrione, sulfosate, sulfosulfuron, terbuthylazine, thifensulfuron-methyl, tralkoxydim, triallate, triasulfuron, tribenuronmethyl, tritosulfuron, 4-(4,5-dihydro-4-methyl-5-oxo-3-trifluoromethyl-1H-1,2,4-triazol-1-yl)-2-(ethylsulphonylamino)-5-fluoro-benzenecarbothioamide (HWH4991) and 2-chloro-N-[1-(2,6-dichloro-4-difluoromethylphenyl)-4-nitro-1H-pyrazol-5-yl]propanecarboxamide(StA5599).

Among the active compounds of Group (2), particular emphasis is given to the following mixing components:
aclonifen, amicarbazone, amidosulfuron, amitrole, anilofos, asulam, benazolin-ethyl, benfuresate, bifenox, bispyribac-sodium, bromoxynil, desmedipham, diclofopmethyl, diflufenican, ethofumesate, ethoxysulfuron, fenoxaprop-ethyl, fenoxaprop-P-ethyl, fentrazamide, fluazifop-P-butyl, fluazolate, flucarbazone-sodium, flufenacet, flurtamone, foramsulfuron, glufosinate, glufosinate-ammonium, iodosulfuron, ioxynil, isoproturon, isoxachlortole, isoxaflutole, lactofen, linuron, mefenacet, mesosulfuron, metamitron, methabenzthiazuron, metribuzin, neburon, oxadiargyl, oxadiazon, oxaziclomefone, phenmedipham, propanil, propoxycarbazone-sodium, pyraclonil, pyraflufen-ethyl and sulcotrione.

Among the active compounds of Group (3), particular emphasis is given to the following mixing components:
1-methylhexyl 5-chloroquinolin-8-oxyacetate(cloquintocet-mexyl), ethyl 4,5-dihydro-5,5-diphenyl-3-isoxazolecarboxylate (isoxadifen-ethyl) and diethyl 1-(2,4-dichlorophenyl)-4,5-dihydro-5-methyl-1H-pyrazole-3,5-dicarboxylate (mefenpyrdiethyl), particularly suitable for improving the compatibility in barley and wheat and, to a certain extent, also in maize and rice, and also 4-dichloroacetyl-1-oxa-4-azaspiro[4.5]-decane (AD-67), 1-dichloroacetylhexahydro-3,3,8a-trimethylpyrrolo [1,2-a]pyrimidin-6(2H)-one (BAS-145138), 4-dichloroacetyl-3,4-dihydro-3-methyl-2H-1,4-benzoxazine (benoxacor), 2,2-dichloro-N,N-di-2-propenylacetamide (dichlormid), 3-dichloroacetyl-5-(2-furanyl)-2,2-dimethyloxazolidine (furilazole, MON-13900) and 3-dichloroacetyl-2,2,5-trimethyloxazolidine (R-29148), particularly suitable for improving the compatibility in maize. As active compound of Group (3), mefenpyr-diethyl is of particular interest.

The compositions according to the invention preferably comprise one or two active compounds of Group (1) and one to three active compounds of Group (2) and/or, if appropriate, one active compound of Group (3).

In particular, the compositions according to the invention comprise one active compound of Group (1) and one or two active compounds of Group (2) and/or, if appropriate, one active compound of Group (3).

Examples of combinations according to the invention of in each case one active compound of Group (1) and one or two active compounds of Group (2) and also combinations of in each case one active compound of Group (1), one or two active compounds of Group (2) and one compound of Group (3) are listed below in Table 2.

Here, the names of the active compounds of the formula (I) (active compounds of Group (1)) are in each case taken from Table 1.

TABLE 2
Examples of combinations comprising one active compound
of Group (1) and one or two active compounds of Group (2)
and, if appropriate, one active compound of Group (3).

| Active compound of | Active compound of Group (2) (+active compound |
|---|---|
| Group (1) | of Group (3)) |
| (I-1) | aclonifen |
| (I-1) | amicarbazone |
| (I-1) | amidosulfuron |
| (I-1) | amitrole |
| (I-1) | anilofos |
| (I-1) | asulam |
| (I-1) | benazolin-ethyl |
| (I-1) | benfuresate |
| (I-1) | bifenox |
| (I-1) | bispyribac-sodium |
| (I-1) | bromoxynil |
| (I-1) | desmedipham |
| (I-1) | diclofop-methyl |
| (I-1) | diflufenican |
| (I-1) | ethofumesate |
| (I-1) | ethoxysulfuron |
| (I-1) | fenoxaprop-ethyl |
| (I-1) | fenoxaprop-P-ethyl |
| (I-1) | fentrazamide |
| (I-1) | fluazifop-P-butyl |
| (I-1) | fluazolate |
| (I-1) | flucarbazone-sodium |
| (I-1) | flufenacet |
| (I-1) | flurtamone |
| (I-1) | foramsulfuron |
| (I-1) | glufosinate |
| (I-1) | glufosinate-ammonium |
| (I-1) | iodosulfuron |
| (I-1) | ioxynil |
| (I-1) | isoproturon |
| (I-1) | isoxachlortole |
| (I-1) | isoxaflutole |
| (I-1) | lactofen |
| (I-1) | linuron |
| (I-1) | mefenacet |
| (I-1) | mesosulfuron |
| (I-1) | metamitron |
| (I-1) | methabenzthiazuron |
| (I-1) | metribuzin |
| (I-1) | neburon |
| (I-1) | oxadiargyl |
| (I-1) | oxadiazon |
| (I-1) | oxaziclomefone |
| (I-1) | phenmedipham |
| (I-1) | propanil |
| (I-1) | propoxycarbazone-sodium |
| (I-1) | pyraclonil |
| (I-1) | pyraflufen-ethyl |
| (I-1) | sulcotrione |
| (I-2) | aclonifen |
| (I-2) | amicarbazone |
| (I-2) | amidosulfuron |
| (I-2) | amitrole |
| (I-2) | anilofos |
| (I-2) | asulam |
| (I-2) | benazolin-ethyl |
| (I-2) | benfuresate |
| (I-2) | bifenox |
| (I-2) | bispyribac-sodium |
| (I-2) | bromoxynil |
| (I-2) | desmedipham |
| (I-2) | diclofop-methyl |
| (I-2) | diflufenican |
| (I-2) | ethofumesate |
| (I-2) | ethoxysulfuron |
| (I-2) | fenoxaprop-ethyl |
| (I-2) | fenoxaprop-P-ethyl |
| (I-2) | fenoxaprop-P-ethyl + mefenpyr-diethyl |
| (I-2) | fenoxaprop-P-ethyl + isoxadifen-ethyl |
| (I-2) | fentrazamide |
| (I-2) | fluazifop-P-butyl |
| (I-2) | fluazolate |
| (I-2) | flucarbazone-sodium |
| (I-2) | flufenacet |
| (I-2) | flurtamone |
| (I-2) | foramsulfuron |
| (I-2) | glufosinate |
| (I-2) | glufosinate-ammonium |
| (I-2) | iodosulfuron |
| (I-2) | ioxynil |
| (I-2) | isoproturon |
| (I-2) | isoxachlortole |
| (I-2) | isoxaflutole |
| (I-2) | lactofen |
| (I-2) | linuron |
| (I-2) | mefenacet |
| (I-2) | mesosulfuron |
| (I-2) | metamitron |
| (I-2) | methabenzthiazuron |
| (I-2) | metribuzin |
| (I-2) | neburon |
| (I-2) | oxadiargyl |
| (I-2) | oxadiazon |
| (I-2) | oxaziclomefone |
| (I-2) | phenmedipham |
| (I-2) | propanil |
| (I-2) | propoxycarbazone-sodium |
| (I-2) | pyraclonil |
| (I-2) | pyraflufen-ethyl |
| (I-2) | sulcotrione |
| (I-6) | aclonifen |
| (I-6) | amicarbazone |
| (I-6) | amidosulfuron |
| (I-6) | amitrole |
| (I-6) | anilofos |
| (I-6) | asulam |
| (I-6) | benazolin-ethyl |
| (I-6) | benfuresate |
| (I-6) | bifenox |
| (I-6) | bispyribac-sodium |
| (I-6) | bromoxynil |
| (I-6) | desmedipham |
| (I-6) | diclofop-methyl |
| (I-6) | diflufenican |
| (I-6) | ethofumesate |
| (I-6) | ethoxysulfuron |
| (I-6) | fenoxaprop-ethyl |
| (I-6) | fenoxaprop-P-ethyl |
| (I-6) | fentrazamide |
| (I-6) | fluazifop-P-butyl |
| (I-6) | fluazolate |
| (I-6) | flucarbazone-sodium |
| (I-6) | flufenacet |
| (I-6) | flurtamone |
| (I-6) | foramsulfuron |
| (I-6) | glufosinate |
| (I-6) | glufosinate-ammonium |
| (I-6) | iodosulfuron |
| (I-6) | ioxynil |
| (I-6) | isoproturon |
| (I-6) | isoxachlortole |
| (I-6) | isoxaflutole |
| (I-6) | lactofen |
| (I-6) | linuron |
| (I-6) | mefenacet |
| (I-6) | mesosulfuron |
| (I-6) | metamitron |
| (I-6) | methabenzthiazuron |
| (I-6) | metribuzin |
| (I-6) | neburon |
| (I-6) | oxadiargyl |
| (I-6) | oxadiazon |
| (I-6) | oxaziclomefone |
| (I-6) | phenmedipham |
| (I-6) | propanil |
| (I-6) | propoxycarbazone-sodium |
| (I-6) | pyraclonil |
| (I-6) | pyraflufen-ethyl |
| (I-6) | sulcotrione |
| (I-9) | aclonifen |
| (I-9) | amicarbazone |
| (I-9) | amidosulfuron |
| (I-9) | amitrole |
| (I-9) | anilofos |
| (I-9) | asulam |
| (I-9) | benazolin-ethyl |
| (I-9) | benfuresate |
| (I-9) | bifenox |
| (I-9) | bispyribac-sodium |
| (I-9) | bromoxynil |
| (I-9) | desmedipham |
| (I-9) | diclofop-methyl |
| (I-9) | diflufenican |
| (I-9) | ethofumesate |
| (I-9) | ethoxysulfuron |
| (I-9) | fenoxaprop-ethyl |
| (I-9) | fenoxaprop-P-ethyl |
| (I-9) | fentrazamide |
| (I-9) | fluazifop-P-butyl |
| (I-9) | fluazolate |
| (I-9) | flucarbazone-sodium |
| (I-9) | flufenacet |
| (I-9) | flurtamone |
| (I-9) | foramsulfuron |
| (I-9) | glufosinate |
| (I-9) | glufosinate-ammonium |
| (I-9) | iodosulfuron |
| (I-9) | ioxynil |
| (I-9) | isoproturon |
| (I-9) | isoxachlortole |
| (I-9) | isoxaflutole |
| (I-9) | lactofen |
| (I-9) | linuron |
| (I-9) | mefenacet |
| (I-9) | mesosulfuron |
| (I-9) | metamitron |
| (I-9) | methabenzthiazuron |
| (I-9) | metribuzin |
| (I-9) | neburon |
| (I-9) | oxadiargyl |
| (I-9) | oxadiazon |
| (I-9) | oxaziclomefone |
| (I-9) | phenmedipham |
| (I-9) | propanil |
| (I-9) | propoxycarbazone-sodium |
| (I-9) | pyraclonil |
| (I-9) | pyraflufen-ethyl |
| (I-9) | sulcotrione |
| (I-11) | aclonifen |
| (I-11) | amicarbazone |
| (I-11) | amidosulfuron |
| (I-11) | amitrole |
| (I-11) | anilofos |
| (I-11) | asulam |
| (I-11) | benazolin-ethyl |
| (I-11) | benfuresate |
| (I-11) | bifenox |
| (I-11) | bispyribac-sodium |
| (I-11) | bromoxynil |
| (I-11) | desmedipham |
| (I-11) | diclofop-methyl |
| (I-11) | diflufenican |
| (I-11) | ethofumesate |
| (I-11) | ethoxysulfuron |
| (I-11) | fenoxaprop-ethyl |
| (I-11) | fenoxaprop-P-ethyl |
| (I-11) | fentrazamide |
| (I-11) | fluazifop-P-butyl |
| (I-11) | fluazolate |
| (I-11) | flucarbazone-sodium |
| (I-11) | flufenacet |
| (I-11) | flurtamone |
| (I-11) | foramsulfuron |
| (I-11) | glufosinate |
| (I-11) | glufosinate-ammonium |
| (I-11) | iodosulfuron |
| (I-11) | ioxynil |
| (I-11) | isoproturon |
| (I-11) | isoxachlortole |
| (I-11) | isoxaflutole |
| (I-11) | lactofen |
| (I-11) | linuron |
| (I-11) | mefenacet |
| (I-11) | mesosulfuron |
| (I-11) | metamitron |
| (I-11) | methabenzthiazuron |
| (I-11) | metribuzin |
| (I-11) | neburon |
| (I-11) | oxadiargyl |
| (I-11) | oxadiazon |
| (I-11) | oxaziclomefone |
| (I-11) | phenmedipham |
| (I-11) | propanil |
| (I-11) | propoxycarbazone-sodium |
| (I-11) | pyraclonil |
| (I-11) | pyraflufen-ethyl |
| (I-11) | sulcotrione |
| (I-12) | aclonifen |
| (I-12) | amicarbazone |
| (I-12) | amidosulfuron |
| (I-12) | amitrole |
| (I-12) | anilofos |
| (I-12) | asulam |
| (I-12) | benazolin-ethyl |
| (I-12) | benfuresate |
| (I-12) | bifenox |
| (I-12) | bispyribac-sodium |
| (I-12) | bromoxynil |
| (I-12) | desmedipham |
| (I-12) | diclofop-methyl |
| (I-12) | diflufenican |
| (I-12) | ethofumesate |
| (I-12) | ethoxysulfuron |
| (I-12) | fenoxaprop-ethyl |
| (I-12) | fenoxaprop-P-ethyl |
| (I-12) | fentrazamide |
| (I-12) | fluazifop-P-butyl |
| (I-12) | fenoxaprop-P-ethyl + mefenpyr-diethyl |
| (I-12) | fenoxaprop-P-ethyl + isoxadifen-ethyl |
| (I-12) | fluazolate |
| (I-12) | flucarbazone-sodium |
| (I-12) | flufenacet |
| (I-12) | flurtamone |
| (I-12) | foramsulfuron |
| (I-12) | glufosinate |
| (I-12) | glufosinate-ammonium |
| (I-12) | iodosulfuron |
| (I-12) | ioxynil |
| (I-12) | isoproturon |
| (I-12) | isoxachlortole |
| (I-12) | isoxaflutole |
| (I-12) | lactofen |
| (I-12) | linuron |
| (I-12) | mefenacet |
| (I-12) | mesosulfuron |
| (I-12) | metamitron |
| (I-12) | methabenzthiazuron |
| (I-12) | metribuzin |
| (I-12) | neburon |
| (I-12) | oxadiargyl |
| (I-12) | oxadiazon |
| (I-12) | oxaziclomefone |
| (I-12) | phenmedipham |
| (I-12) | propanil |
| (I-12) | propoxycarbazone-sodium |
| (I-12) | pyraclonil |
| (I-12) | pyraflufen-ethyl |
| (I-12) | sulcotrione |
| (I-14) | aclonifen |
| (I-14) | amicarbazone |
| (I-14) | amidosulfuron |
| (I-14) | amitrole |
| (I-14) | anilofos |
| (I-14) | asulam |
| (I-14) | benazolin-ethyl |
| (I-14) | benfuresate |
| (I-14) | bifenox |
| (I-14) | bispyribac-sodium |
| (I-14) | bromoxynil |
| (I-14) | desmedipham |
| (I-14) | diclofop-methyl |
| (I-14) | diflufenican |
| (I-14) | ethofumesate |
| (I-14) | ethoxysulfuron |
| (I-14) | fenoxaprop-ethyl |
| (I-14) | fenoxaprop-P-ethyl |
| (I-14) | fentrazamide |
| (I-14) | fluazifop-P-butyl |
| (I-14) | fenoxaprop-P-ethyl + mefenpyr-diethyl |
| (I-14) | fenoxaprop-P-ethyl + isoxadifen-ethyl |
| (I-14) | fluazolate |
| (I-14) | flucarbazone-sodium |
| (I-14) | flufenacet |
| (I-14) | flurtamone |
| (I-14) | foramsulfuron |
| (I-14) | glufosinate |
| (I-14) | glufosinate-ammonium |
| (I-14) | iodosulfuron |
| (I-14) | ioxynil |
| (I-14) | isoproturon |
| (I-14) | isoxachlortole |
| (I-14) | isoxaflutole |
| (I-14) | lactofen |
| (I-14) | linuron |
| (I-14) | mefenacet |
| (I-14) | mesosulfuron |
| (I-14) | metamitron |
| (I-14) | methabenzthiazuron |
| (I-14) | metribuzin |
| (I-14) | neburon |
| (I-14) | oxadiargyl |
| (I-14) | oxadiazon |
| (I-14) | oxaziclomefone |
| (I-14) | phenmedipham |
| (I-14) | propanil |
| (I-14) | propoxycarbazone-sodium |
| (I-14) | pyraclonil |
| (I-14) | pyraflufen-ethyl |
| (I-14) | sulcotrione |
| (I-15) | aclonifen |
| (I-15) | amicarbazone |
| (I-15) | amidosulfuron |
| (I-15) | amitrole |
| (I-15) | anilofos |
| (I-15) | asulam |
| (I-15) | benazolin-ethyl |
| (I-15) | benfuresate |
| (I-15) | bifenox |
| (I-15) | bispyribac-sodium |
| (I-15) | bromoxynil |
| (I-15) | desmedipham |
| (I-15) | diclofop-methyl |
| (I-15) | diflufenican |
| (I-15) | ethofumesate |
| (I-15) | ethoxysulfuron |
| (I-15) | fenoxaprop-ethyl |
| (I-15) | fenoxaprop-P-ethyl |
| (I-15) | fentrazamide |
| (I-15) | fluazifop-P-butyl |
| (I-15) | fenoxaprop-P-ethyl + mefenpyr-diethyl |
| (I-15) | fenoxaprop-P-ethyl + isoxadifen-ethyl |
| (I-15) | fluazolate |
| (I-15) | flucarbazone-sodium |
| (I-15) | flufenacet |
| (I-15) | flurtamone |
| (I-15) | foramsulfuron |
| (I-15) | glufosinate |
| (I-15) | glufosinate-ammonium |
| (I-15) | iodosulfuron |
| (I-15) | ioxynil |
| (I-15) | isoproturon |
| (I-15) | isoxachlortole |
| (I-15) | isoxaflutole |
| (I-15) | lactofen |
| (I-15) | linuron |
| (I-15) | mefenacet |
| (I-15) | mesosulfuron |
| (I-15) | metamitron |
| (I-15) | methabenzthiazuron |
| (I-15) | metribuzin |
| (I-15) | neburon |
| (I-15) | oxadiargyl |
| (I-15) | oxadiazon |
| (I-15) | oxaziclomefone |
| (I-15) | phenmedipham |
| (I-15) | propanil |
| (I-15) | propoxycarbazone-sodium |
| (I-15) | pyraclonil |
| (I-15) | pyraflufen-ethyl |
| (I-15) | sulcotrione |
| (I-18) | aclonifen |
| (I-18) | amicarbazone |
| (I-18) | amidosulfuron |
| (I-18) | amitrole |
| (I-18) | anilofos |
| (I-18) | asulam |
| (I-18) | benazolin-ethyl |
| (I-18) | benfuresate |
| (I-18) | bifenox |
| (I-18) | bispyribac-sodium |
| (I-18) | bromoxynil |
| (I-18) | desmedipham |
| (I-18) | diclofop-methyl |
| (I-18) | diflufenican |
| (I-18) | ethofumesate |
| (I-18) | ethoxysulfuron |
| (I-18) | fenoxaprop-ethyl |
| (I-18) | fenoxaprop-P-ethyl |
| (I-18) | fentrazamide |
| (I-18) | fluazifop-P-butyl |
| (I-18) | fenoxaprop-P-ethyl + mefenpyr-diethyl |
| (I-18) | fenoxaprop-P-ethyl + isoxadifen-ethyl |
| (I-18) | fluazolate |
| (I-18) | flucarbazone-sodium |
| (I-18) | flufenacet |
| (I-18) | flurtamone |
| (I-18) | foramsulfuron |
| (I-18) | glufosinate |
| (I-18) | glufosinate-ammonium |
| (I-18) | iodosulfuron |
| (I-18) | ioxynil |
| (I-18) | isoproturon |
| (I-18) | isoxachlortole |
| (I-18) | isoxaflutole |
| (I-18) | lactofen |
| (I-18) | linuron |
| (I-18) | mefenacet |
| (I-18) | mesosulfuron |
| (I-18) | metamitron |
| (I-18) | methabenzthiazuron |
| (I-18) | metribuzin |
| (I-18) | neburon |
| (I-18) | oxadiargyl |
| (I-18) | oxadiazon |
| (I-18) | oxaziclomefone |
| (I-18) | phenmedipham |
| (I-18) | propanil |
| (I-18) | propoxycarbazone-sodium |
| (I-18) | pyraclonil |
| (I-18) | pyraflufen-ethyl |
| (I-18) | sulcotrione |
| (I-24) | aclonifen |
| (I-24) | amicarbazone |
| (I-24) | amidosulfuron |
| (I-24) | amitrole |
| (I-24) | anilofos |
| (I-24) | asulam |
| (I-24) | benazolin-ethyl |
| (I-24) | benfuresate |
| (I-24) | bifenox |
| (I-24) | bispyribac-sodium |
| (I-24) | bromoxynil |
| (I-24) | desmedipham |
| (I-24) | diclofop-methyl |
| (I-24) | diflufenican |
| (I-24) | ethofumesate |
| (I-24) | ethoxysulfuron |
| (I-24) | fenoxaprop-ethyl |
| (I-24) | fenoxaprop-P-ethyl |
| (I-24) | fentrazamide |
| (I-24) | fluazifop-P-butyl |
| (I-24) | fenoxaprop-P-ethyl + mefenpyr-diethyl |
| (I-24) | fenoxaprop-P-ethyl + isoxadifen-ethyl |
| (I-24) | fluazolate |
| (I-24) | flucarbazone-sodium |
| (I-24) | flufenacet |
| (I-24) | flurtamone |
| (I-24) | foramsulfuron |
| (I-24) | glufosinate |
| (I-24) | glufosinate-ammonium |
| (I-24) | iodosulfuron |
| (I-24) | ioxynil |
| (I-24) | isoproturon |
| (I-24) | isoxachlortole |
| (I-24) | isoxaflutole |
| (I-24) | lactofen |
| (I-24) | linuron |
| (I-24) | mefenacet |
| (I-24) | mesosulfuron |
| (I-24) | metamitron |
| (I-24) | methabenzthiazuron |
| (I-24) | metribuzin |
| (I-24) | neburon |
| (I-24) | oxadiargyl |
| (I-24) | oxadiazon |
| (I-24) | oxaziclomefone |
| (I-24) | phenmedipham |
| (I-24) | propanil |
| (I-24) | propoxycarbazone-sodium |
| (I-24) | pyraclonil |
| (I-24) | pyraflufen-ethyl |
| (I-24) | sulcotrione |
| (I-25) | aclonifen |
| (I-25) | amicarbazone |
| (I-25) | amidosulfuron |
| (I-25) | amitrole |
| (I-25) | anilofos |
| (I-25) | asulam |
| (I-25) | benazolin-ethyl |
| (I-25) | benfuresate |
| (I-25) | bifenox |
| (I-25) | bispyribac-sodium |
| (I-25) | bromoxynil |
| (I-25) | desmedipham |
| (I-25) | diclofop-methyl |
| (I-25) | diflufenican |
| (I-25) | ethofumesate |
| (I-25) | ethoxysulfuron |
| (I-25) | fenoxaprop-ethyl |
| (I-25) | fenoxaprop-P-ethyl |
| (I-25) | fentrazamide |
| (I-25) | fluazifop-P-butyl |
| (I-25) | fenoxaprop-P-ethyl + mefenpyr-diethyl |
| (I-25) | fenoxaprop-P-ethyl + isoxadifen-ethyl |
| (I-25) | fluazolate |
| (I-25) | flucarbazone-sodium |
| (I-25) | flufenacet |
| (I-25) | flurtamone |
| (I-25) | foramsulfuron |
| (I-25) | glufosinate |
| (I-25) | glufosinate-ammonium |
| (I-25) | iodosulfuron |
| (I-25) | ioxynil |
| (I-25) | isoproturon |
| (I-25) | isoxachlortole |
| (I-25) | isoxaflutole |
| (I-25) | lactofen |
| (I-25) | linuron |
| (I-25) | mefenacet |
| (I-25) | mesosulfuron |
| (I-25) | metamitron |
| (I-25) | methabenzthiazuron |
| (I-25) | metribuzin |
| (I-25) | neburon |
| (I-25) | oxadiargyl |
| (I-25) | oxadiazon |
| (I-25) | oxaziclomefone |
| (I-25) | phenmedipham |
| (I-25) | propanil |
| (I-25) | propoxycarbazone-sodium |
| (I-25) | pyraclonil |
| (I-25) | pyraflufen-ethyl |
| (I-25) | sulcotrione |
| (I-26) | aclonifen |
| (I-26) | amicarbazone |
| (I-26) | amidosulfuron |
| (I-26) | amitrole |
| (I-26) | anilofos |
| (I-26) | asulam |
| (I-26) | benazolin-ethyl |
| (I-26) | benfuresate |
| (I-26) | bifenox |
| (I-26) | bispyribac-sodium |
| (I-26) | bromoxynil |
| (I-26) | desmedipham |
| (I-26) | diclofop-methyl |
| (I-26) | diflufenican |
| (I-26) | ethofumesate |
| (I-26) | ethoxysulfuron |
| (I-26) | fenoxaprop-ethyl |
| (I-26) | fenoxaprop-P-ethyl |
| (I-26) | fentrazamide |
| (I-26) | fluazifop-P-butyl |
| (I-26) | fenoxaprop-P-ethyl + mefenpyr-diethyl |
| (I-26) | fenoxaprop-P-ethyl + isoxadifen-ethyl |
| (I-26) | fluazolate |
| (I-26) | flucarbazone-sodium |
| (I-26) | flufenacet |
| (I-26) | flurtamone |
| (I-26) | foramsulfuron |
| (I-26) | glufosinate |
| (I-26) | glufosinate-ammonium |
| (I-26) | iodosulfuron |
| (I-26) | ioxynil |
| (I-26) | isoproturon |
| (I-26) | isoxachlortole |
| (I-26) | isoxaflutole |
| (I-26) | lactofen |
| (I-26) | linuron |
| (I-26) | mefenacet |
| (I-26) | mesosulfuron |
| (I-26) | metamitron |
| (I-26) | methabenzthiazuron |
| (I-26) | metribuzin |
| (I-26) | neburon |
| (I-26) | oxadiargyl |
| (I-26) | oxadiazon |
| (I-26) | oxaziclomefone |
| (I-26) | phenmedipham |
| (I-26) | propanil |
| (I-26) | propoxycarbazone-sodium |
| (I-26) | pyraclonil |
| (I-26) | pyraflufen-ethyl |
| (I-26) | sulcotrione |
| (I-27) | aclonifen |
| (I-27) | amicarbazone |
| (I-27) | amidosulfuron |
| (I-27) | amitrole |
| (I-27) | anilofos |
| (I-27) | asulam |
| (I-27) | benazolin-ethyl |
| (I-27) | benfuresate |
| (I-27) | bifenox |
| (I-27) | bispyribac-sodium |
| (I-27) | bromoxynil |
| (I-27) | desmedipham |
| (I-27) | diclofop-methyl |
| (I-27) | diflufenican |
| (I-27) | ethofumesate |
| (I-27) | ethoxysulfuron |
| (I-27) | fenoxaprop-ethyl |
| (I-27) | fenoxaprop-P-ethyl |
| (I-27) | fentrazamide |
| (I-27) | fluazifop-P-butyl |
| (I-27) | fenoxaprop-P-ethyl + mefenpyr-diethyl |
| (I-27) | fenoxaprop-P-ethyl + isoxadifen-ethyl |
| (I-27) | fluazolate |
| (I-27) | flucarbazone-sodium |
| (I-27) | flufenacet |
| (I-27) | flurtamone |
| (I-27) | foramsulfuron |
| (I-27) | glufosinate |
| (I-27) | glufosinate-ammonium |
| (I-27) | iodosulfuron |
| (I-27) | ioxynil |
| (I-27) | isoproturon |
| (I-27) | isoxachlortole |
| (I-27) | isoxaflutole |
| (I-27) | lactofen |
| (I-27) | linuron |
| (I-27) | mefenacet |
| (I-27) | mesosulfuron |
| (I-27) | metamitron |
| (I-27) | methabenzthiazuron |
| (I-27) | metribuzin |
| (I-27) | neburon |
| (I-27) | oxadiargyl |
| (I-27) | oxadiazon |
| (I-27) | oxaziclomefone |
| (I-27) | phenmedipham |
| (I-27) | propanil |
| (I-27) | propoxycarbazone-sodium |
| (I-27) | pyraclonil |
| (I-27) | pyraflufen-ethyl |
| (I-27) | sulcotrione |
| (I-28) | aclonifen |
| (I-28) | amicarbazone |
| (I-28) | amidosulfuron |
| (I-28) | amitrole |
| (I-28) | anilofos |
| (I-28) | asulam |
| (I-28) | benazolin-ethyl |
| (I-28) | benfuresate |
| (I-28) | bifenox |
| (I-28) | bispyribac-sodium |
| (I-28) | bromoxynil |
| (I-28) | desmedipham |
| (I-28) | diclofop-methyl |
| (I-28) | diflufenican |
| (I-28) | ethofumesate |
| (I-28) | ethoxysulfuron |
| (I-28) | fenoxaprop-ethyl |
| (I-28) | fenoxaprop-P-ethyl |
| (I-28) | fentrazamide |
| (I-28) | fluazifop-P-butyl |
| (I-28) | fenoxaprop-P-ethyl + mefenpyr-diethyl |
| (I-28) | fenoxaprop-P-ethyl + isoxadifen-ethyl |
| (I-28) | fluazolate |
| (I-28) | flucarbazone-sodium |
| (I-28) | flufenacet |
| (I-28) | flurtamone |
| (I-28) | foramsulfuron |
| (I-28) | glufosinate |
| (I-28) | glufosinate-ammonium |
| (I-28) | iodosulfuron |
| (I-28) | ioxynil |
| (I-28) | isoproturon |
| (I-28) | isoxachlortole |
| (I-28) | isoxaflutole |
| (I-28) | lactofen |
| (I-28) | linuron |
| (I-28) | mefenacet |
| (I-28) | mesosulfuron |
| (I-28) | metamitron |
| (I-28) | methabenzthiazuron |
| (I-28) | metribuzin |
| (I-28) | neburon |
| (I-28) | oxadiargyl |
| (I-28) | oxadiazon |
| (I-28) | oxaziclomefone |
| (I-28) | phenmedipham |
| (I-28) | propanil |
| (I-28) | propoxycarbazone-sodium |
| (I-28) | pyraclonil |
| (I-28) | pyraflufen-ethyl |
| (I-28) | sulcotrione |
| (I-29) | aclonifen |
| (I-29) | amicarbazone |
| (I-29) | amidosulfuron |
| (I-29) | amitrole |
| (I-29) | anilofos |
| (I-29) | asulam |
| (I-29) | benazolin-ethyl |
| (I-29) | benfuresate |
| (I-29) | bifenox |
| (I-29) | bispyribac-sodium |
| (I-29) | bromoxynil |
| (I-29) | desmedipham |
| (I-29) | diclofop-methyl |
| (I-29) | diflufenican |
| (I-29) | ethofumesate |
| (I-29) | ethoxysulfuron |
| (I-29) | fenoxaprop-ethyl |
| (I-29) | fenoxaprop-P-ethyl |
| (I-29) | fentrazamide |
| (I-29) | fluazifop-P-butyl |
| (I-29) | fenoxaprop-P-ethyl + mefenpyr-diethyl |
| (I-29) | fenoxaprop-P-ethyl + isoxadifen-ethyl |
| (I-29) | fluazolate |
| (I-29) | flucarbazone-sodium |
| (I-29) | flufenacet |
| (I-29) | flurtamone |
| (I-29) | foramsulfuron |
| (I-29) | glufosinate |
| (I-29) | glufosinate-ammonium |
| (I-29) | iodosulfuron |
| (I-29) | ioxynil |
| (I-29) | isoproturon |
| (I-29) | isoxachlortole |
| (I-29) | isoxaflutole |
| (I-29) | lactofen |
| (I-29) | linuron |
| (I-29) | mefenacet |
| (I-29) | mesosulfuron |
| (I-29) | metamitron |
| (I-29) | methabenzthiazuron |
| (I-29) | metribuzin |
| (I-29) | neburon |
| (I-29) | oxadiargyl |
| (I-29) | oxadiazon |
| (I-29) | oxaziclomefone |
| (I-29) | phenmedipham |
| (I-29) | propanil |
| (I-29) | propoxycarbazone-sodium |
| (I-29) | pyraclonil |
| (I-29) | pyraflufen-ethyl |
| (I-29) | sulcotrione |
| (I-30) | aclonifen |
| (I-30) | amicarbazone |
| (I-30) | amidosulfuron |
| (I-30) | amitrole |
| (I-30) | anilofos |
| (I-30) | asulam |
| (I-30) | benazolin-ethyl |
| (I-30) | benfuresate |
| (I-30) | bifenox |
| (I-30) | bispyribac-sodium |
| (I-30) | bromoxynil |
| (I-30) | desmedipham |
| (I-30) | diclofop-methyl |
| (I-30) | diflufenican |
| (I-30) | ethofumesate |
| (I-30) | ethoxysulfuron |
| (I-30) | fenoxaprop-ethyl |
| (I-30) | fenoxaprop-P-ethyl |
| (I-30) | fentrazamide |
| (I-30) | fluazifop-P-butyl |
| (I-30) | fenoxaprop-P-ethyl + mefenpyr-diethyl |
| (I-30) | fenoxaprop-P-ethyl + isoxadifen-ethyl |
| (I-30) | fluazolate |
| (I-30) | flucarbazone-sodium |
| (I-30) | flufenacet |
| (I-30) | flurtamone |
| (I-30) | foramsulfuron |
| (I-30) | glufosinate |
| (I-30) | glufosinate-ammonium |
| (I-30) | iodosulfuron |
| (I-30) | ioxynil |
| (I-30) | isoproturon |
| (I-30) | isoxachlortole |
| (I-30) | isoxaflutole |
| (I-30) | lactofen |
| (I-30) | linuron |
| (I-30) | mefenacet |
| (I-30) | mesosulfuron |
| (I-30) | metamitron |
| (I-30) | methabenzthiazuron |
| (I-30) | metribuzin |
| (I-30) | neburon |
| (I-30) | oxadiargyl |
| (I-30) | oxadiazon |
| (I-30) | oxaziclomefone |
| (I-30) | phenmedipham |
| (I-30) | propanil |
| (I-30) | propoxycarbazone-sodium |
| (I-30) | pyraclonil |
| (I-30) | pyraflufen-ethyl |
| (I-30) | sulcotrione |
| (I-31) | aclonifen |
| (I-31) | amicarbazone |
| (I-31) | amidosulfuron |
| (I-31) | amitrole |
| (I-31) | anilofos |
| (I-31) | asulam |
| (I-31) | benazolin-ethyl |
| (I-31) | benfuresate |
| (I-31) | bifenox |
| (I-31) | bispyribac-sodium |
| (I-31) | bromoxynil |
| (I-31) | desmedipham |
| (I-31) | diclofop-methyl |
| (I-31) | diflufenican |
| (I-31) | ethofumesate |
| (I-31) | ethoxysulfuron |
| (I-31) | fenoxaprop-ethyl |
| (I-31) | fenoxaprop-P-ethyl |
| (I-31) | fentrazamide |
| (I-31) | fluazifop-P-butyl |
| (I-31) | fenoxaprop-P-ethyl + mefenpyr-diethyl |
| (I-31) | fenoxaprop-P-ethyl + isoxadifen-ethyl |
| (I-31) | fluazolate |
| (I-31) | flucarbazone-sodium |
| (I-31) | flufenacet |
| (I-31) | flurtamone |
| (I-31) | foramsulfuron |
| (I-31) | glufosinate |
| (I-31) | glufosinate-ammonium |
| (I-31) | iodosulfuron |
| (I-31) | ioxynil |
| (I-31) | isoproturon |
| (I-31) | isoxachlortole |
| (I-31) | isoxaflutole |
| (I-31) | lactofen |
| (I-31) | linuron |
| (I-31) | mefenacet |
| (I-31) | mesosulfuron |
| (I-31) | metamitron |
| (I-31) | methabenzthiazuron |
| (I-31) | metribuzin |
| (I-31) | neburon |
| (I-31) | oxadiargyl |
| (I-31) | oxadiazon |
| (I-31) | oxaziclomefone |
| (I-31) | phenmedipham |
| (I-31) | propanil |
| (I-31) | propoxycarbazone-sodium |
| (I-31) | pyraclonil |
| (I-31) | pyraflufen-ethyl |
| (I-31) | sulcotrione |
| (I-32) | aclonifen |
| (I-32) | amicarbazone |
| (I-32) | amidosulfuron |
| (I-32) | amitrole |
| (I-32) | anilofos |
| (I-32) | asulam |
| (I-32) | benazolin-ethyl |
| (I-32) | benfuresate |
| (I-32) | bifenox |
| (I-32) | bispyribac-sodium |
| (I-32) | bromoxynil |
| (I-32) | desmedipham |
| (I-32) | diclofop-methyl |
| (I-32) | diflufenican |
| (I-32) | ethofumesate |
| (I-32) | ethoxysulfuron |
| (I-32) | fenoxaprop-ethyl |
| (I-32) | fenoxaprop-P-ethyl |
| (I-32) | fentrazamide |
| (I-32) | fluazifop-P-butyl |
| (I-32) | fenoxaprop-P-ethyl + mefenpyr-diethyl |
| (I-32) | fenoxaprop-P-ethyl + isoxadifen-ethyl |
| (I-32) | fluazolate |
| (I-32) | flucarbazone-sodium |
| (I-32) | flufenacet |
| (I-32) | flurtamone |
| (I-32) | foramsulfuron |
| (I-32) | glufosinate |
| (I-32) | glufosinate-ammonium |
| (I-32) | iodosulfuron |
| (I-32) | ioxynil |
| (I-32) | isoproturon |
| (I-32) | isoxachlortole |
| (I-32) | isoxaflutole |
| (I-32) | lactofen |
| (I-32) | linuron |
| (I-32) | mefenacet |
| (I-32) | mesosulfuron |
| (I-32) | metamitron |
| (I-32) | methabenzthiazuron |
| (I-32) | metribuzin |
| (I-32) | neburon |
| (I-32) | oxadiargyl |
| (I-32) | oxadiazon |
| (I-32) | oxaziclomefone |
| (I-32) | phenmedipham |
| (I-32) | propanil |
| (I-32) | propoxycarbazone-sodium |
| (I-32) | pyraclonil |
| (I-32) | pyraflufen-ethyl |
| (I-32) | sulcotrione |
| (I-33) | aclonifen |
| (I-33) | amicarbazone |
| (I-33) | amidosulfuron |
| (I-33) | amitrole |
| (I-33) | anilofos |
| (I-33) | asulam |
| (I-33) | benazolin-ethyl |
| (I-33) | benfuresate |
| (I-33) | bifenox |
| (I-33) | bispyribac-sodium |
| (I-33) | bromoxynil |
| (I-33) | desmedipham |
| (I-33) | diclofop-methyl |
| (I-33) | diflufenican |
| (I-33) | ethofumesate |
| (I-33) | ethoxysulfuron |
| (I-33) | fenoxaprop-ethyl |
| (I-33) | fenoxaprop-P-ethyl |
| (I-33) | fentrazamide |
| (I-33) | fluazifop-P-butyl |
| (I-33) | fenoxaprop-P-ethyl + mefenpyr-diethyl |
| (I-33) | fenoxaprop-P-ethyl + isoxadifen-ethyl |
| (I-33) | fluazolate |
| (I-33) | flucarbazone-sodium |
| (I-33) | flufenacet |
| (I-33) | flurtamone |
| (I-33) | foramsulfuron |
| (I-33) | glufosinate |
| (I-33) | glufosinate-ammonium |
| (I-33) | iodosulfuron |
| (I-33) | ioxynil |
| (I-33) | isoproturon |
| (I-33) | isoxachlortole |
| (I-33) | isoxaflutole |
| (I-33) | lactofen |
| (I-33) | linuron |
| (I-33) | mefenacet |
| (I-33) | mesosulfuron |
| (I-33) | metamitron |
| (I-33) | methabenzthiazuron |
| (I-33) | metribuzin |
| (I-33) | neburon |
| (I-33) | oxadiargyl |
| (I-33) | oxadiazon |
| (I-33) | oxaziclomefone |
| (I-33) | phenmedipham |
| (I-33) | propanil |
| (I-33) | propoxycarbazone-sodium |
| (I-33) | pyraclonil |
| (I-33) | pyraflufen-ethyl |
| (I-33) | sulcotrione |
| (I-34) | aclonifen |
| (I-34) | amicarbazone |
| (I-34) | amidosulfuron |
| (I-34) | amitrole |
| (I-34) | anilofos |
| (I-34) | asulam |
| (I-34) | benazolin-ethyl |
| (I-34) | benfuresate |
| (I-34) | bifenox |
| (I-34) | bispyribac-sodium |
| (I-34) | bromoxynil |
| (I-34) | desmedipham |
| (I-34) | diclofop-methyl |
| (I-34) | diflufenican |
| (I-34) | ethofumesate |
| (I-34) | ethoxysulfuron |
| (I-34) | fenoxaprop-ethyl |
| (I-34) | fenoxaprop-P-ethyl |
| (I-34) | fentrazamide |
| (I-34) | fluazifop-P-butyl |
| (I-34) | fenoxaprop-P-ethyl + mefenpyr-diethyl |
| (I-34) | fenoxaprop-P-ethyl + isoxadifen-ethyl |
| (I-34) | fluazolate |
| (I-34) | flucarbazone-sodium |
| (I-34) | flufenacet |
| (I-34) | flurtamone |
| (I-34) | foramsulfuron |
| (I-34) | glufosinate |
| (I-34) | glufosinate-ammonium |
| (I-34) | iodosulfuron |
| (I-34) | ioxynil |
| (I-34) | isoproturon |
| (I-34) | isoxachlortole |
| (I-34) | isoxaflutole |
| (I-34) | lactofen |
| (I-34) | linuron |
| (I-34) | mefenacet |
| (I-34) | mesosulfuron |
| (I-34) | metamitron |
| (I-34) | methabenzthiazuron |
| (I-34) | metribuzin |
| (I-34) | neburon |
| (I-34) | oxadiargyl |
| (I-34) | oxadiazon |
| (I-34) | oxaziclomefone |
| (I-34) | phenmedipham |
| (I-34) | propanil |
| (I-34) | propoxycarbazone-sodium |
| (I-34) | pyraclonil |
| (I-34) | pyraflufen-ethyl |
| (I-34) | sulcotrione |
| (I-35) | aclonifen |
| (I-35) | amicarbazone |
| (I-35) | amidosulfuron |
| (I-35) | amitrole |
| (I-35) | anilofos |
| (I-35) | asulam |
| (I-35) | benazolin-ethyl |
| (I-35) | benfuresate |
| (I-35) | bifenox |
| (I-35) | bispyribac-sodium |
| (I-35) | bromoxynil |
| (I-35) | desmedipham |
| (I-35) | diclofop-methyl |
| (I-35) | diflufenican |
| (I-35) | ethofumesate |
| (I-35) | ethoxysulfuron |
| (I-35) | fenoxaprop-ethyl |
| (I-35) | fenoxaprop-P-ethyl |
| (I-35) | fentrazamide |
| (I-35) | fluazifop-P-butyl |
| (I-35) | fenoxaprop-P-ethyl + mefenpyr-diethyl |
| (I-35) | fenoxaprop-P-ethyl + isoxadifen-ethyl |
| (I-35) | fluazolate |
| (I-35) | flucarbazone-sodium |
| (I-35) | flufenacet |
| (I-35) | flurtamone |
| (I-35) | foramsulfuron |
| (I-35) | glufosinate |
| (I-35) | glufosinate-ammonium |
| (I-35) | iodosulfuron |
| (I-35) | ioxynil |
| (I-35) | isoproturon |
| (I-35) | isoxachlortole |
| (I-35) | isoxaflutole |
| (I-35) | lactofen |
| (I-35) | linuron |
| (I-35) | mefenacet |
| (I-35) | mesosulfuron |
| (I-35) | metamitron |
| (I-35) | methabenzthiazuron |
| (I-35) | metribuzin |
| (I-35) | neburon |
| (I-35) | oxadiargyl |
| (I-35) | oxadiazon |
| (I-35) | oxaziclomefone |
| (I-35) | phenmedipham |
| (I-35) | propanil |
| (I-35) | propoxycarbazone-sodium |
| (I-35) | pyraclonil |
| (I-35) | pyraflufen-ethyl |
| (I-35) | sulcotrione |
| (I-36) | aclonifen |
| (I-36) | amicarbazone |
| (I-36) | amidosulfuron |
| (I-36) | amitrole |
| (I-36) | anilofos |
| (I-36) | asulam |
| (I-36) | benazolin-ethyl |
| (I-36) | benfuresate |
| (I-36) | bifenox |
| (I-36) | bispyribac-sodium |
| (I-36) | bromoxynil |
| (I-36) | desmedipham |
| (I-36) | diclofop-methyl |
| (I-36) | diflufenican |
| (I-36) | ethofumesate |
| (I-36) | ethoxysulfuron |
| (I-36) | fenoxaprop-ethyl |
| (I-36) | fenoxaprop-P-ethyl |
| (I-36) | fentrazamide |
| (I-36) | fluazifop-P-butyl |
| (I-36) | fenoxaprop-P-ethyl + mefenpyr-diethyl |
| (I-36) | fenoxaprop-P-ethyl + isoxadifen-ethyl |
| (I-36) | fluazolate |
| (I-36) | flucarbazone-sodium |
| (I-36) | flufenacet |
| (I-36) | flurtamone |
| (I-36) | foramsulfuron |
| (I-36) | glufosinate |
| (I-36) | glufosinate-ammonium |
| (I-36) | iodosulfuron |
| (I-36) | ioxynil |
| (I-36) | isoproturon |
| (I-36) | isoxachlortole |
| (I-36) | isoxaflutole |
| (I-36) | lactofen |
| (I-36) | linuron |
| (I-36) | mefenacet |
| (I-36) | mesosulfuron |
| (I-36) | metamitron |
| (I-36) | methabenzthiazuron |
| (I-36) | metribuzin |
| (I-36) | neburon |
| (I-36) | oxadiargyl |
| (I-36) | oxadiazon |
| (I-36) | oxaziclomefone |
| (I-36) | phenmedipham |
| (I-36) | propanil |
| (I-36) | propoxycarbazone-sodium |
| (I-36) | pyraclonil |
| (I-36) | pyraflufen-ethyl |
| (I-36) | sulcotrione |
| (I-37) | aclonifen |
| (I-37) | amicarbazone |
| (I-37) | amidosulfuron |
| (I-37) | amitrole |
| (I-37) | anilofos |
| (I-37) | asulam |
| (I-37) | benazolin-ethyl |
| (I-37) | benfuresate |
| (I-37) | bifenox |
| (I-37) | bispyribac-sodium |
| (I-37) | bromoxynil |
| (I-37) | desmedipham |
| (I-37) | diclofop-methyl |
| (I-37) | diflufenican |
| (I-37) | ethofumesate |
| (I-37) | ethoxysulfuron |
| (I-37) | fenoxaprop-ethyl |
| (I-37) | fenoxaprop-P-ethyl |
| (I-37) | fentrazamide |
| (I-37) | fluazifop-P-butyl |
| (I-37) | fenoxaprop-P-ethyl + mefenpyr-diethyl |
| (I-37) | fenoxaprop-P-ethyl + isoxadifen-ethyl |
| (I-37) | fluazolate |
| (I-37) | flucarbazone-sodium |
| (I-37) | flufenacet |
| (I-37) | flurtamone |
| (I-37) | foramsulfuron |
| (I-37) | glufosinate |
| (I-37) | glufosinate-ammonium |
| (I-37) | iodosulfuron |
| (I-37) | ioxynil |
| (I-37) | isoproturon |
| (I-37) | isoxachlortole |
| (I-37) | isoxaflutole |
| (I-37) | lactofen |
| (I-37) | linuron |
| (I-37) | mefenacet |
| (I-37) | mesosulfuron |
| (I-37) | metamitron |
| (I-37) | methabenzthiazuron |
| (I-37) | metribuzin |
| (I-37) | neburon |
| (I-37) | oxadiargyl |
| (I-37) | oxadiazon |
| (I-37) | oxaziclomefone |
| (I-37) | phenmedipham |
| (I-37) | propanil |
| (I-37) | propoxycarbazone-sodium |
| (I-37) | pyraclonil |
| (I-37) | pyraflufen-ethyl |
| (I-37) | sulcotrione |
| (I-38) | aclonifen |
| (I-38) | amicarbazone |
| (I-38) | amidosulfuron |
| (I-38) | amitrole |
| (I-38) | anilofos |
| (I-38) | asulam |
| (I-38) | benazolin-ethyl |
| (I-38) | benfuresate |
| (I-38) | bifenox |
| (I-38) | bispyribac-sodium |
| (I-38) | bromoxynil |
| (I-38) | desmedipham |
| (I-38) | diclofop-methyl |
| (I-38) | diflufenican |
| (I-38) | ethofumesate |
| (I-38) | ethoxysulfuron |
| (I-38) | fenoxaprop-ethyl |
| (I-38) | fenoxaprop-P-ethyl |
| (I-38) | fentrazamide |
| (I-38) | fluazifop-P-butyl |
| (I-38) | fenoxaprop-P-ethyl + mefenpyr-diethyl |
| (I-38) | fenoxaprop-P-ethyl + isoxadifen-ethyl |
| (I-38) | fluazolate |
| (I-38) | flucarbazone-sodium |
| (I-38) | flufenacet |
| (I-38) | flurtamone |
| (I-38) | foramsulfuron |
| (I-38) | glufosinate |
| (I-38) | glufosinate-ammonium |
| (I-38) | iodosulfuron |
| (I-38) | ioxynil |
| (I-38) | isoproturon |
| (I-38) | isoxachlortole |
| (I-38) | isoxaflutole |
| (I-38) | lactofen |
| (I-38) | linuron |
| (I-38) | mefenacet |
| (I-38) | mesosulfuron |
| (I-38) | metamitron |
| (I-38) | methabenzthiazuron |
| (I-38) | metribuzin |
| (I-38) | neburon |
| (I-38) | oxadiargyl |
| (I-38) | oxadiazon |
| (I-38) | oxaziclomefone |
| (I-38) | phenmedipham |
| (I-38) | propanil |
| (I-38) | propoxycarbazone-sodium |
| (I-38) | pyraclonil |
| (I-38) | pyraflufen-ethyl |
| (I-38) | sulcotrione |
| (I-39) | aclonifen |
| (I-39) | amicarbazone |
| (I-39) | amidosulfuron |
| (I-39) | amitrole |
| (I-39) | anilofos |
| (I-39) | asulam |
| (I-39) | benazolin-ethyl |
| (I-39) | benfuresate |
| (I-39) | bifenox |
| (I-39) | bispyribac-sodium |
| (I-39) | bromoxynil |
| (I-39) | desmedipham |
| (I-39) | diclofop-methyl |
| (I-39) | diflufenican |
| (I-39) | ethofumesate |
| (I-39) | ethoxysulfuron |
| (I-39) | fenoxaprop-ethyl |
| (I-39) | fenoxaprop-P-ethyl |
| (I-39) | fentrazamide |
| (I-39) | fluazifop-P-butyl |
| (I-39) | fenoxaprop-P-ethyl + mefenpyr-diethyl |
| (I-39) | fenoxaprop-P-ethyl + isoxadifen-ethyl |
| (I-39) | fluazolate |
| (I-39) | flucarbazone-sodium |
| (I-39) | flufenacet |
| (I-39) | flurtamone |
| (I-39) | foramsulfuron |
| (I-39) | glufosinate |
| (I-39) | glufosinate-ammonium |
| (I-39) | iodosulfuron |
| (I-39) | ioxynil |
| (I-39) | isoproturon |
| (I-39) | isoxachlortole |
| (I-39) | isoxaflutole |
| (I-39) | lactofen |
| (I-39) | linuron |
| (I-39) | mefenacet |
| (I-39) | mesosulfuron |
| (I-39) | metamitron |
| (I-39) | methabenzthiazuron |
| (I-39) | metribuzin |
| (I-39) | neburon |
| (I-39) | oxadiargyl |
| (I-39) | oxadiazon |
| (I-39) | oxaziclomefone |
| (I-39) | phenmedipham |
| (I-39) | propanil |
| (I-39) | propoxycarbazone-sodium |
| (I-39) | pyraclonil |
| (I-39) | pyraflufen-ethyl |
| (I-39) | sulcotrione |

Surprisingly, it has now been found that the above-defined active compound combinations of the substituted carboxanilides of the formula (I) and the abovementioned active compounds of Group (2) exhibit a particularly high herbicidal activity combined with very good crop plant compatibility and can be used for the selective control of monocotyledonous and dicotyledonous weeds in a variety of crops, in particular in cotton, barley, potatoes, maize, oilseed rape, rice, rye, soya beans, sunflowers, wheat, sugar cane and sugar beet, especially in barley, maize, rice and wheat, and additionally also for controlling monocotyledonous and dicotyledonous weeds in the semi- and nonselective field.

Surprisingly, the herbicidal activity of the active compound combinations according to the invention of compounds of the abovementioned Groups (1) and (2) exceeds the total of the action of the individual active compounds considerably.

Thus, not just a complementation of actions but a synergistic effect is present which could not have been predicted. The novel active compound combinations are well tolerated in a variety of crops, also effecting good control of weeds which are usually difficult to control. Thus, the novel active compound combinations are a valuable addition to the herbicides.

The synergistic effect of the active compound combinations according to the invention is particularly strongly pronounced in certain concentration ratios.

However, the weight ratios of the active compounds in the active compound combinations may be varied within relatively wide ranges. In general, from 0.001 to 1000 parts by weight, preferably from 0.002 to 500 parts by weight and particularly preferably from 0.01 to 100 parts by weight of active compound of Group (2) are used per part by weight of active compound of the formula (I).

It must also be considered as surprising that, from amongst a multitude of known safeners or antidotes capable of antagonizing the harmful effects of a herbicide on the crop plants, it is precisely the abovementioned compounds of Group (3) which are capable of almost completely compensating for the harmful effect, on the crop plants, of active compounds of the formula (1) and their salts, if appropriate also in combination with one or more of the abovementioned active compounds of Group (2), without adversely affecting the herbicidal efficacy towards the weeds.

Surprisingly, it has also been found that the herbicidally active substance 2,4-dichlorophenoxyacetic acid (2,4-D) and its derivatives, too, can play the safener role described above.

Accordingly, a preferred embodiment is also a mixture comprising a compound of the formula (1) and/or salts thereof on the one hand, and 2,4-D and/or its derivatives on the other hand, if appropriate in combination with one or more of the active compounds of Group (2) listed above. Typical derivatives of 2,4-D are, for example, its esters.

Surprisingly, it has also been found that the herbicidally active substances (4-chloro-2-methylphenoxy)acetic acid (MCPA) and (+−)-2-(4-chloro-2-methylphenoxy)propanoic acid (mecoprop) can also play a safener role in the present case. The compounds mentioned are described in the following patent applications: JP 63 072 605 and GB 00 820 180.

The compounds diethyl 1-(2,4-dichlorophenyl)-4,5-dihydro-5-methyl-1H-pyrazole-3,5-dicarboxylate (mefenpyr-diethyl), 1-methylhexyl [(5-chloro-8-quinolinyl)-oxy]acetate(cloquintocet-mexyl) and ethyl 1-(2,4-dichlorophenyl)-5-(trichloromethyl)-1H-1,2,4-triazole-3-carboxylate (fenchlorazole-ethyl) are described in the following patent applications: DE-A-39 39 503, EP-A-191 736 and DE-A-35 25 205. 2,4-D is a known herbicide.

The advantageous effect of the crop plant compatibility of the active compound combinations according to the invention is likewise particularly strongly pronounced at certain concentration ratios. However, the weight ratios of the active compounds in the active compound combinations can be varied within relatively wide ranges. In general, from 0.001 to 1000 parts by weight, preferably from 0.01 to 100 parts by weight and particularly preferably from 0.1 to 10 parts by weight of one of the crop plant compatibility-improving compounds mentioned above under (c) (antidotes/safeners) are used per part by weight of active compound of the formula (I) or its mixtures with active compounds of Group (2).

All plants and plant parts can be treated in accordance with the invention. Plants are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant varieties protectable or not protectable by plant breeders' rights. Plant parts are to be understood as meaning all aerial and subterranean plant parts and organs of the plants such as shoot, leaf, flower and root, examples which may be mentioned being leaves, needles, stalks, trunks, flowers, fruiting bodies, fruits, seeds, roots, tubers and rhizomes. The plant parts also include vegetative and generative propagation material, for example cuttings, tubers, rhizomes, seedlings and seeds.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are understood as meaning plants with novel properties (“traits”) which are grown by conventional cultivation, by mutagenesis or by recombinant DNA techniques. These may be cultivars, biotypes or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are emphasized in particular are increased defence of the plants against insects by toxins formed in the plants, in particular those formed in the plants by the genetic material from Bacillus thuringiensis (for example by the genes encoding CryIA(a), CryIA(b), CryIA(c), CryIIIA, CryIIIA, CryIIB2, Cry9c Cry2Ab, Cry3Bb and CryIF and also combinations thereof) (hereinbelow referred to as “Bt plants”). Traits which are also particularly emphasized are the increased resistance of plants to fungi, bacteria and viruses by systemic acquired resistance (SAR), systemin, phytoalexins, elicitors and resistance genes and the correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which cultivars will be developed and/or marketed in the future.

The plants listed can be treated according to the invention in a particularly advantageous manner with the compounds of the general formula (I) or the active compound mixtures according to the invention. The preferred ranges stated above for the active compounds or mixtures also apply to the treatment of these plants. Particular emphasis is given to the treatment of plants with the compounds or mixtures specifically mentioned in the present text.

The treatment according to the invention of the plants and plant parts with the active compounds is carried out directly or by allowing the compounds to act on their surroundings, environment or storage space by the customary treatment methods, for example by immersion, spraying, evaporation, fogging, scattering, painting on and, in the case of propagation material, in particular in the case of seeds, also by applying one or more coats.

Amongst the plants obtained by biotechnological and recombinant methods, or by combining these methods, plants which are emphasized are those which tolerate so-called ALS, 4-HPPD, EPSPS and/or PPO inhibitors, such as, for example, Acuron plants.

The active compounds according to the invention can be used, for example, in the following plants:

Dicotyledonous weeds of the genera: Abutilon, Amaranthus, Ambrosia, Anoda, Anthernis, Aphanes, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola, Xanthium.

Dicotyledonous crops of the genera: Arachis, Beta, Brassica, Cucumis, Cucurbita, Helianthus, Daucus, Glycine, Gossypium, Ipomoea, Lactuca, Linum, Lycopersicon, Nicotiana, Phaseolus, Pisum, Solanum, Vicia.

Monocotyledonous weeds of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, Sorghum.

Monocotyledonous crops of the genera: Allium, Ananas, Asparagus, Avena, Hordeum, Oryza, Panicum, Saccharum, Secale, Sorghum, Triticale, Triticum, Zea.

However, the use of the active compound combinations according to the invention is in no way restricted to these genera, but also extends in the same manner to other plants.

The active compound combinations to be used in accordance with the invention can be employed not only in conventional cultivation methods (suitably spaced row crops), in plantation crops (for example grapevines, fruit, citrus) and in industrial plants and railtracks, on paths and squares, but also for stubble treatment and in the minimum tillage method. They are furthermore suitable as dessicants (haulm killing in, for example, potatoes) or as defoliants (for example in cotton). They are furthermore suitable for use on non-crop areas. Other fields of application are nurseries, forests, grassland and the production of ornamentals.

The active compound combinations can be converted into the customary formulations such as solutions, emulsions, wettable powders, suspensions, powders, dusts, pastes, soluble powders, granules, suspo-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants and/or foam formers.

If the extender used is water it is also possible, for example, to use organic solvents as cosolvents. The following are essentially suitable as liquid solvents: aromatics such as xylene, toluene, or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Solid carriers which are suitable are: for example ammonium salts and ground natural minerals such as kaolins, clays, talc, chalk, quartz, attapulgite, montmorillonite or diatomaceous earth, and ground synthetic minerals such as highly-disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compounds, preferably between 0.5 and 90%.

The active compound combinations according to the invention are generally applied in the form of ready mixes. However, the active compounds contained in the active compound combinations may also be applied in the form of individual formulations which are mixed upon use, that is, in the form of tank mixes.

The new active compound combinations, as such or in their formulations, may furthermore also be used as a mixture with other known herbicides, again with ready mixes or tank mixes being possible. A mixture with other known active compounds such as fungicides, insecticides, acaricides, nematicides, bird repellants, growth substances, plant nutrients and soil conditioners is also possible. It may furthermore be advantageous for specific applications, in particular for the post-emergence method, to incorporate into the formulations plant-tolerated mineral or vegetable oils (for example the commercial product “Rako Binol”) or ammonium salts such as, for example, ammonium sulphate or ammonium thiocyanate, as further additives.

The new active compound combinations can be used as such, in the form of their formulations or the use forms which can be prepared from these formulations by further dilution, such as ready-to-use solutions, suspensions, emulsions, powders, pastes and granules. Application is effected in the customary manner, for example by pouring, spraying, atomizing, dusting or broadcasting.

The active compound combinations according to the invention can be applied before and after emergence of the plants, that is to say by the pre- and post-emergence method. They may also be incorporated into the soil prior to sowing.

The good herbicidal action of the new active compound combinations can be seen from the examples which follow. While the individual active compounds show weaknesses with regard to their herbicidal action, the combinations all show a very good herbicidal action which exceeds a simple sum of actions.

A synergistic effect in herbicides is always present when the herbicidal action of the active compound combination exceeds the action of the active compounds when applied individually.

The expected action for a given combination of two herbicides can be calculated as follows (cf. COLBY, S. R.: “Calculating synergistic and antagonistic responses of herbicide combinations”, Weeds 15, pages 20-22, 1967):

If
X=% damage by herbicide A (active compound of the formula I) at an application rate of p kg/ha and
Y=% damage by herbicide B (active compound of the formula II) at an application rate of q kg/ha and
E=the expected damage of herbicides A+B at an application rate of p+q kg/ha, then
   E=X+Y−(X*Y/100).

If the actual damage exceeds the calculated value, the combination has a superadditive effect, that is to say a synergistic effect.

The expected activity for a given combination of three herbicides can likewise be found in the literature mentioned above.

### USE EXAMPLES

### Example A

Post-Emergence Test/Greenhouse

Test plants are grown under controlled conditions (temperature and light). Once the plants have reached a height of 5 to 15 cm, the test compound or the combination of test compounds is applied by spraying such that the particular amounts of active compound desired are applied per unit area. The concentration of the spray liquor is chosen so that the particular amounts of active compound desired are applied in 500 litres of water/ha.

Following the spray application, the plant containers are kept in the greenhouse under constant light and temperature conditions.

After five days (5d) and/or three weeks (21d), the degree of damage to the plants is rated in % damage in comparison to the development of the untreated control.

The figures denote:

0%=no effect (like untreated control)
100%=total destruction.

Active compounds, application rates, test plants and results are shown in the tables below. Unless indicated otherwise, the tests were carried out in the presence of 0.5% Renex 36.
a.i. denotes “active ingredient” (active compound).
HORVW denotes Hordeum vulgare (winter barley).

TRZAW denotes Triticum aestivum (winter wheat).

TABLE 3

| | Application | | | | |
|---|---|---|---|---|---|
| Active | rate | HORVW | HORVW | TRZAW | TRZAW |
| compound | [g of ai/ha] | 5d | 21d | 5d | 21d |
| mefenpyr- | 50 | 0 | 0 | 0 | 0 |
| diethyl | | | | | |
| cloquinto- | 50 | 0 | 0 | 0 | 0 |
| cet-mexyl | | | | | |
| isoxadifen | 50 | 0 | 0 | 0 | 0 |

TABLE 4

| | Application | | | |
|---|---|---|---|---|
| Active | rate | HORVW | HORVW | TRZAW |
| compound*) | [g of ai/ha] | 5d | 21d | 5d |
| cloquintocet-mexyl | 50 | 0 | 0 | 0 |
| isoxadifen | 50 | 0 | 0 | 0 |

*)without addition of Renex 36

TABLE 5

| | Application rate | HORVW |
|---|---|---|
| Active compound | [g of ai/ha] | 21d |
| Ex. I-26 | 60 | 40 |
| | 30 | 20 |
| | 15 | 10 |
| Ex. I-26 + mefenpyr-diethyl | 60 + 50 | 5 |
| | 30 + 50 | 5 |
| | 15 + 50 | 0 |

TABLE 6

| | Application rate | HORVW |
|---|---|---|
| Active compound | [g of ai/ha] | 21d |
| Ex. I-26 | 60 | 40 |
| Ex. I-26 + cloquintocet-mexyl | 60 + 50 | 20 |

TABLE 7

| | Application rate | TRZAW |
|---|---|---|
| Active compound | [g of ai/ha] | 21d |
| Ex. I-26 | 60 | 30 |
| | 30 | 20 |
| Ex. I-26 + mefenpyr-diethyl | 60 + 50 | 10 |
| | 30 + 50 | 5 |
| Ex. I-26 + cloquintocet-mexyl | 60 + 50 | 10 |
| | 30 + 50 | 5 |

TABLE 8

| | Application rate | TRZAW |
|---|---|---|
| Active compound | [g of ai/ha] | 21d |
| Ex. I-26 | 60 | 30 |
| Ex. I-26 + isoxadifen | 60 + 50 | 20 |

TABLE 9

| | Application rate | HORVW |
|---|---|---|
| Active compound | [g of ai/ha] | 5d |
| Ex. I-31 | 60 | 50 |
| | 30 | 40 |
| | 15 | 30 |
| Ex. I-31 + mefenpyr-diethyl | 60 + 50 | 30 |
| | 30 + 50 | 25 |
| | 15 + 50 | 20 |
| Ex. I-31 + cloquintocet-mexyl | 60 + 50 | 25 |
| | 30 + 50 | 20 |
| | 15 + 50 | 20 |
| Ex. I-31 + isoxadifen | 60 + 50 | 20 |
| | 30 + 50 | 20 |
| | 15 + 50 | 15 |

TABLE 10

| | Application rate | TRZAW |
|---|---|---|
| Active compound | [g of ai/ha] | 5d |
| Ex. I-31 | 60 | 20 |
| | 30 | 20 |
| Ex. I-31 + mefenpyr-diethyl | 60 + 50 | 10 |
| | 30 + 50 | 10 |

TABLE 11

| | Application rate | HORVW |
|---|---|---|
| Active compound | [g of ai/ha] | 5d |
| Ex. I-32 | 60 | 40 |
| | 30 | 25 |
| Ex. I-32 + mefenpyr-diethyl | 60 + 50 | 20 |
| | 30 + 50 | 15 |
| Ex. I-32 + cloquintocet-mexyl | 60 + 50 | 20 |
| | 30 + 50 | 15 |
| Ex. I-32 + isoxadifen | 60 + 50 | 25 |

TABLE 12

| | Application rate | HORVW |
|---|---|---|
| Active compound | [g of ai/ha] | 5d |
| Ex. I-33 | 60 | 40 |
| Ex. I-33 + mefenpyr-diethyl | 60 + 50 | 20 |
| Ex. I-33 + cloquintocet-mexyl | 60 + 50 | 30 |
| Ex. I-33 + isoxadifen | 60 + 50 | 10 |

TABLE 13

| | Application rate | HORVW |
|---|---|---|
| Active compound | [g of ai/ha] | 21d |
| Ex. I-33 | 60 | 20 |
| | 30 | 15 |
| Ex. I-33 + isoxadifen | 60 + 50 | 10 |
| | 30 + 50 | 5 |

TABLE 14

| | Application rate | TRZAW |
|---|---|---|
| Active Compound | [g of ai/ha] | 5d |
| Ex. I-33 | 60 | 25 |
| Ex. I-33 + mefenpyr-diethyl | 60 + 50 | 15 |
| Ex. I-33 + cloquintocet-mexyl | 60 + 50 | 10 |
| Ex. I-33 + isoxadifen | 60 + 50 | 5 |

TABLE 15

| | Application rate | TRZAW |
|---|---|---|
| Active Compound | [g of ai/ha] | 21d |
| Ex. I-33 | 60 | 15 |
| | 30 | 10 |
| Ex. I-33 + isoxadifen | 60 + 50 | 5 |
| | 30 + 50 | 0 |

TABLE 15

| | Application rate | HORVW |
|---|---|---|
| Active Compound | [g of ai/ha] | 5d |
| Ex. I-29 | 15 | 10 |
| Ex. I-29 + cloquintocet-mexyl | 15 + 50 | 0 |

TABLE 16

| | Application rate | HORVW |
|---|---|---|
| Active Compound | [g of ai/ha] | 5d |
| Ex. I-40 | 60 | 30 |
| Ex. I-40 + mefenpyr-diethyl | 60 + 50 | 20 |
| Ex. I-40 + cloquintocet-mexyl | 60 + 50 | 20 |

TABLE 17

| | Application rate | HORVW |
|---|---|---|
| Active Compound | [g of ai/ha] | 21d |
| Ex. I-40 | 60 | 20 |
| Ex. I-40 + mefenpyr-diethyl | 60 + 50 | 10 |
| Ex. I-40 + cloquintocet-mexyl | 60 + 50 | 10 |
| Ex. I-40 + isoxadifen | 60 + 50 | 10 |

TABLE 18

| | Application rate | TRZAW |
|---|---|---|
| Active Compound | [g of ai/ha] | 5d |
| Ex. I-40 | 60 | 20 |
| Ex. I-40 + cloquintocet-mexyl | 60 + 50 | 10 |

TABLE 19

| | Application rate | HORVW |
|---|---|---|
| Active Compound | [g of ai/ha] | 5d |
| Ex. I-41 | 30 | 25 |
| | 15 | 20 |
| Ex. I-41 + cloquintocet-mexyl | 30 + 50 | 15 |
| | 15 + 50 | 5 |

TABLE 20

| | Application rate | HORVW |
|---|---|---|
| Active Compound | [g of ai/ha] | 5d |
| Ex. I-42 | 60 | 30 |
| Ex. I-42 + mefenpyr-diethyl | 60 + 50 | 20 |
| Ex. I-42 + cloquintocet-mexyl | 60 + 50 | 20 |

TABLE 21

| | Application rate | HORVW |
|---|---|---|
| Active Compound | [g of ai/ha] | 5d |
| Ex. I-42 | 60 | 30 |
| | 30 | 20 |
| | 15 | 15 |
| Ex. I-42 + isoxadifen | 60 + 50 | 20 |
| | 30 + 50 | 10 |
| | 15 + 50 | 5 |

TABLE 22

| | Application rate | HORVW |
|---|---|---|
| Active Compound | [g of ai/ha] | 21d |
| Ex. I-42 | 60 | 20 |
| Ex. I-42 + mefenpyr-diethyl | 60 + 50 | 10 |
| Ex. I-42 + cloquintocet-mexyl | 60 + 50 | 10 |
| Ex. I-42 + isoxadifen | 60 + 50 | 10 |

TABLE 23

| | Application rate | TRZAW |
|---|---|---|
| Active compound | [g of ai/ha] | 5d |
| Ex. I-43 | 30 | 15 |
| | 15 | 15 |
| Ex. I-43 + cloquintocet-mexyl | 30 + 25 | 5 |
| | 15 + 25 | 5 |

TABLE 24

| | Application rate | HORVW |
|---|---|---|
| Active compound*) | [g of ai/ha] | 21d |
| Ex. I-43 | 15 | 10 |
| Ex. I-43 + isoxadifen | 15 + 25 | 0 |

*)without addition of Renex 36

TABLE 25

| | Application rate | HORVW |
|---|---|---|
| Active compound | [g of ai/ha] | 5d |
| Ex. I-14 | 60 | 30 |
| Ex. I-14 + mefenpyr-diethyl | 60 + 50 | 20 |

TABLE 26

| | Application rate | TRZAW |
|---|---|---|
| Active compound | [g of ai/ha] | 5d |
| Ex. I-14 | 60 | 20 |
| Ex. I-14 + mefenpyr-diethyl | 60 + 50 | 10 |

TABLE 27

| | Application rate | HORVW |
|---|---|---|
| Active compound | [g of ai/ha] | 21d |
| Ex. I-1 | 60 | 40 |
| | 30 | 20 |
| Ex. I-1 + mefenpyr-diethyl | 60 + 50 | 15 |
| | 30 + 50 | 10 |
| Ex. I-1 + cloquintocet-mexyl | 60 + 50 | 15 |
| | 30 + 50 | 10 |
| Ex. I-1 + isoxadifen | 60 + 50 | 15 |
| | 30 + 50 | 10 |

TABLE 28

| | Application rate | HORVW |
|---|---|---|
| Active compound | [g of ai/ha] | 5d |
| Ex. I-2 | 60 | 60 |
| | 30 | 40 |
| Ex. I-2 + mefenpyr-diethyl | 60 + 50 | 25 |
| | 30 + 50 | 25 |
| Ex. I-2 + cloquintocet-mexyl | 60 + 50 | 30 |
| | 30 + 50 | 25 |
| Ex. I-2 + isoxadifen | 60 + 50 | 40 |
| | 30 + 50 | 30 |

TABLE 29

| | Application rate | HORVW |
|---|---|---|
| Active compound | [g of ai/ha] | 5d |
| Ex. I-24 | 30 | 60 |
| | 15 | 40 |
| Ex. I-24 + mefenpyr-diethyl | 30 + 50 | 40 |
| | 15 + 50 | 30 |

TABLE 30

| | Application rate | HORVW |
|---|---|---|
| Active compound | [g of ai/ha] | 5d |
| Ex. I-24 | 60 | 70 |
| | 30 | 60 |
| | 15 | 40 |
| Ex. I-24 + cloquintocet-mexyl | 60 + 50 | 30 |
| | 30 + 50 | 25 |
| | 15 + 50 | 25 |
| Ex. I-24 + isoxadifen | 60 + 50 | 30 |
| | 30 + 50 | 30 |
| | 15 + 50 | 25 |

1-10. (canceled)

11. A composition comprising an effective amount of an active compound combination comprising
(a) one or more compounds of formula (I) 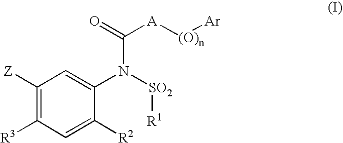
in which
n represents the number 0 or 1,
A represents alkanediyl(alkylene) or alkenediyl having in each case up to 6 carbon atoms,
Ar represents optionally substituted aryl having 6 or 10 carbon atoms or represents optionally substituted heterocyclyl having up to 9 carbon atoms and 1 to 4 nitrogen atoms and/or optionally 1 or 2 oxygen or sulphur atoms,
where the optional substituents are selected from the group consisting of nitro, cyano, carboxyl, carbamoyl, thiocarbamoyl, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulphinyl, C₁-C₄-haloalkylsulphinyl, C₁-C₄-alkylsulphonyl, C₁-C₄-haloalkylsulphonyl, C₁-C₄-alkylamino, di(C₁-C₄-alkyl)amino, C₁-C₄-alkylcarbonyl, C₁-C₄-alkoxycarbonyl, C₁-C₄-alkylaminocarbonyl, di(C₁-C₄-alkyl)-aminoarbonyl, and di(C₁-C₄-alkyl)aminosulphonyl,
R¹ represents optionally halogen-substituted alkyl having 1 to 6 carbon atoms; represents optionally halogen-substituted alkenyl having 2 to 6 carbon atoms; represents optionally halogen- or C₁-C₄-alkyl-substituted cycloalkyl having 3 to 6 carbon atoms; represents optionally nitro-, cyano-, halogen-, C₁-C₄-alkyl-, or C₁-C₄-alkoxy-substituted aryl or aryl-alkyl having in each case 6 or 10 carbon atoms in the aryl group and, if appropriate, 1 to 4 carbon atoms in the alkyl moiety; or represents optionally nitro-, cyano-, halogen-, C₁-C₄-alkyl-, or C₁-C₄-alkoxy-substituted heterocyclyl having 5 carbon atoms and 1 to 4 nitrogen atoms and/or 1 or 2 oxygen or sulphur atoms,
R² represents cyano, carbamoyl, thiocarbamoyl, or halogen; or represents optionally halogen-substituted alkyl or alkoxy having in each case 1 to 4 carbon atoms,
R³ represents hydrogen, cyano, carbamoyl, thiocarbamoyl, or halogen, and
Z represents one of the groups 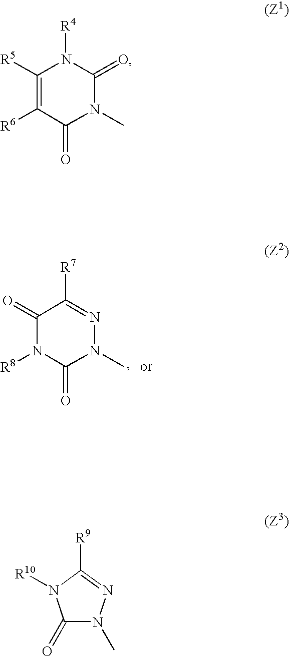
in which
R⁴ represents hydrogen, amino, or optionally halogen-substituted alkyl having 1 to 4 carbon atoms,
R⁵ represents carboxyl, cyano, carbamoyl, thiocarbamoyl, or optionally halogen-substituted alkyl or alkoxycarbonyl having in each case 1 to 4 carbon atoms in the alkyl groups,
R⁶ represents hydrogen, halogen, or optionally halogen-substituted alkyl having 1 to 4 carbon atoms,
R⁷ represents hydrogen, cyano, or halogen; or represents optionally cyano-, halogen- or C₁-C₄-alkoxy-substituted alkyl, alkoxy, alkylthio, alkylamino, or dialkylamino having in each case 1 to 4 carbon atoms in the alkyl groups,
R⁸ represents hydrogen; or represents optionally cyano-, halogen-, or C₁-C₄-alkoxy-substituted alkyl, alkoxy, alkylamino, alkylcarbonyl, or alkoxycarbonyl having in each case 1 to 4 carbon atoms in the alkyl groups,
R⁹ represents hydrogen, cyano, halogen, or one of the groups —R¹¹, —O—R¹¹, S—R¹¹, SO—R¹¹, or SO₂—R¹¹,
R¹⁰ represents hydrogen, hydroxyl, amino or one of the groupings —R¹¹ or —O—R¹¹, and
R¹¹ represents optionally cyano-, halogen-, or C₁-C₄-alkoxy-substituted alkyl having 1 to 6 carbon atoms; represents optionally halogen-substituted alkenyl or alkynyl having in each case 2 to 6 carbon atoms; represents optionally cyano-, halogen-, or C₁-C₄-alkyl-substituted cycloalkyl having 3 to 6 carbon atoms; or represents optionally nitro-, cyano-, halogen-, C₁-C₄-alkyl-, C₁-C₄-haloalkyl-, C₁-C₄-alkoxy-, or C₁-C₄-halo-alkoxy-substituted phenyl or benzyl, and
(b) one or more compounds of a second group of herbicides selected from the group consisting of the active compounds 4,5-dihydro-3-methoxy-4-methyl-5-oxo-N-[(2-trifluoromethoxyphenyl)-sulphonyl]-1-H-1,2,4-triazole-1-carboxamide sodium salt (flucarbazone-sodium), 2-chloro-N-(ethoxymethyl)-N-(2-ethyl-6-methylphenyl)acetamide(acetochlor), 5-(2-chloro-4-trifluoromethylphenoxy)-2-nitrobenzoic acid (sodium salt) (acifluorfen (-sodium)), 2-chloro-6-nitro-3-phenoxybenzeneamine(aclonifen), 2-chloro-N-(methoxymethyl)-N-(2,6-diethylphenyl)acetamide(alachlor), methyl 4-hydroxy-6,6-dimethyl-2-oxo-3-[1-[(2-propenyloxy)imino]butyl]-3-cyclohexene-1-carboxylate (sodium salt) (alloxydim (-sodium)), N-ethyl-N′-isopropyl-6-methylthio-1,3,5-triazine-2,4-diamine (ametryn), 4-amino-N-(1,1-dimethylethyl)-4,5-dihydro-3-(1-methylethyl)-5-oxo-1H-1,2,4-triazole-1-carboxamide(amicarbazone), N-(4,6-dimethoxypyrimidin-2-yl)-N′-(N-methyl-N-methylsulphonylsulphamoyl)urea (amidosulfuron), 1H-1,2,4-triazole-3-amine(amitrole), S-[2-[(4-chlorophenyl)-(1-isopropyl)amino]-2-oxoethyl]O,O-dimethyl phosphorodithioate (anilofos), O-methyl N-(4-aminophenylsulphonyl)carbamate (asulam), 6-chloro-4-ethyl-amino-2-isopropylamino-1,3,5-triazine (atrazine), 2-[2,4-dichloro-5-(2-propynyloxy)phenyl]-5,6,7,8-tetrahydro-1,2,4-triazolo-[4,3-a]-pyridin-3(2H)-one (azafenidin), N-(4,6-dimethoxypyrimidin-2-yl)-N′-[1-methyl-4-(2-methyl-2H-tetrazol-5-yl)-1H-pyrazol-5-ylsulphonyl]urea (azimsulfuron), N-benzyl-2-(4-fluoro-3-trifluoromethylphenoxy)butanamide(beflubutamid), 4-chloro-2-oxo-3(2H)-benzothiazoleacetic acid (ethyl ester) (benazolin, (-ethyl)), N-butyl-N-ethyl-2,6-dinitro-4-trifluoromethylbenzeneamine(benfluralin), 2,3-dihydro-3,3-dimethyl-5-benzofuranylethanesulphonate (benfuresate), N-(4,6-dimethoxy-pyrimidin-2-yl)-N′-(2-methoxycarbonylphenylmethylsulphonyl)urea (bensulfuron-methyl), 3-isopropyl-1H-2,1,3-benzothiadiazin-4(3H)-one 2,2-dioxide (bentazone), S-[(4-chlorophenyl)methyl]diethylthiocarbamate (benthiocarb, thiobencarb), methyl 2-[2-[4-(3,6-dihydro-3-methyl-2,6-dioxo-4-trifluoromethyl-1 (2H)-pyrimidinylphenoxymethyl]-5-ethylphenoxypropanoate (benzfendizone), 3-(2-chloro-4-methylsulphonylbenzoyl)-4-phenylthiobicyclo-[3.2.1]-oct-3-en-2-one (benzobicyclon), 2-[[4-(2,4-dichloro-3-methylbenzoyl)-1,3-dimethyl-1H-pyrazol-5-yl]oxy]-1-(4-methylphenyl)ethanone (benzofenap), methyl 5-(2,4-dichlorophenoxy)-2-nitrobenzoate (bifenox), 2,6-bis-(4,6-dimethoxypyrimidin-2-yloxy)benzoic acid sodium salt (bispyribac-sodium), 5-bromo-6-methyl-3-(1-methylpropyl)-2,4(1H,3H)-pyrimidinedione (bromacil), 2-bromo-3,3-dimethyl-N-(1-methyl-1-phenylethyl)butanamide(bromobutide), 3,5-dibromo-4-hydroxy-benzaldehyde O-(2,4-dinitrophenyl)oxime (bromofenoxim), 3,5-dibromo-4-hydroxybenzonitrile (bromoxynil), N-butoxymethyl-2-chloro-N-(2,6-diethylphenyl)acetamide (butachlor), 1,1-dimethyl-2-oxo-2-(2-propenyloxy)]ethyl 2-chloro-5-(3,6-dihydro-3-methyl-2,6-dioxo-4-trifluoromethyl-1 (2H)-pyrimidinyl)benzoate (butafenacil), 4-(1-t-butyl)-N-(s-butyl)-2,6-dinitroaniline (butralin), 2-(1-ethoximinopropyl)-3-hydroxy-5-[2,4,6-trimethyl-3-(1-oxobutyl)-phenyl]-2-cyclohexen-1-one (butroxydim), S-ethyl bis-(2-methylpropyl)thio-carbamate (butylate), N,N-diethyl-3-(2,4,6-trimethylphenylsulphonyl)-1H-1,2,4-triazole-1-carboxamide(cafenstrole), (R)-N-ethyl-2-[(phenylaminocarbonyl)-oxy]propanamide(carbetamide), 2-(4-chloro-2-fluoro-5-(2-chloro-2-ethoxy-carbonylethyl)phenyl)-4-difluoromethyl-5-methyl-2,4-dihydro-3H-1,2,4-triazol-3-one (carfentrazone-ethyl), 2,4-dichloro-1-(3-methoxy-4-nitrophenoxy)-benzene (chlormethoxyfen), 5-amino-4-chloro-2-phenyl-3(2H)-pyridazinone -(chloridazon), N-(4-chloro-6-methoxypyrimidin-2-yl)-N′-(2-ethoxycarbonyl-phenylsulphonyl)urea (chlorimuron-ethyl), 1,3,5-trichloro-2-(4-nitrophen-oxy)benzene (chlornitrofen), N′-(3-chloro-4-methylphenyl)-N,N-dimethylurea (chlorotoluron), N-(4-methoxy-6-methyl-1,3,5-triazin-2-yl)-N′-(2-chlorophenylsulphonyl)urea (chlorsulfuron), ethyl 2-chloro-3-[2-chloro-5-(1,3,4,5,6,7-hexahydro-1,3-dioxo-2H-isoindol-2-yl)phenyl]-2-propanoate (cinidon-ethyl), exo-1-methyl-4-isopropyl-2-(2-methylphenylmethoxy)-7-oxabicyclo-[2.2.1]-heptane (cinmethylin), N-(4,6-dimethoxy-1,3,5-triazin-2-yl)-N′-(2-(2-methoxyethoxy)-phenylsulphonyl)urea (cinosulfuron), 2-[1-[2-(4-chlorophenoxy)propoxyaminobutyl]-5-(tetrahydro-2H-thiopyran-3-yl)-1,3-cyclohexanedione (clefoxydim), (E,E)-(+)-2-[1-[[(3-chloro-2-propenyl)oxy]imino]propyl]-3-hydroxy-2-cyclohexen-1-one (clethodim), (R)-(2-propynyl)2-[4-(5-chloro-3-fluoropyridin-2-yloxy)phenoxypropanoate (clodinafop-propargyl), 2-[(2-chlorophenyl)methyl]-4,4-dimethyl-3-isoxazolidinone (clomazone), 2-(2,4-dichloro-3-methylphenoxy)-N-phenylpropanamide (clomeprop), 3,6-dichloropyridin-2-carboxylic acid (clopyralid), methyl 3-chloro-2-[(5-ethoxy-7-fluoro[1,2,4]triazolo[1,5-c]-pyrimidin-2-ylsulphonyl)amino]benzoate (cloransulam-methyl), N-[(2-chlorophenyl)methyl]-N′-(1-methyl-1-phenylethyl)urea (cumyluron), 2-chloro-4-ethylamino-6-(1-cyano-1-methylethylamino)-1,3,5-triazine (cyanazine), N-(4,6-dimethoxypyrimidin-2-yl)-N′-(2-cyclopropylcarbonylphenylsulphonyl)urea (cyclosulfamuron), 2-(1-ethoximinobutyl)-3-hydroxy-5-(tetrahydro-2H-thiopyran-3-yl)-2-cyclohexen-1-one (cycloxydim), (R)-butyl 2-[4-(4-cyano-2-fluorophenoxy)phenoxy]propanoate (cyhalofop-butyl), 2,4-dichlorophenoxyacetic acid (2,4-D), O-ethyl N-[3-(phenylaminocarbonyloxy)phenyl]-carbamate (desmedipham), 3,6-dichloro-2-methoxybenzoic acid (dicamba), 2,6-dichlorobenzonitrile (dichlobenil), (R)-2-(2,4-dichlorophenoxy)propanoic acid (dichlorprop-P), methyl 2-[4-(2,4-dichlorophenoxy)phenoxy]propanoate (diclofop-methyl), N-(2,6-dichlorophenyl)-5-ethoxy-7-fluoro-[1,2,4]-triazolo-[1,5-c]-pyrimidine-2-sulphonamide(diclosulam), 1,2-dimethyl-3,5-diphenyl-1H-pyrazolium methylsulphate (difenzoquat), N-(2,4-difluorophenyl)-2-(3-trifluoro-methylphenoxy)pyridine-3-carboxamide(diflufenican), 2-[1-[(3,5-difluorophenyl)aminocarbonylhydrazono]ethyl]pyridine-3-carboxylic acid (diflufenzopyr), N′-[3-chloro-4-(5-t-butyl-oxo-1,3,4-oxadiazol-3(2H)-yl)phenyl]-N,N-dimethylurea (dimefuron), S-(1-methyl-1-phenylethyl)1-piperidinecarbothioate (dimepiperate), 2-chloro-N-(2,6-dimethylphenyl)-N-(2-methoxyethyl)acetamide (dimethachlor), N-(1,2-dimethylpropyl)-N′-ethyl-6-methylthio-1,3,5-triazine-2,4-diamine(dimethametryn), (S—) 2-chloro-N-(2,4-dimethyl-3-thienyl)-N-(2-methoxy-1-methylethyl)acetamide((S—) (dimethenamid)), 2-amino-4-(1-fluoro-1-methylethyl)-6-(1-methyl-2-(3,5-dimethylphenoxy)ethylamino)-1,3,5-triazine (dimexyflam), 6,7-dihydrodipyrido[1,2-a:2′,1′-c]pyrazinediium dibromide (di-quat-dibromide), S,S-di methyl 2-difluoromethyl-4-isobutyl-6-trifluoromethylpyridine-3,5-dicarbothioate (dithiopyr), N′-(3,4-dichlorophenyl)-N,N-dimethylurea (diuron), N-(4-methylphenyl)-N′-(1-methyl-1-phenylethyl)urea (dymron, daimuron), S-ethyl dipropylthiocarbamate (EPTC), S-(phenylmethyl) N-ethyl-N-(1,2-dimethylpropyl)thiocarbamate (Esprocarb), N-ethyl-N-(2-methyl-2-propenyl)-2,6-dinitro-4-trifluoromethylbenzeneamine(ethalfluralin), methyl 2-[[[[(4-ethoxy-6-methylamino-1,3,5-triazin-2-yl)amino]carbonyl]amino]-sulphonyl]benzoate (ethametsulfuron-methyl), 2-ethoxy-2,3-dihydro-3,3-dimethyl-5-benzofuranylmethanesulphonate (ethofumesate), (S)-(2-ethoxy-1-methyl-2-oxoethyl) 2-chloro-5-(2-chloro-4-trifluoromethylphenoxy)benzoate (ethoxyfen), N-(4,6-dimethoxypyrimidin-2-yl)-N′-(2-ethoxyphenoxysulphonyl)urea (ethoxysulfuron), N-(2,3-dichlorophenyl)-4-ethoxymethoxybenzamide (etobenzamide), (R)-ethyl 2-[4-(6-chlorobenzoxazol-2-yloxy)phenoxy]propanoate (Fenoxaprop-(P)-ethyl), 4-(2-chlorophenyl)-N-cyclohexyl-N-ethyl-4,5-dihydro-5-oxo-1H-tetrazole-1-carboxamide(fentrazamide), isopropyl N-benzoyl-N-(3-chloro-4-fluorophenyl)-D-alaninate (flamprop-M-isopropyl), methyl N-benzoyl-N-(3-chloro-4-fluorophenyl)-D-alaninate (flamprop-M-methyl), N-[[(4,6-dimethoxy-2-pyrimidinyl)amino]carbonyl]-3-trifluoromethyl-2-pyridinesulphonamide(flazasulfuron), N-(2,6-difluorophenyl)-8-fluoro-5-methoxy-[1,2,4]-triazolo-[1,5-c]-pyrimidine-2-sulphonamide(florasulam), (R)-butyl 2-[4-(5-trifluoromethylpyridin-2-yloxy)phenoxy]propanoate (fluazifop-P-butyl), isopropyl 5-(4-bromo-1-methyl-5-trifluoromethyl-1H-pyrazol-3-yl)-2-chloro-4-fluorobenzoate (fluazolate), N-(4-fluorophenyl)-N-isopropyl-2-(5-trifluoromethyl-1,3,4-thiadiazol-2-yloxy)acetamide(flufenacet), ethyl [2-chloro-4-fluoro-5-(5-methyl-6-oxo-4-trifluoromethyl-1 (6H)-pyridazinyl)phenoxy]acetate (flufenpyr), N-(2,6-difluorophenyl)-5-methyl-1,2,4-triazolo[1,5-a]-pyrimidine-2-sulphonamide(flumetsulam), pentyl [2-chloro-4-fluoro-5-(1,3,4,5,6,7-hexahydro-1,3-dioxo-2H-isoindol-2-yl)phenoxy]acetate(flumiclorac-pentyl), 2-[7-fluoro-3,4-dihydro-3-oxo-4-(2-propynyl)-2H-1,4-benzoxazin-6-yl]-4,5,6,7-tetrahydro-1H-isoindole-1,3-dione (flumioxazin), 2-[4-chloro-2-fluoro-5-[(1-methyl-2-propynyl)oxy]phenyl]-4,5,6,7-tetrahydro-1H-isoindole-1,3(2H)-dione (flumipropyn), N,N-dimethyl-N′-(3-trifluoromethylphenyl)urea (fluometuron), 3-chloro-4-chloromethyl-1-(3-trifluoromethylphenyl)-2-pyrrolidinone (fluorochloridone), ethoxycarbonylmethyl 5-(2-chloro-4-trifluoromethylphenoxy)-2-nitrobenzoate (fluoroglycofen-ethyl), 1-(4-chloro-3-(2,2,3,3,3-pentafluoropropoxymethyl)phenyl)-5-phenyl-1H-1,2,4-triazol-3-carboxamide(flupoxam), 1-isopropyl-2-chloro-5-(3,6-dihydro-3-methyl-2,6-dioxo-4-trifluoromethyl-1 (2H)-pyrimidyl)benzoate (flupropacil), N-(4,6-dimethoxypyrimidin-2-yl)-N′-(3-methoxycarbonyl-6-trifluoromethylpyridin-2-ylsulphonyl)urea sodium salt (flupyrsulfuron-methyl-sodium), 9-hydroxy-9H-fluorene-9-carboxylic acid (flurenol), (4-amino-3,5-dichloro-6-fluoropyridin-2-yloxy)acetic acid (2-butoxy-1-methylethyl ester, 1-methylheptyl ester) (fluroxypyr, -butoxypropyl, -meptyl), 5-methylamino-2-phenyl-4-(3-trifluoromethylphenyl)-3(2H)-furanone (flurtamone), methyl [(2-chloro-4-fluoro-5-(tetrahydro-3-oxo-1H,3H-[1,3,4]-thiadiazolo-[3,4-a]-pyridazin-1-ylidene)aminophenyl]thioacetate(fluthiacetmethyl), 5-(2-chloro-4-trifluoromethylphenoxy)-N-methylsulphonyl-2-nitrobenzamide (fomesafen), 2-[[[[(4,6-dimethoxy-2-pyrimidinyl)amino]carbonyl]amino]-sulphonyl]-4-formylamino-N,N-dimethylbenzamide(foramsulfuron), 2-amino-4-(hydroxymethylphosphinyl)butanoic acid (ammonium salt) (glufosinate (ammonium)), N-phosphonomethylglycine (isopropylammonium salt) (glyphosate, isopropylammonium), methyl 3-chloro-5-[[[[(4,6-dimethoxy-2-pyrimidinyl)amino]carbonyl]amino]sulphonyl]-1-methyl-1H-pyrazole-4-carboxylate (halosulfuron-methyl), (R)-2-[4-(3-chloro-5-trifluoromethylpyridin-2-yloxy)phenoxy]propanoic acid (methyl ester, 2-ethoxyethyl ester, butyl-ester) (haloxyfop, -methyl, —P-methyl, -ethoxyethyl, -butyl), 3-cyclohexyl-6-di-methylamino-1-methyl-1,3,5-triazine-2,4(1H,3H)-dione (hexazinone), methyl 2-(4,5-dihydro-4-methyl-4-isopropyl-5-oxo-1H-imidazol-2-yl)-4-methylbenzoate (imazamethabenz-methyl), 2-(4,5-dihydro-4-methyl-4-isopropyl-5-oxo-1H-imidazol-2-yl)-5-methoxymethylpyridine-3-carboxylic acid (imazamox), -2-(4,5-dihydro-4-methyl-4-isopropyl-5-oxo-1H-imidazol-2-yl)-5-methylpyridine-3-carboxylic acid (imazapic), 2-(4,5-dihydro-4-methyl-4-(isopropyl)-5-oxo-1H-imidazol-2-yl)-3-pyridinecarboxylic acid (imazapyr), 2-(4,5-dihydro-4-methyl-4-isopropyl-5-oxo-1H-imidazol-2-yl)quinoline-3-carboxylic acid (imazaquin), 2-(4,5-dihydro-4-methyl-4-isopropyl-5-oxo-1H-imidazol-2-yl)-5-ethylpyridine-3-carboxylic acid (imazethapyr), N-(4,6-dimethoxypyrimidin-2-yl)-N′-(2-chloroimidazo[1,2-a]-pyridin-3-ylsulphonyl)urea (imazosulturon), 2-[2-(3-chlorophenyl)oxiranylmethyl]-2-ethyl-1H-indene-1,3(2H)-dione (indanofan), N-(4-methoxy-6-methyl-1,3,5-triazin-2-yl)-N′-(5-iodo-2-methoxycarbonylphenyl-sulphonyl)urea sodium salt (iodosulfuron-methyl-sodium), 4-hydroxy-3,5-diiodobenzonitrile (ioxynil), N,N-dimethyl-N′-(4-isopropylphenyl)urea (isoproturon), N-(5-t-butyl-3-isoxazolyl)-N′,N′-dimethylurea (isouron), N-(3-(1-ethyl-1-methylpropyl)isoxazol-5-yl)-2,6-dimethoxybenzamide(isoxaben), (4-chloro-2-methylsulphonylphenyl)-(5-cyclopropylisoxazol-4-yl)methanone (isoxachlortole), (5-cyclopropylisoxazol-4-yl)-(2-methylsulphonyl-4-trifluoromethylphenyl)methanone (isoxaflutole), 2-[(2,3-dihydro-5,8-dimethyl-1,1-dioxidospiro-[4H-1-benzothiopyran-4,2′-[1,3]-dioxolan-6-yl)carbonyl]-1,3-cyclohexanedione (ketospiradox), (2-ethoxy-1-methyl-2-oxoethyl) 5-(2-chloro-4-trifluoromethylphenoxy)-2-nitrobenzoate (lactofen), 3-cyclohexyl-6,7-dihydro-1H-cyclopentapyrimidine-2,4-(3H,5H)-dione (lenacil), N′-(3,4-dichlorophenyl)-N-methoxy-N-methylurea (linuron), (4-chloro-2-methylphenoxy)acetic acid (MCPA), (R)-2-(4-chloro-2-methylphenoxy)propionic acid (mecoprop-P), 2-(2-benzothiazolyloxy)-N-methyl-N-phenylacetamide(mefenacet), methyl 2-[[[[(4,6-dimethoxy-2-pyrimidinyl)amino]carbonyl]amino]sulphonyl]-4-[[(methylsulphonyl)amino]methyl]benzoate (mesosulfuron), 2-(4-methylsulphonyl-2-nitrobenzoyl)-1,3-cyclohexanedione (mesotrione), 4-amino-3-methyl-6-phenyl-1,2,4-triazin-5(4H)-one (metamitron), 2-chloro-N-(2,6-dimethylphenyl)-N-(1H-pyrazol-1-ylmethyl)acetamide(metazachlor), N-(2-benzothiazolyl)-N,N′-dimethylurea (methabenzthiazuron), N′-(4-bromophenyl)-N-methoxy-N-methylurea (metobromuron), (S)-2-chloro-N-(2-ethyl-6-methylphenyl)-N-(2-methoxy-1-methylethyl)acetamide(metolachlor, S-metolachlor), N-(2,6-dichloro-3-methylphenyl)-5,7-dimethoxy-1,2,4-triazolo[1,5-a]-pyrimidine-2-sulphonamide(metosulam), N′-(3-chloro-4-methoxyphenyl)-N,N—-dimethylurea (metoxuron), 4-amino-6-tert-butyl-3-methylthio-1,2,4-triazin-5(4H)-one (metribuzin), N-(4-methoxy-6-methyl-1,3,5-triazin-2-yl)-N′-(2-methoxycarbonylphenylsulphonyl)urea (metsulfuron-methyl), S-ethyl hexahydro-1H-azepine-1-carbothioate (molinate), 2-(2-naphthyloxy)-N-phenylpropanamide (naproanilide), N,N-diethyl-2-(1-naphthalenyloxy)propanamide(napropamide), N-butyl-N′-(3,4-dichlorophenyl)-N-methylurea (neburon), N-(4,6-dimethoxypyrimidin-2-yl)-N′-(3-dimethylcarbamoylpyridin-2-ylsulphonyl)urea (nicosulfuron), 4-chloro-5-methylamino-2-(3-trifluoromethylphenyl)-3(2H)pyridazinone (norflurazon), S-(2-chlorobenzyl) N,N-diethylthiocarbamate (orbencarb), 4-dipropylamino-3,5-dinitrobenzenesulphonamide(oryzalin), 3-[2,4-dichloro-5-(2-propynyloxy)phenyl]-5-(t-butyl)-1,3,4-oxadiazol-2(3H)-one (oxadiargyl), 3-[2,4-dichloro-5-(1-methylethoxy)phenyl]-5-(t-butyl)-1,3,4-oxadiazol-2(3H)-one (oxadiazon), N-(4,6-dimethylpyrimidin-2-yl)-N′-(2-oxetan-3-yloxycarbonylphenylsulphonyl)urea (oxasulfuron), 3-[1-(3,5-dichlorophenyl)-1-isopropyl]-2,3-dihydro-6-methyl-5-phenyl-4H-1,3-oxazin-4-one (oxaziclomefone), 2-chloro-1-(3-ethoxy-4-nitrophenoxy)-4-trifluoromethylbenzene (oxyfluorfen), 1,1′-dimethyl-4,4′-bipyridinium (paraquat), 1-amino-N-(1-ethylpropyl)-3,4-dimethyl-2,6-dinitrobenzene (pendimethalin), 4-(t-butyl)-N-(1-ethylpropyl)-2,6-dinitrobenzeneamine(pendralin), 2-(2,2-difluoroethoxy)-N-(5,8-dimethoxy-[1,2,4]triazolo[1,5-c]pyrimidin-2-yl)-6-trifluoromethylbenzenesulphonamide (penoxsulam), 3-(4-chloro-5-cyclopentyloxy-2-fluorophenyl)-5-(1-methylethylidene)-2,4-oxazolidinedione (pentoxazone), 2-chloro-N-(2-ethoxyethyl)-N-(2-methyl-1-phenyl-1-propenyl)acetamide(pethoxamid), O-methyl N-[3-(3-methylphenylaminocarbonyloxy)phenyl]carbamate (phenmedipham), 4-amino-3,5,6-trichloropyridine-2-carboxylic acid (picloram), N-(4-fluorophenyl)-6-(3-trifluoromethylphenoxy)pyridine-2-carboxamide(picolinafen), S-[2-(2-methyl-1-piperidinyl)-2-oxoethyl]O,O-dipropyl phosphorodithioate (piperophos), 2-chloro-N-(2,6-diethylphenyl)-N-(2-propoxyethyl)acetamide(pretilachlor), N-(4,6-bis-difluoromethoxypyrimidin-2-yl)-N′-(2-methoxycarbonylphenylsulphonyl)urea (primisulfuron-methyl), 1-chloro-N-[2-chloro-4-fluoro-5-[(6S,7aR)-6-fluorotetrahydro-1,3-dioxo-1H-pyrrolo[1,2-c]imidazol-2(3H)yl]phenyl]methanesulphonamide (profluazol), 2-[1-[[2-(4-chlorophenoxy)propoxy]imino]butyl]-3-hydroxy-5-(tetrahydro-2H-thiopyranyl)-2-cyclohexen-1-one (profoxydim), N,N′-bis-isopropyl-6-methylthio-1,3,5-triazine-2,4-diamine(prometryn), 2-chloro-N-isopropyl-N-phenylacetamide (propachlor), N-(3,4-dichlorophenyl)propanamide (propanil), (R)-[2-[[(1-methylethylidene)amino]oxy]ethyl]2-[4-(6-chloro-2-quinoxalinyloxy)phenoxy]propanoate (propaquizafop), 2-chloro-N-(2-ethyl-6-methylphenyl)-N-[(1-methylethoxy)methyl]acetamide(propisochlor), methyl 2-[[[(4,5-dihydro-4-methyl-5-oxo-3-propoxy-1H-1,2,4-triazol-1-yl)carbonyl]-amino]sulphonyl]benzoate sodium salt (propoxycarbazone-sodium), 3,5-dichloro-N-(1,1-dimethyl-2-propynyl)benzamide(propyzamide), S-phenylmethyl N,N-dipropylthiocarbamate (prosulfocarb), N-(4-methoxy-6-methyl-1,3,5-triazin-2-yl)-N′-(2-(3,3,3-trifluoropropyl)phenylsulphonyl) urea (prosulfuron), 1-(3-chloro-4,5,6,7-tetrahydropyrazolo[1,5-a]pyridin-2-yl)-5-(methyl-2-propynylamino)-1H-pyrazole-4-carbonitrile (pyraclonil), ethyl [2-chloro-5-(4-chloro-5-difluoromethoxy-1-methyl-1H-pyrazol-3-yl)-4-fluorophenoxy]acetate (pyraflufen-ethyl), 4-(2,4-dichlorobenzoyl)-1,3-dimethyl-5-(4-methylphenylsulphonyloxy)pyrazole (pyrazolate), N-(4,6-dimethoxypyrimidin-2-yl)-N′-(4-ethoxycarbonyl-1-methylpyrazol-5-ylsulphonyl)urea (pyrazosulfuron-ethyl), 4-(2,4-dichlorobenzoyl)-1,3-dimethyl-5-(phenylcarbonylmethoxy)pyrazole (pyrazoxyfen), diphenylmethanone O-[2,6-bis-(4,6-dimethoxypyrimidin-2-yl-oxy)benzoyl]oxime (pyribenzoxim), O-[3-(1,1-dimethylethyl)phenyl](6-methoxy-2-pyridinyl)methylthiocarbamate (pyributicarb), 6-chloro-3-phenyl-4-pyridazinol (pyridafol), O-(6-chloro-3-phenylpyridazin-4-yl)S-octyl thiocarbonate (pyridate), 6-chloro-3-phenylpyridazin-4-ol (pyridatol), 7-[(4,6-dimethoxy-2-pyrimidinyl)thio]-3-methyl-1 (3H)-isobenzofuranone (pyriftalid), methyl 2-(4,6-dimethoxypyrimidin-2-yloxy)benzoate (pyriminobac-methyl), 2-chloro-6-(4,6-dimethoxypyrimidin-2-ylthio)benzoic acid sodium salt (pyrithiobac-sodium), 3,7-dichloroquinoline-8-carboxylic acid (quinchlorac), 7-chloro-3-methylquinoline-8-carboxylic acid (quinmerac), 2-amino-3-chloro-1,4-naphthalenedione (quinoclamine), (R)-2-[4-(6-chloro-2-quinoxalinyloxy)phenoxy]propanoic acid (ethyl ester, tetrahydro-2-furanylmethyl ester) (quizalofop, -ethyl, —P-ethyl, —P-tefuryl), N-(4,6-dimethoxypyrimidin-2-yl)-N′-(3-ethylsulphonylpyridin-2-ylsulphonyl)urea (rimsulfuron), 2-(1-ethoximinobutyl)-5-(2-ethylthiopropyl)-3-hydroxy-2-cyclohexen-1-one (sethoxydim), 6-chloro-2,4-bis-ethylamino-1,3,5-triazine (simazine), 2-(2-chloro-4-methylsulphonylbenzoyl)cyclohexane-1,3-dione (sulcotrione), 2-(2,4-dichloro-5-methylsulphonylaminophenyl)-4-difluoromethyl-5-methyl-2,4-dihydro-3H-1,2,4-triazol-3-one (sulfentrazone), methyl 2-[[[[(4,6-dimethyl-2-pyrimidinyl)amino]carbonyl]amino]sulphonyl]benzoate (sulfometuron-methyl), N-phosphonomethylglycine trimethylsulphonium (sulfosate), N-(4,6-dimethoxypyrimidin-2-yl)-N′-(2-ethylsulphonyl)imidazo-[1,2-a]pyridine-3-sulphonamide(sulfosulfuron), N-(5-t-butyl-1,3,4-thiadiazol-2-yl)-N,N′-dimethylurea (tebuthiuron), 2-[1-[(3-chloro-2-propenyl)oxyimino]-propyl]-3-hydroxy-5-(tetrahydro-2H-pyran-4-yl)-2-cyclohexen-1-one (tepraloxydim), 6-chloro-4-ethylamino-2-t-butylamino-1,3,5-triazine (terbuthylazine), 2-t-butylamino-4-ethylamino-6-methylthio-1,3,5-triazine (terbutryn), 2-chloro-N-(2,6-dimethylphenyl)-N-(3-methoxy-2-thienylmethyl)acetamide(thenylchlor), 2-difluoromethyl-5-(4,5-dihydrothiazol-2-yl)-4-(2-methylpropyl)-6-trifluoromethylpyridine-3-carboxylate (thiazopyr), N-(4-methoxy-6-methyl-1,3,5-triazin-2-yl)-N′-(2-methoxycarbonylthien-3-ylsulphonyl)urea (thifensulfuron-methyl), S-phenylmethyl bis-s-butylcarbamothioate (tiocarbazil), 2-(ethoximinopropyl)-3-hydroxy-5-(2,4,6-trimethylphenyl)-2-cyclohexen-1-one (tralkoxydim), S-(2,3,3-trichloro-2-propenyl) diisopropylcarbamothioate (triallate), N-(4-methoxy-6-methyl-1,3,5-triazin-2-yl)-N′-[2-(2-chloroethoxy)phenylsulphonyl]urea (triasulfuron), N-methyl-N-(4-methoxy-6-methyl-1,3,5-triazin-2-yl)-N′-(2-methoxycarbonylphenylsulphonyl)urea (tribenuron-methyl), (3,5,6-trichloro)pyridin-2-yloxyacetic acid (triclopyr), 2-(3,5-dichlorophenyl)-2-(2,2,2-trichloroethyl)-oxirane (tridiphane), N-[[(4,6-dimethoxy-2-pyrimidinyl)amino]carbonyl]-3-(2,2,2-trifluoroethoxy)-2-pyridinesulphonamide sodium salt (trifloxysulfuron), 1-amino-2,6-dinitro-N,N-dipropyl-4-trifluoromethylbenzene (trifluralin), N-[4-dimethylamino-6-(2,2,2-trifluoroethoxy)-1,3,5-triazin-2-yl]-N′-(2-methoxycarbonylphenylsulphonyl)urea (triflusulfuron-methyl), N-(4-methoxy-6-trifluoromethoxy-1,3,5-triazin-2-yl)-N′-(2-trifluoromethylphenylsulphonyl)urea (tritosulfuron), N-[[(4,6-dimethoxy-2-pyrimidinyl)amino]carbonyl]-3-(N-methyl-N-methylsulphonylamino)-2-pyridinesulphonamide, N-[[(4,6-dimethoxy-2-pyrimidinyl)amino]carbonyl]-3-(N-methyl-N-methylsulphonylamino)-2-pyridinesulphonamide, 4-(4,5-dihydro-4-methyl-5-oxo-3-trifluoromethyl-1H-1,2,4-triazol-1-yl)-2-(ethylsulphonylamino)-5-fluorobenzenecarbothioamide (HWH4991), 2-chloro-N-[1-(2,6-dichloro-4-difluoromethylphenyl)-4-nitro-1H—-pyrazol-5-yl]propanecarboxamide (SLA5599), [2-chloro-3-(4,5-dihydro-3-isoxazolyl)-4-methylsulphonylphenyl]-(5-hydroxy-1-methyl-1H-pyrazol-4-yl)-methanone, [3-(4,5-dihydro-3-isoxazolyl)-2-methyl-4-methylsulphonylphenyl]-(5-hydroxy-1-methyl-1H-pyrazol-4-yl)methanone, [3-[2-chloro-3-[(2,6-dioxocyclohexyl)carbonyl]-6-ethylsulphonylphenyl]-5-isoxazolyl]acetonitrile, 2-[2-chloro-4-methylsulphonyl-3-[(2,2,2-trifluoroethoxy)methyl]benzoyl]-1,3-cyclohexanedione, and 2-[[5,8-dimethyl-1,1-dioxido-4-(2-pyrimidinyloxy)-3,4-dihydro-2H-thiochromen-6-yl]carbonyl]-1,3-cyclohexanedione, and/or
(c) optionally a compound that improves compatibility with crop plants selected from the group consisting of the compounds 4-dichloroacetyl-1-oxa-4-azaspiro[4.5]-decane (AD-67), 1-dichloroacetylhexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 4-carboxy-3,4-dihydro-2H-1-benzopyran-4-acetic acid (CL-304415), 1-methylhexyl 5-chloroquinolin-8-oxyacetate (cloquintocet-mexyl), α-(cyanomethoximino)phenylacetonitrile (cyometrinil), 2,4-dichlorophenoxy acetic acid (2,4-D), 2,2-dichloro-N-(2-oxo-2-(2-propenylamino)ethyl)-N-(2-propenyl)acetamide (DKA-24), 2,2-dichloro-N,N-di-2-propenylacetamide(dichlormid), N-(4-methylphenyl)-N′-(1-methyl-1-phenylethyl)urea (daimuron, dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazol-ethyl), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl), (4-chloro-2-methylphenoxy)acetic acid (MCPA), (+−)-2-(4-chloro-2-methylphenoxy)propanoic acid (mecoprop), diethyl 1-(2,4-dichlorophenyl)-4,5-dihydro-5-methyl-1H-pyrazol-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2,5-trimethyloxazolidine (R-29148), N-cyclopropyl-4-[[(2-methoxy-5-methylbenzoyl)amino]sulphonyl]benzamide, N-[[(4-methoxyacetylamino)phenyl]sulphonyl]-2-methoxybenzamide, N-[[(4-methylaminocarbonylamino)phenyl]sulphonyl]-2-methoxybenzamide, methyl (3-oxoisochroman-4-ylidenemethoxy)acetate and methyl(3-oxo-1H-2-benzothiopyran-4-(3H)-ylidenemethoxy)acetate, 1-ethyl-4-hydroxy-3-(1H-tetrazolyl-5-ylcarbonyl)-2-(1H)-quinoline.

12. A composition according to claim 11 in which
n represents the number 0,
A represents alkanediyl (alkylene) having 1 to 5 carbon atoms or alkenediyl having 2 to 5 carbon atoms,
Ar represents optionally substituted phenyl or naphthyl; or represents optionally substituted heterocyclyl selected from the group consisting of furyl, tetrahydrofuryl, thienyl, tetrahydrothienyl, benzofuryl, dihydrobenzofuryl, benzothienyl, pyrrolyl, pyrazolyl, pyranyl, benzopyranyl, dihydrobenzopyranyl, tetrahydrobenzopyranyl, pyridinyl, quinolinyl, and pyrimidinyl,
where the optional substituents are selected from the group consisting of nitro, cyano, carboxyl, carbamoyl, thiocarbamoyl, fluorine, chlorine, bromine, methyl, ethyl, n- or isopropyl, n-, iso-, s-, or t-butyl, trifluoromethyl, methoxy, ethoxy, n- or isopropoxy, n-, iso-, s-, or t-butoxy, difluoromethoxy, trifluoromethoxy, methylthio, ethylthio, n- or isopropylthio, n-, iso-, s-, or t-butylthio, difluoromethylthio, trifluoromethylthio, methylsulphinyl, ethylsulphinyl, n- or isopropylsulphinyl, trifluoromethylsulphinyl, methylsulphonyl, ethylsulphonyl, n- or iso-propylsulphonyl, trifluoromethylsulphonyl, methylamino, ethylamino, n- or isopropylamino, n-, iso-, s-, or t-butylamino, dimethylamino, diethylamino, acetyl, propionyl, n- or isobutyroyl, methoxycarbonyl, ethoxycarbonyl, n- or isopropoxycarbonyl, methylaminocarbonyl, ethylaminocarbonyl, n- or isopropylaminocarbonyl, dimethylaminocarbonyl, diethylaminocarbonyl, dimethylaminosulphonyl, and diethylaminosulphonyl,
R¹ represents optionally fluorine-, chlorine-, and/or bromine-substituted alkyl having 1 to 5 carbon atoms; represents optionally fluorine-, chlorine-, and/or bromine-substituted alkenyl having 2 to 5 carbon atoms; represents optionally fluorine-, chlorine-, and/or bromine-, or C₁-C₄-alkyl-substituted cycloalkyl having 3 to 6 carbon atoms; represents optionally nitro-, cyano-, fluorine-, chlorine-, bromine-, methyl-, ethyl-, n- or isopropyl-, n-, iso-, s-, or t-butyl-, methoxy-, ethoxy-, n- or isopropoxy-, or n-, iso-, s-, or t-butoxy-substituted aryl or arylalkyl having in each case 6 or 10 carbon atoms in the aryl group and, if appropriate, 1 to 3 carbon atoms in the alkyl moiety; or represents optionally nitro-, cyano-, fluorine-, chlorine-, bromine-, methyl-, ethyl-, n- or isopropyl-, n-, iso-, s-, or t-butyl-, methoxy-, ethoxy-, n- or isopropoxy-, or n-, iso-, s-, or t-butoxy-substituted heterocyclyl having 5 carbon atoms and 1 to 3 nitrogen atoms and/or 1 or 2 oxygen or sulphur atoms,
R² represents cyano, carbamoyl, thiocarbamoyl, fluorine, chlorine, or bromine; or represents optionally fluorine-, chlorine-, and/or bromine-substituted methyl, ethyl, n- or isopropyl, methoxy, ethoxy, or n- or isopropoxy,
R³ represents hydrogen, cyano, carbamoyl, thiocarbamoyl, fluorine, chlorine, or bromine;
Z represents one of the groups 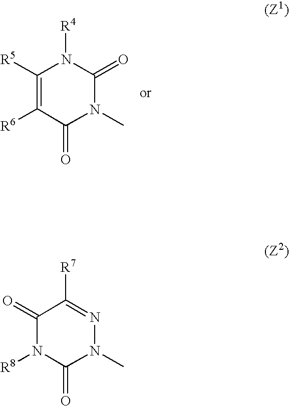
in which
R⁴ represents hydrogen, amino or optionally fluorine-, chlorine-, and/or bromine-substituted methyl, ethyl or n- or isopropyl,
R⁵ represents carboxyl, cyano, carbamoyl, thiocarbamoyl, or optionally fluorine-, chlorine, and/or bromine-substituted methyl, ethyl, n- or isopropyl, methoxycarbonyl, ethoxycarbonyl, or n- or iso-propoxycarbonyl,
R⁶ represents hydrogen, fluorine, chlorine, bromine, or optionally fluorine-, chlorine-, and/or bromine-substituted methyl, ethyl, or n- or isopropyl,
R⁷ represents hydrogen, cyano, fluorine, chlorine, bromine, or optionally F cyano-, fluorine-, chlorine-, bromine-, methoxy-, ethoxy-, n- or isopropoxy-, or n-, iso-, s-, or t-butoxy-substituted alkyl, alkoxy, alkylthio, alkylamino, or dialkylamino having in each case 1 to 3 carbon -atoms in the alkyl groups,
R⁸ represents hydrogen or optionally cyano-, fluorine-, chlorine-, bromine-, methoxy-, ethoxy-, n- or isopropoxy-, or n-, iso-, s-, or t-butoxy-substituted alkyl, alkoxy, alkylamino, alkylcarbonyl, or alkoxycarbonyl having in each case 1 to 3 carbon atoms in the alkyl groups,
R⁹ represents hydrogen, cyano, fluorine, chlorine, bromine, or one of the groups —R¹¹, —O—R¹¹, S—R¹¹, or SO₂—R¹¹,
R¹⁰ represents hydrogen, hydroxyl, amino, or the group —R¹¹, and
R¹¹ —represents optionally cyano-, fluorine-, chlorine-, bromine-, methoxy-, ethoxy-, n- or isopropoxy-, or n-, iso-, s-, or t-butoxy-substituted alkyl having 1 to 4 carbon atoms; represents optionally halogen-substituted alkenyl or alkynyl having in each case 2 to 4 carbon atoms; represents optionally cyano-, fluorine-, chlorine-, bromine-, ethyl-, methyl-, n- or isopropyl-, or n-, iso-, s- or t-butyl-substituted cycloalkyl having 3 to 6 carbon atoms; or represents optionally nitro-, cyano-, fluorine-, chlorine-, bromine-, C₁-C₄-alkyl-, C₁-C₄-haloalkyl, C₁-C₄-alkoxy, or C₁-C₄-haloalkoxy-substituted phenyl or benzyl.

13. A composition according to claim 11 in which
A represents methylene, ethane-1,1-diyl(ethylidene), ethane-1,2-diyl (dimethylene), propane-1,1-diyl(propylidene), propane-1,2-diyl, propane-1,3-diyl(trimethylene), ethene-1,2-diyl, propene-1,2-diyl, or propene-2,3-diyl,
Ar represents optionally substituted phenyl; or represents optionally substituted heterocyclyl selected from the group consisting of furyl, tetrahydrofuryl, thienyl, benzofuryl, dihydrobenzofuryl, benzothienyl, pyrrolyl, pyrazolyl, benzopyranyl, dihydrobenzopyranyl, tetrahydrobenzopyranyl, pyridinyl, and pyrimidinyl,
where the optional substituents are selected from the group consisting of nitro, cyano, carboxyl, carbamoyl, thiocarbamoyl, fluorine, chlorine, bromine, methyl, ethyl, n- or isopropyl, n-, iso-, s-, or t-butyl, trifluoromethyl, methoxy, ethoxy, n- or isopropoxy, difluoromethoxy, trifluoromethoxy, methylthio, ethylthio, n- or isopropylthio, difluoromethylthio, trifluoromethylthio, methylsulphinyl, ethylsulphinyl, trifluoromethylsulphinyl, methylsulphonyl, ethylsulphonyl, trifluoromethylsulphonyl, methylamino, ethylamino, n- or isopropylamino, dimethylamino, diethylamino, acetyl, propionyl, n- or isobutyroyl, methoxycarbonyl, ethoxycarbonyl, n- or isopropoxycarbonyl, methylaminocarbonyl, ethylaminocarbonyl, n- or isopropylaminocarbonyl, dimethylaminocarbonyl, diethylaminocarbonyl, dimethylaminosulphonyl, and diethylaminosulphonyl,
R¹ represents optionally fluorine-, chlorine-, and/or bromine-substituted methyl, ethyl, n- or isopropyl, or n-, iso-, s-, or t-butyl; represents optionally fluorine-, chlorine-, and/or bromine-substituted ethenyl, propenyl, or butenyl;
represents optionally fluorine-, chlorine-, bromine-, methyl-, ethyl-, or n- or isopropyl-substituted cyclopropyl, cyclobutyl, cyclopentyl, or cyclohexyl;
represents optionally nitro-, cyano-, fluorine-, chlorine-, bromine-, methyl-, ethyl-, n- or isopropyl-, n-, iso-, s-, or t-butyl-, methoxy-, ethoxy-, or n- or isopropoxy-substituted phenyl, naphthyl, benzyl, or phenylethyl; or represents optionally fluorine-, chlorine-, bromine-, methyl-, ethyl-, n- or isopropyl-, n-, iso-, s-, or t-butyl-, methoxy-, ethoxy-, or n- or isopropoxy-substituted heterocyclyl selected from the group consisting of furyl, thienyl, pyrazolyl, and pyridinyl,
R² represents cyano, carbamoyl, thiocarbamoyl, fluorine, chlorine, or bromine; or
represents optionally fluorine- and/or chlorine-substituted methyl, ethyl, methoxy, or ethoxy,
R³ represents hydrogen, cyano, fluorine, or chlorine,
Z represents the group (Z¹) 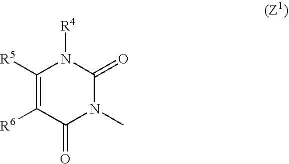
in which
R⁴ represents hydrogen, amino, or optionally fluorine-substituted methyl or ethyl,
R⁵ represents carboxyl, cyano, carbamoyl, thiocarbamoyl, or optionally -fluorine- and/or chlorine-substituted methyl, ethyl, methoxycarbonyl, or ethoxycarbonyl,
R⁶ represents hydrogen, fluorine, chlorine, bromine, or optionally fluorine-and/or chlorine-substituted methyl or ethyl,
R⁷ represents hydrogen, cyano, fluorine, chlorine, bromine, or optionally cyano-, fluorine-, chlorine-, methoxy-, ethoxy-, or n- or isopropoxy-substituted methyl, ethyl, n- or isopropyl, methoxy, ethoxy, n- or isopropoxy, methylthio, ethylthio, n- or isopropylthio, methylamino, ethylamino, n- or isopropylamino, dimethylamino, or diethylamino,
R⁸ represents hydrogen or optionally cyano-, fluorine-, chlorine-, methoxy-, ethoxy-, or n- or isopropoxy-substituted methyl, ethyl, n- or isopropyl, methoxy, ethoxy, n- or isopropoxy, methylamino, ethylamino, n- or iso-propylamino, acetyl, propionyl, n- or isobutyroyl, methoxycarbonyl, ethoxycarbonyl, or n- or isopropoxycarbonyl,
R⁹ represents hydrogen, cyano, fluorine, chlorine, bromine, or group —O—R¹′ or SO₂—R¹¹,
R¹⁰ represents hydrogen or the group —R¹¹, and
R¹¹ represents optionally cyano-, fluorine-, chlorine-, bromine-, methoxy-, ethoxy-, or n- or isopropoxy-substituted methyl, ethyl, n- or isopropyl, or n-, iso-, s-, or t-butyl; represents optionally fluorine-, chlorine-, and/or bromine-substituted ethenyl, propenyl, butenyl, ethynyl, propynyl, or butynyl; represents optionally cyano-, fluorine-, chlorine-, bromine-, methyl-, ethyl-, or n- or isopropyl-substituted cyclopropyl, cyclobutyl, cyclopentyl, or cyclohexyl; or represents optionally nitro-, cyano-, fluorine-, chlorine-, bromine-methyl-, ethyl-, n- or isopropyl-, n-, iso-, s-, or t-butyl-, trifluoromethyl-, methoxy-, ethoxy-, n- or isopropoxy-, difluoromethoxy-, or trifluoromethoxy-substituted phenyl or benzyl.

14. A composition according to claim 11 in which
A represents methylene, ethane-1,1-diyl(ethylidene), ethane-1,2-diyl (dimethylene), propane-1,1-diyl(propylidene), ethene-1,2-diyl, propene-1,2-diyl, or propene-2,3-diyl,
Ar represents optionally substituted phenyl, pyridinyl, or pyrimidinyl,
where the optional substituents are selected from the group consisting of cyano, carbamoyl, thiocarbamoyl, fluorine, chlorine, bromine, methyl, ethyl, trifluoromethyl, methoxy, ethoxy, and trifluoromethoxy,
R¹ represents optionally fluorine- and/or chlorine-substituted methyl, ethyl, n- or isopropyl, or n-, iso or s-butyl; represents optionally fluorine-, chlorine-, or methyl-substituted cyclopropyl; represents optionally fluorine-, chlorine-, bromine-, methyl-, ethyl-, methoxy-, or ethoxy-substituted phenyl or benzyl; or represents optionally fluorine-, chlorine-, bromine-, methyl-, ethyl-, methoxy-, or ethoxy-substituted heterocyclyl selected from the group consisting of furyl, thienyl, pyrazolyl, and pyridinyl,
R² represents cyano, chlorine, bromine, or trifluoromethyl,
R³ represents hydrogen, fluorine, or chlorine,
R⁴ represents hydrogen, amino, or methyl,
R⁵ represents cyano or trifluoromethyl,
R⁶ represents hydrogen, chlorine, bromine, or methyl,
R⁷ represents hydrogen, cyano, fluorine, chlorine, bromine, or optionally fluorine- and/or chlorine-substituted methyl or ethyl,
R⁸ represents hydrogen or optionally fluorine-substituted methyl or ethyl,
R⁹ represents hydrogen, chlorine, bromine, or the group —R¹¹, and
R¹¹ represents optionally fluorine-, chlorine-, methoxy-, or ethoxy-substituted methyl, ethyl, or n- or isopropyl; or represents optionally fluorine-, chlorine-, or methyl-substituted cyclopropyl.

15. A composition according to claim 11 in which component (b) comprises one or more compounds of a second group of herbicides selected from the group consisting of the active compounds flucarbazone-sodium, acetochlor, aclonifen, alachlor, amicarbazone, amidosulfuron, amitrole, anilofos, asulam, atrazine, beflubutamid, benazolin (-ethyl), benfuresate, bentazone, bifenox, bispyribac-sodium, bromoxynil, butylate, carfentrazone-ethyl, chlorotoluron, chlorosulfuron, cinidonethyl, clodinafop-propargyl, clopyralid, cyanazine, 2,4-D, desmedipham, dicamba, dichlorprop-P, diclofop-methyl, difenzoquat, diflufenican, diflufenzopyr, dimethenamid, S-dimethenamid, EPTC, ethofumesate, ethoxysulfuron, fenoxaprop-ethyl, fenoxaprop-P-ethyl, fentrazamide, flamprop-M-isopropyl, flamprop-M-methyl, florasulam, fluazifop-P-butyl, fluazolate, flufenacet, flumetsulam, fluoroglycofen-ethyl, flu pyrsulfu ron-methyl-sod ium, flu roxypyr, -butoxypropyl, -meptyl, flurtamone, fluthiacet-methyl, foramsulfuron, glufosinate, glufosinate-ammonium, halosulfuron-methyl, haloxyfop-P-methyl, imazamethabenz-methyl, imazamox, imazapic, imazapyr, imazaquin, imazethapyr, iodosulfuron-methyl-sodium, ioxynil, isoproturon, isoxaben, isoxachlortole, isoxaflutole, lactofen, linuron, MCPA, mecoprop-P, mefenacet, mesosulfuron, mesotrione, metamitron, metazachlor, methabenzthiazuron, metolachlor, S-metolachlor, metosulam, metribuzin, metsulfuron-methyl, naproanilide, neburon, nicosulfuron, oxadiargyl, oxadiazon, oxaziclomefone, oxyfluorfen, pendimethalin, penoxsulam, phenmedipham, picolinafen, primisulfuron-methyl, profluazol, propanil, propoxycarbazone-sod ium, prosulfocarb, prosulfu ron, pyraclonil, pyraflufen-ethyl, pyribenzoxim, pyridafol, pyridate, qinclorac, quinmerac, rimsulfuron, sulcotrione, sulfosate, sulfosulfuron, terbuthylazine, thifensulfuron-methyl, tralkoxydim, triallate, triasulfu ron, tribenu ron-methyl, tritosulfu ron, 4-(4,5-dihydro-4-methyl-5-oxo-3-trifluoromethyl-1H-1,2,4-triazol-1-yl)-2-(ethylsulfonylamino)-5-fluorobenzenecarbothioamide (HWH4991), and 2-chloro-N-[1-(2,6-dichloro-4-difluoromethylphenyl)-4-n itro-1H-pyrazol-5-yl]propanecarboxamide (SLA5599).

16. A composition according to claim 11 in which component (b) comprises one or more compounds of a second group of herbicides selected from the group consisting of the active compounds aclonifen, amicarbazone, amidosulfuron, amitrole, anilofos, asulam, benazolin-ethyl, benfuresate, bifenox, bispyribac-sodium, bromoxynil, desmedipham, diclofop-methyl, diflufenican, ethofumesate, ethoxysulfuron, fenoxaprop-ethyl, fenoxaprop-P-ethyl, fentrazamide, fluazifop-P-butyl, fluazolate, flucarbazone-sodium, flufenacet, flurtamone, foramsulfuron, glufosinate, glufosinate-ammonium, iodosulfuron, ioxynil, isoproturon, isoxachlortole, isoxaflutole, lactofen, linuron, mefenacet, mesosulfuron, metamitron, methabenzthiazuron, metribuzin, neburon, oxadiargyl, oxadiazon, oxaziclomefone, phenmedipham, propanil, propoxycarbazone-sodium, pyraclonil, pyraflufen-ethyl, and sulcotrione.

17. A composition according to claim 11 in which component (c) comprises a compound that improves compatibility with crop plants selected from the group consisting of the compounds 1-methylhexyl 5-chloroquinoline-8-oxyacetate -(cloquintocet-mexyl), ethyl 4,5-dihydro-5,5-diphenyl-3-isoxazolecarboxylate (isoxa-difen-ethyl), diethyl 1-(2,4-dichlorophenyl)-4,5-dihydro-5-methyl-1H-pyrazole-3,5-dicarboxylate (mefenpyr-diethyl), 4-dichloroacetyl-1-oxa-4-azaspiro[4.5]decane (AD-67), 1-dichloroacetylhexahydro-3,3,8a-trimethylpyrrolo[1,2-a]-pyrimidin-6(2H)-one (BAS-145138), 4-dichloroacetyl-3,4-dihydro-3-methyl-2H-1,4-benzoxazine (benoxacor), 2,2-dichloro-N,N-di-2-propenylacetamide(dichloromid), 3-dichloroacetyl-5-(2-furanyl)-2,2-dimethyloxazolidine (furilazole, MON-13900), and 3-dichloroacetyl-2,2,5-trimethyloxazolidine (R-29148).

18. A composition according to claim 11 in which component (c) comprises mefenpyr-diethyl.

19. A method of controlling unwanted plants comprising allowing an effective amount of a composition according to claim 11 to act on the unwanted plants and/or their habitat.
